(19) United States
(12) Patent Application Publication
(10) Pub. No.: US 2007/0082300 A1
(43) Pub. Date: Apr. 12, 2007

(54) Image forming method

(76) Inventor: Narito Goto, Sagamihara-shi (JP)

Correspondence Address: CANTOR COLBURN, LLP, 55 GRIFFIN ROAD SOUTH, BLOOMFIELD, CT, 06002, US

(21) Appl. No.: 11/543,684

(22) Filed: Oct. 5, 2006

(30) Foreign Application Priority Data
Oct. 12, 2005 (JP) JP2005-297708

(51) Int. Cl. G03C 5/16

(52) U.S. Cl. 430/348

(57) ABSTRACT

A method of forming an image comprising the steps of: (a) irradiating an silver salt photothermographic material with a laser beam emitted by a scanning exposing device in a laser imager, provided that the scanning exposing device comprises a laser diode, a polygon mirror, and an imaging lens made of a resin; and (b) developing the irradiated silver salt photothermographic material to obtain an image by applying heat, wherein the silver salt photothermographic material comprises a first radiation absorbing compound on a side of the support which is provided with the photosensitive layer, provided that a total absorbance of the first radiation absorbing compound is from 0.3 to 1.00 at an irradiation wavelength; and a second radiation absorbing compound on a side of the support opposite the photosensitive layer, provided that a total absorbance of the second radiation absorbing compound is from 0.20 to 1.50 at an irradiation wavelength.

This application is based on Japanese Patent Application No. 2005-297708 filed on Oct. 12, 2005 in Japan Patent Office, the entire content of which is hereby incorporated by reference.

### TECHNICAL FIELD

The present invention relates to an image forming method in which after exposure of a laser beam from a semi-conductor laser onto a silver salt photothermographic dry imaging material (hereinafter also referred to as a photothermographic dry imaging material, a photothermographic photosensitive material, a heat developable photosensitive material, or simply a photosensitive material), images are recorded via heat development.

### BACKGROUND

Conventionally, a thermal processor has been known (refer, for example, to Patent Document 1) in which after exposure of a laser beam onto a heat developable photosensitive material, employing a plane scanning optical system composed of a semiconductor laser, a polygonal mirror, and an imaging lens constituted of at least one fθ lens, and a cylindrical lens, images are recorded via heat development.

Much higher image quality than that commonly outputted by an electrophotographic recording system is demanded for diagnostic medical images outputted by the above thermal processor. In order to meet the above demand, since it becomes necessary to converge light generated from a semiconductor laser to uniformly result in small spot diameter over a broad output range, in the plane scanning optical system of the thermal processor, glass lenses have been employed as imaging lenses which result in high conversion accuracy and minimal variation due to environmental variation.

On the other hand, in recent years, downsizing and cost reduction have been strongly demanded for thermal processors. As a means to meet the above demand, for example, cost is reduced by shortening the distance to convey photosensitive materials to decrease the number of necessary parts for conveyance.

(Patent Document 1) Japanese Patent Publication Open to Public Inspection (hereinafter referred to as JP-A) No. 2003-195203 (claims)

### SUMMARY

In order to downsizing and to reduce cost of the thermal processors, it is effective to employ imaging lenses which are prepared by employing resins instead of conventionally employed glass lenses. However, it has been found that resin imaging lenses are not consistently at satisfactory levels resulting in degradation of image quality and large density variation caused by humidity change. When rapid processing is carried out, the above drawbacks are particularly exhibited, and then improvement has been demanded.

In view of the foregoing, the present invention was achieved. An object of the present invention is to provide an image forming method which results in excellent image quality and minimal variation due to humidity change, even when a silver salt photothermographic dry imaging material is subjected to rapid thermal development, employing a down-sized and low cost laser imager using resinous lenses.

The inventors of the present invention diligently worked to overcome the above drawbacks and found that the object of the present invention was achieved at a higher level in such a manner that total absorbance at the exposure wavelength of all the layers on the side on which the photosensitive layer of a silver salt photothermographic dry imaging material was arranged, was controlled within 0.30-1.00, while total absorbance at the exposure wavelength of layers (hereinafter also referred to a back coat layer or a BC layer) arranged across the support and on the side opposite the side, on which the photosensitive layer was arranged, was controlled within the range of 0.20-1.50, and both requirements are simultaneously satisfied. Accordingly, the present invention was achieved. Further, it was also found that the object of the present invention was achieved at a higher level by employing the highly active reducing agents represented by Formula (RD1), as a reducing agent.

### BRIEF DESCRIPTION OF THE DRAWINGS

FIG. 1 is a schematic side view showing the major section of a thermal processor.

FIG. 2 is a block diagram of a scanning exposure section.

### DESCRIPTION OF THE PREFERRED EMBODIMENTS

The above object of the present invention is achieved employing the following embodiments.

(1) An aspect of the embodiment of the invention includes a method of forming an image comprising the steps of:

(a) irradiating an silver salt photothermographic material with a laser beam emitted by a scanning exposure section in a laser imager, provided that the scanning exposure section comprises a laser diode, a polygon mirror, and an imaging lens made of a resin; and

(b) developing the irradiated silver salt photothermographic material to obtain an image by applying heat,

wherein the silver salt photothermographic material comprises:
(i) a support having thereon a photosensitive layer comprising organic silver salts, silver halide grains, a binder, a reducing agent;
(ii) a first radiation absorbing compound on a side of the support which is provided with the photosensitive layer, provided that a total absorbance of the first radiation absorbing compound is from 0.3 to 1.00 at an irradiation wavelength; and
(iii) a second radiation absorbing compound on a side of the support opposite the photosensitive layer, provided that a total absorbance of the second radiation absorbing compound is from 0.20 to 1.50 at an irradiation wavelength, and the first radiation absorbing compound and the second radiation absorbing compound may be the same or different from each other.
   (2) Another aspect of the invention includes a method of forming an image,

wherein the resin for making the imaging lens is a cycloolefin polymer.

(3) Another aspect of the invention includes a method of forming an image,

wherein the reducing agent in the photosensitive layer is represented by Formula (RDI):

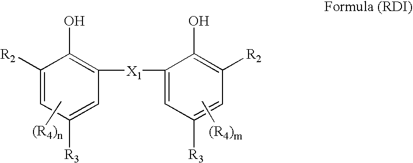

wherein X₁ is a chalcogen atom or CHR₁ in which R₁ is a hydrogen atom, a halogen atom, an alkyl group, an alkenyl group, an aryl group or a heterocyclic group; both R₂s are alkyl groups which may be the same or different, provided that at least one R₂ is a secondary or tertiary alkyl group; both R₃s are a hydrogen atom or a group capable of being substituted on a benzene ring, provided that plural R₃s may be the same or different; R₄ is a group capable of being substituted on a benzene ring; and m and n are an integer of 0 to 2.

(4) Another aspect of the invention includes a method of forming an image,

wherein in the reducing agent represented by Formula (RDI), at least one R₃ is an alkyl group having 1 to 20 carbon atoms, provided that the alkyl group has a hydroxyl group as a substituent, or the alkyl group has a protected hydroxy group capable of forming a hydroxyl group upon deprotection.

(5) Another aspect of the invention includes a method of forming an image,

wherein a thickness of the photosensitive layer is from 4 to 16 μm.

(6) Another aspect of the invention includes a method of forming an image,

wherein the developed image obtained by irradiation with a laser beam and then by heating at 123° C. for 10 seconds has an optical density of 0.25 to 2.5 measured with a diffused light and an average gradation of 1.8 to 6.0,

provided that the average gradation is measured from an characteristic curve having orthogonal coordinates X and Y axes, the Y axis being a diffusion density; and the X axis being an amount of irradiation light in a common logarithm unit, each unit of the X and Y axes being the same length.

(7) Another aspect of the invention includes a method of forming an image,

wherein a content of silver iodide in the silver halide grains is 5 to 100 mol % based on a total mol of the silver halide grains.

(8) Another aspect of the invention includes a method of forming an image,

wherein the silver salt photothermographic material is provided as a sheet, and the sheet is fed in the laser imager at a speed of 30 to 200 mm/second during heating.

(9) Another aspect of the invention includes a method of forming an image,

wherein the silver salt photothermographic material is provided as a sheet, and development of an irradiated portion of the sheet is carried out while a portion of the sheet is irradiated.

(10) Another aspect of the invention includes a method of forming an image,

wherein a distance between an irradiating device and a heating device of the laser imager is 0 to 50 cm.

(11) Another aspect of the invention includes a method of forming an image,

wherein a time period for applying heat is not more than 10 seconds.

(12) Another aspect of the invention includes a method of forming an image,

wherein the silver salt photothermographic material is provided as a sheet, and a laser imager for processing the silver salt photothermographic material has an installation area of not more than 0.40 m².

According to the present invention, it is possible to provide an image forming method which results in excellent image quality and minimal variation due to humidity change even when a silver salt photothermographic dry imaging material is subjected to rapid thermal development, employing a down-sized and low cost laser imager using a resinous lens.

Preferred embodiments to practice the present invention will now be described, however the present invention is not limited thereto.

The constituting elements of the present invention will successively be described.

(Constitution of the Entire Apparatus)

The laser imager (being the thermal processing apparatus) according to the present invention is composed of the film feeding section represented by a film tray, a heat development section which provides uniform and stable heat onto the entire surface of silver salt photothermographic dry imaging materials, and a conveying device section which discharges photothermographic dry imaging materials, on which images are formed via heat development from the film feeding section via laser recording, to the exterior of the apparatus.

In the preferable laser imager employed in the present invention, the ratio of the path length of the cooling section to the path length of the heat development section is preferably at most 1.5, is more preferably 0.1-1.2, but is most preferably 0.2-1.0. Path length of the heat development section, as described herein, refers to the conveyance distance in which photosensitive materials are heated at the development temperature in the thermal processor. Further, path length of the cooling section, as described herein, refers to the path length from the region in which photosensitive materials are shielded from light by the laser imager to discharge of the photosensitive material to light in the room where the laser imager is installed.

Further, it is preferable that the above laser imager exhibits a function in that the cooling rate of the surface (hereinafter referred to as a “non-photosensitive surface”) having no photosensitive layer across the support of a silver salt photothermographic dry imaging material, becomes greater than that of the surface (hereinafter referred to as a “photosensitive surface”) having a photosensitive layer.

In the present invention, the ratio of the cooling rate on the non-photosensitive surface to the cooling rate on the photosensitive surface is preferably at least 1.1, is more preferably 1.1-5.0, but is most preferably 1.5-3.0. Methods to increase the cooling rate of the non-photosensitive surface are not particularly limited, but preferable embodiments are such that the non-photosensitive layer is brought into direct contact with a metal plate, a metal roller, a nonwoven fabric, or a brush roller. Further, more preferable embodiments are such that in order to positively discharge heat accumulated by these parts, heat sinks and heat pipes are simultaneously employed.

When the path length of the cooling section is less than that of the heat development section in such a manner that the ratio is at most 1.5, it is possible to provide a downsized laser imager resulting in a higher processing rate.

The cooling period until sheet discharge after leaving the heat development section is not particularly specified. However, it is preferably 0-25 seconds, is more preferably 0-15 seconds, but is most preferably 5-15 seconds.

The path length until discharge of photosensitive materials after leaving the heat development section is also not particularly specified. However, it is preferably 1-60 cm, is more preferably 5-50 cm, but is most preferably 5-40 cm.

The silver salt photothermographic dry imaging material of the present invention may be developed employing any of the conventional development methods. Commonly, the above photosensitive material, which has been subjected to imagewise exposure, is developed while heated. The development temperature is preferably 80-250° C., but is more preferably 110-130° C. The development time is preferably 1-10 seconds, is more preferably 2-10 seconds, but is most preferably 3-10 seconds. When the heating temperature is less than 80° C., it is not possible to achieve the desired image density within a short period of time. On the other hand, when it exceeds 200° C., binders tend to melt resulting in adverse effects not only to images, such as transfer onto rollers but also to conveyance and the processor. When heated, silver images are produced via an oxidation-reduction reaction between organic silver salts (which function as an oxidizing agent) and reducing agents. The above reaction process proceeds without any supply of processing solutions such as water from the exterior. Necessary time to complete the heat development process (being the time from pick-up of a photosensitive material in the tray section to its discharge) is preferably at most 60 seconds, but is more preferably 10-50 seconds, enabling to correspond to urgent diagnosis.

Employed as a heat development system may be either a drum type heater or a plate type heater, of which the plate heater system is preferred. As a heat development system via the plate heater system, the following method described in JP-A No. 11-133572 is particularly preferred. Namely, the above method relates to a laser imager which produces visible images, characterized in that silver salt photothermographic dry imaging materials, in which a latent image is formed on silver halide grains via exposure, are brought into contact with a heating device in the heat development section; the above heating device is composed of a plate heater and along one side of the above plate heater; a plurality of pressing rollers is faced each other; and heat development is carried out by passing the above imaging materials between the above pressing roller and the above plate heater.

The linear conveyance rate of photosensitive materials in the exposure section, the heat development section, and the cooling section is not particularly specified. However, a higher rate is preferred for rapid processing and enhancement in through-put. The linear rate is preferably 30-200 mm/second, is more preferably 30-150 mm/second, but is most preferably 30-60 mm/second. Regulating the conveyance rate within the above range is preferred since it is possible to minimize uneven density and to enable urgent diagnosis due to reduction of the processing time.

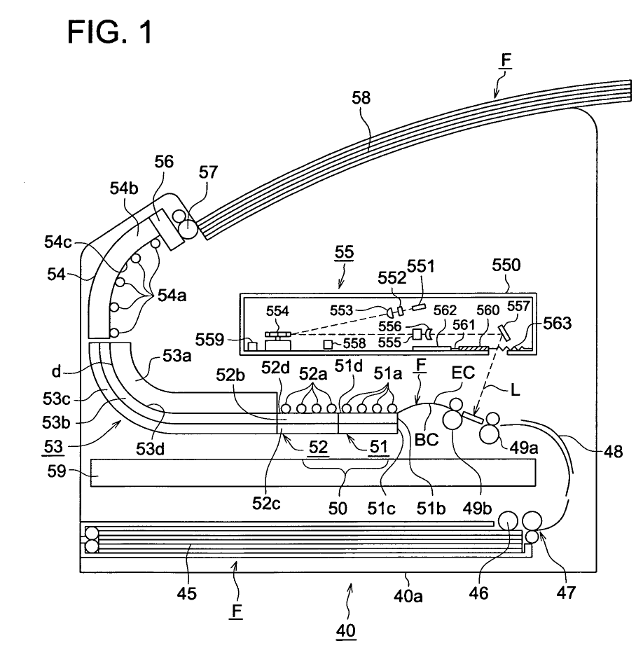

FIG. 1 is a schematic side view showing major sections of the thermal processor based on the preferred embodiments.

Exposure and heat development processes are simultaneously carried out; namely, in order to initiate development of a part of a photosensitive material sheet while exposed to the part of it, the distance between the section to carry out exposure and the development section is preferably 0-50 cm. By doing so, the series of processing times of exposure and development is markedly shortened. The above distance is preferably within the range of 3-40 cm, but is more preferably in the range of 5-30 cm. The exposure section, as described herein, refers to the position at which light from the exposure light source is exposed onto heat developable photosensitive materials, while the development section refers to the position at which heat developable photosensitive material is firstly heated to carry out heat development. In FIG. 1, the position (at the tip of the arrow) represented by L, in which a laser beam is incident to a heat developable photosensitive material, is the exposure section. In FIG. 1, the section in which the photosensitive material conveyed from 45 is firstly brought into contact with plate 50 is the development section.

Employed as heating devices, apparatuses, or methods may be heat generators such as hot plates, irons, hot rollers or typical heating methods as heat generators, employing carbon and white titanium. In view of uniform heat application, heating efficiency, and workability, it is more preferable that in silver salt photothermographic dry imaging materials, heating is carried out in such a manner that the surface on the protective layer incorporating side is brought into contact with a heating device. It is also preferable that the surface incorporating the protective layer is conveyed while brought into contact with the heating roller and development is carried out while heated.

In the present invention, with regard to an image formed via heat development at a heating temperature 123° C. and a development time of 10 seconds, the average gradient between the optical density of 0.25-2.5, determined under diffused light, is preferably 1.8-6.0, is more preferably 2.0-5.0, but is most preferably 2.0-4.5 in the characteristic curve formed on the rectangular coordinates in which the unit length of diffuse density (being the Y axis) is the same as that of the exposure amount in common logarithm (being the X axis). By regulating the gradient within the above range, it enables production of images exhibiting high diagnostic recognition.

In order to obtain effective adaptation to the above laser imager according to the present invention, the total dried layer thickness of the photosensitive layer and the non-photosensitive layer, arranged on at least one side of the silver salt photothermographic dry imaging material according to the present invention, is preferably 12-19 μm, but is most preferably 14-18 μm. Further, the dried layer thickness of the photosensitive layer is preferably 4-16 μm, is more preferably 6-14 μm, but is most preferably 8-12 μm.

As shown in FIG. 1, thermal processor 40 of the preferred embodiment carries out secondary scanning conveyance of film F, which incorporates a substrate sheet composed of PET having on one side a photosensitive surface (hereinafter referred to as an EC surface) and a non-photosensitive surface (hereinafter referred to as a BC surface) on the side of the substrate opposite the EC surface, whereby a latent image is formed on the EC surface employing laser beam L from light scanning exposure section 55. Subsequently, the latent image is visualized by heating the BC side of Film F, and resulting Film F is conveyed upward in the processor via a curved conveyance path, and subsequently discharged.

Thermal processor 40 shown in FIG. 40 is provided with film storage section 45 located near the bottom of processor enclosure 40a, which stores a number of film F sheets, pick-up roller 46 which picks up uppermost Film F sheet and conveys it, paired conveying rollers 47 which convey film F from pick-up roller 46, curved plane guide 48 which guides film F from paired conveying rollers 47 and conveys it while nearly reversing the conveying direction, paired conveying rollers 49a and 49b which carry out secondary scanning conveyance of film F from curved plane guide 48, and light scanning exposure section 55 which scans laser beam L based on image data and exposes a scanning laser beam onto the EC surface to form a latent image.

Thermal processor 40 is further provided with temperature increasing section 50 which heats the BC surface of film F to the specified heat development temperature, temperature maintaining section 53 which maintains the specified heat development temperature by heating heated film F, cooling section 54 which cools the BC surface of heated film F, densitometer 56 which is located on the exit side of cooling section 54 and determines the density of film F, conveying roller 57 which discharges film F from densitometer 56, and film placing section 58 which is obliquely arranged on processor enclosure 40a so that discharged film F can be placed.

As shown in FIG. 1, in thermal processor 40, toward the top from the bottom of processor enclosure 40a, film storage section 45, substrate section 59, paired conveying rollers 49a and 49b, temperature increasing section 50, and temperature maintaining section 53 (upstream side) are arranged in the listed order. Film storage section 45 is arranged at the very bottom, and substrate section 59 is located between temperature increasing section 50 and temperature maintaining section 53, whereby adverse heating effects are minimized.

Further, since the conveying path from paired secondary scanning conveying rollers 49a and 49b to the temperature increasing section 50 is relatively short, the leading edge of film F is thermally developed in temperature increasing section 50 and temperature maintaining section 53, while film F is being exposed to light by light scanning exposure section 55.

A heating section is composed of temperature increasing section 50 and temperature maintaining section 53, whereby film F is heated to the heat development temperature and is maintained at the heat development temperature. Temperature increasing section 50 incorporates first heating zone 51 which heats film F in the upstream end and second heating zone which heats film F in the downstream end.

First heating zone 51 incorporates fixed planar heating guide 51b composed of metallic materials such as aluminum including, planar heating heater 51c composed of a silicone rubber heater which is brought into close contact with the rear side of heating guide 51b, and plural facing rollers 51a which are arranged to press the film onto fixed guide surface 51d of heating guide 51b so that a space narrower than the film thickness is maintained and of which surface is composed of more heat insulating silicone rubber compared to metals.

Second heating zone 52 incorporates fixed planar heating guide 52b composed of metallic materials such as aluminum including, planar heating heater 52c composed of a silicone rubber heater which is brought into close contact with the rear side of heating guide 52b, and plural facing rollers 52a which are arranged to press the film on fixed guide surface 52d of heating guide 52b so that a space narrower than the film thickness is maintained and of which surface is composed of more heat insulating silicone rubber compared to metals.

Temperature maintaining section 53 incorporates fixed heating guide 53b composed of metallic materials such as aluminum, planar heater 53c composed of a silicone rubber heater which is brought into close contact with the rear side of heating guide 53b, and guide section 53a composed of heat insulating materials which are arranged to face each other to result in specified space (slit) d with respect to fixed guide surface 53d constituted on the surface of heating guide 53b. Temperature maintaining section 53 is constituted so that the temperature increasing section 50 side connects to second heating zone 52, and is curved on the way at the specified curvature toward the upper direction of the processor.

In first heating zone 51 of temperature increasing section 50, film F conveyed by paired conveying rollers 49a and 49b from the upstream end of temperature increasing section 50 is pressed onto fixed guide surface 51d by each rotated facing rollers 51a so that BC surface is heated via close contact with fixed guide surface 51d and conveyed.

In second heating zone 52, in the same manner as above, film F, conveyed from first heating zone 51, is pressed onto fixed guide surface 52d by each rotating adjacent rollers 52a so that BC surface is heated via close contact with fixed guide surface 51d, and then conveyed.

Further, one constitution may be made so that a concave portion, which opens upward in the form of a letter V between second heating zone 52 of temperature increasing section 50 and temperature maintaining section 53 is provided. By allowing foreign matter from temperature increasing section 50 to fall into the concave portion, bringing foreign matter from temperature increasing section 50 to temperature maintaining section 53 can be minimized.

In temperature maintaining section 53, film F, conveyed from second heating zone 52, is heated (temperature-maintained) via heat from heating guide 53b at space d between fixed guide surface 53d of heating guide 53b and guide section 53a, and passes space d via conveying force of facing roller 52b on the second heating zone 52 side. During this operation, film F is conveyed while gradually changing the direction from horizontal to vertical in space d and conveyed to cooling section 54.

In cooling section 54, film F being almost vertically conveyed from temperature maintaining section 53 is cooled via contact with cooling guide surface 54c of cooling plate 54b composed of metallic materials by the use of facing rollers 54a. During cooling, the direction of film F is gradually changed from vertical to oblique, which is directed toward film placing section 58, and conveyed. Further, it is possible to enhance cooling efficiency in such a manner that cooling plate 54b is modified as a heat sink structure with fins. A part of cooling plate 54b may be modified as a heat sink structure with fins.

Cooled film F conveyed from cooling section 54 is subjected to density determination employing densitometer 56, then conveyed by paired conveying rollers 57 and discharged to film placing section 58. Film placing section 58 can temporarily accommodate a plurality of sheets of film F.

As noted above, in thermal processor 40 shown in FIG. 1, in temperature increasing section 50 and temperature maintaining section 53, film F is conveyed in such a manner that the BC surface of film F faces fixed guide surfaces 51d, 52d, and 53d in the heated state, and the EC surface coated with heat developable photosensitive material is open. Further, in cooling section 54, film F is cooled while the BC surface comes into contact with cooling guide surface 54c and is conveyed in such a state that the EC surface coated with heat developable materials is open.

Further, film F is conveyed by facing rollers 51a and 52a so that passage time through temperature increasing section 50 and temperature maintaining section 53 does not exceed 10 seconds. Consequently, heating time during temperature increasing and maintaining is regulated to at most 10 seconds.

As noted above, by employing thermal processor 40 shown in FIG. 1, in temperature increasing section 50 required for uniform heat transfer, film F is conveyed while assuring contact heat transfer in such a manner that film F is brought into close contact with fixed guide surfaces 51b and 52b employing plural facing rollers 51a and 52a, which press film F onto heating guide 51b and 52b. Thus, the film surface is uniformly heated and the temperature increases uniformly, whereby finished film sheets carry high quality images in which uneven density is minimized.

Further, after reaching the heat development temperature, in temperature maintaining section 53, a sheet of film is conveyed to space d between fixed guide surface 53d of heating guide 53b and guide section 53a heated (heated via heat transfer by direct contact with fixed guide surface 53d and/or heat transfer via contact with ambient air at high temperature) in space d. Even without close contact with fixed guide surface 53d, the film temperature is regulated to be within the specified range (for example, 0.5° C.) with respect to development temperature (for example 123° C.). As described above, when the sheet of film in space d is conveyed along either the wall surface of heating guide 53b or the wall surface of curved surface guide 53a, the film temperature difference is less than 0.5° C., and it is possible to uniformly maintain the temperature, whereby problems rarely occur in which finished film results in uneven density. Due to that, it is not necessary to arrange driving parts such as rollers in temperatures maintaining section 53, whereby it is possible to reduce the number of parts.

Further, since the heating time of film F is allowed to be at most 10 seconds, it is possible to realize a rapid heat development process. In addition, since temperature maintaining section 53, horizontally extending from temperature increasing section 50, is constituted in such a manner that on the way, it is modified to a curved shape which directs in the vertical direction and film F is almost reversed in the direction and discharged to film placing section 58, whereby it is possible to downsize the installation area and the entire processor by applying a specified curvature to cooling section 54 corresponding to the processor lay-out.

In conventional large processors, a heating conveying mechanism has been employed in the section which is sufficiently covered by temperature maintaining function after heating film to the development temperature. As a result, non-essential parts are employed, resulting in an increase in parts and cost. Further, in conventional downsized processors, it has been difficult to assure heat transmission during temperature increase, resulting in problems such as generation of uneven density, whereby it was difficult to assure high image quality. Contrary to this, based on preferred embodiments, it is possible to solve any of the above problems in such a manner that the heat development process is realized separately in temperature increasing section 50 and temperature maintaining section 53.

Further, during processing film F in temperature increasing section 50 and temperature maintaining section 53, the BC surface side of the heat developable photosensitive material is heated in such a state that the EC surface is open. By doing so, when the heat development process is realized under rapid processing of at most 10 seconds, by opening the EC surface side, solvents (water and organic solvents) incorporated in film F to be heated and sublimed (vaporized) are released in the shortest distance. As a result, even when the heating time (being the sublimation time) is shortened, effects due to the shortened time rarely result. At the same time, even though poor contact between film F and fixed guide surfaces 51d and 52d occur partially, temperature difference due to good contact portions is relaxed via heat diffusion effects due to the PET base of the BC surface, and density difference rarely occurs, whereby it is possible to stabilize density, and also the eventual image quality. Generally, when heating efficiency is considered, it has been assumed that heating the EC surface side is better. However, when it is considered that heat conductivity of PET of the substrate of film F is 0.17 W/m° C. and the thickness of the PET base is approximately 170 μm, the resulting time delay is slight and can be readily compensated for via an increase in the heater capacity, and it is more preferable that it is possible to expect the above uneven contact relaxing effects.

Further, during conveyance to cooling section 54 after leaving temperature maintaining section 53, solvents (water and organic solvents) are ready for sublimation (vaporization) due to the high temperature. Even in cooling section 54, since the EC surface of film F is in an open state, solvents (water and organic solvents) are not retained but are sublimed over an extended period of time, resulting in stabilization of image quality. As noted above, during rapid processing, it is not possible to neglect the cooling time. Consequently, the open state of the EC surface is particularly effective to achieve rapid processing in which the heating time is at most 10 seconds.

In the present invention, the heat development temperature is preferably in the range of 110-150° C., but is more preferably in the range of 115-135° C. When the heating temperature is less than 80° C., sufficient image density is not realized during a short time, while when it is relatively high (specifically, at least 200° C.), conveyance and processors are adversely affected due to transfer of melted binders onto rollers. Heating results in oxidation-reduction reaction between organic silver salts (which function as an oxidizing agent) and reducing agents, whereby silver images are formed. This reaction process proceeds without supply of any outside processing solutions, such as water.

Employed as heating devices may be heating drums and heating plates employed for direct contact heating and radiation employed for non-contact heating, of which the contact heating with the heating plate is preferred. The contact heating side may be either a photosensitive layer side or a non-photosensitive layer, but in view of stability for the processing environment, the non-photosensitive layer is preferably the contact heating side. It is preferable that the development section is composed of a plurality of independently temperature-controlled zones and a plurality of related devices. Further, it is preferable to incorporate at least one temperature maintaining zone which maintains a specified development temperature. Accordingly, in the preferable thermal processor usable in the present invention, it is possible to realize a constitution in which the heat development process is carried out separately in the temperature increasing section, and also in the temperature maintaining section. Thus, in the temperature increasing section, formation of uneven density is minimized by allowing a film sheet to come into close contact with a heating device such as a heating member, while in the temperature maintaining section, it is not necessary to achieve close contact as above. By employing optimal heating systems which differ in the temperature increasing section and the temperature maintaining section, it is possible to achieve a rapid heat development process, to downsize the processor, and to reduce cost while maintaining high quality images at uniform density.

With regard to the above thermal processor, in the aforesaid temperature increasing section, the film sheet is heated while brought into contact with the plate heater via pressing employing the facing rollers. It is possible to constitute the above temperature maintaining section in such a manner that the above film sheet is heated in the slit formed between guides, at least one of which incorporates a heater. In the temperature increasing section, it is possible to allow the film sheet to come into close contact with the plate heater in such a manner that the sheet film is pressed onto the plate heater, employing facing rollers. On the other hand, since in the temperature maintaining section, the film sheet may be conveyed while heated (temperature-maintained) between the slit, employing conveying force applied by the facing rollers of the temperature increasing section, driving parts of the conveying system become unnecessary and accuracy of the slit size is not severely required, whereby it is possible to downsize the processor and also to reduce cost.

By employing the above thermal processor, in the first zone, contact of the film sheet with a heating device such as a heating member is assured and the film sheet is heated to result in minimal formation of uneven density. In the second zone, since close contact, as above, is not required, temperature of the film sheet is maintained in the space between guides. In such a manner, it is possible to realize a rapid heat development process upon maintaining high quality image with even density, to downsize the processor and to reduce cost. When the space in the second zone between guides is at most 3 mm, temperature maintaining capability is minimally affected irrespective of the conveying posture of film sheets and arrangement accuracy of a guide and an another guide is not so essential. Thus, allowance for curvature error during machining of both guides and installation accuracy is enlarged to result in a marked increase in system designing freedom, whereby it is possible to realize contribution to cost reduction of processors.

In the above thermal processor, the guide space of the above second zone is preferably in the range of 1-3 mm. When the guide space is at least 1 mm, the coated surface of the heat developable photosensitive materials in the form of a film sheet is rarely brought into contact with the guide surface to reduce the tendency of formation of abrasion.

Further, it is preferable that the curvature of the above fixed guide of the above second zone approximately equals that of the above guide. When the guide in the second zone allows curvatures to downsize a processor, it is possible to constitute guides which result in nearly constant guide space.

Further, a constitution is possible so that the time engaged with the above film sheet in the above temperature increasing section and the above temperature maintaining section is at most 10 seconds, whereby it is possible to shorten the time of the temperature increasing process and the temperature maintaining process so that it becomes possible to realize a rapid heat development process.

Still further, a constitution is also realized in such a manner that a concave portion is arranged between the above temperature increasing section and the above temperature maintaining section so that foreign matter from the above temperature increasing section drops into the above concave portion. By doing so, any foreign matter collected and moved by the leading edge of a film sheet during conveyance through the temperature increasing section is prevented from being brought into the temperature maintaining section, whereby it is possible to minimize jamming of film sheets, as well as the formation of abrasion and uneven density.

It is preferable that the above temperature increasing section and the above temperature maintaining section are constituted in such a manner that the film sheet is heated while allowing the coating surface side of the above heat developable photosensitive material to be open. Further, it is preferable that in the cooling section, cooling is carried out in such a manner that the coating surface side of the above heat developable photosensitive material is open.

The mechanisms of the temperature maintaining zone is not particularly limited as long as an elevated film temperature is maintained, but is not limited to the above. Further, development time is preferably 5-10 seconds.

Further, the above processor may incorporate a pre-heating zone, in which after exposure of silver salt photothermographic dry imaging materials to light, prior to the heat development process in which the exposed material is heated to a specific development temperature, it is heated to 70-100° C. Further, it is preferable to carry out heating at 90-100° C. Mechanisms of the pre-heating zone are not particularly limited, but in view of cost and controllability, contact heating with a heating plate is preferred. The accuracy of heating temperature in the pre-heating zone is preferably ±1° C., but is more preferably ±0.5° C. The optimal heating time varies depending on heating mechanisms, but is preferably in the range of 0.5-7 seconds, but is more preferably in the range of 1-3 seconds.

Further, the above processor may incorporate a cooling zone which terminates development by regulating the temperature to the range of 10-20° C. lower than the heat development temperature after exposure of a silver salt photothermographic dry imaging material to light and development at the desired temperature. It is more preferable that the temperature is regulated to the range of 10-15° C. lower than the heat development temperature. Mechanisms of the cooling zone are not particularly limited, but in view of cost and controllability, cooling is carried out via contact with a plate regulated to the desired temperature. The temperature accuracy of the cooling zone is preferably ±1° C., but is more preferably ±0.5° C. Cooling time is preferably at least ×2.5 of the development time, but is more preferably in the range of ×0.25-×1.0 when rapid processing is considered.

Further, in the present invention, it is possible to maintain consistent image quality by controlling the development time and development temperature, based on the temperature or humidity determined by a temperature and humidity sensor arranged near the conveying path from film storage section 45 to temperature increasing section 50. For example, when the ambient temperature is relatively high, the development temperature is decreased or the development time is shortened, whereby it is possible to achieve consistent image density.

(Constitution of the Light Scanning Exposure Section)

Light scanning exposure section 55 exposes film F, for example, via laser beam L which is in the infrared range of 780-860 nm, such as 810 nm, and is modulated based on image signals, whereby a latent image is formed on film F.

FIG. 1 is a constitution view of a light scanning exposure section. Light scanning exposure section 55 is composed of case 550, laser diode 551, lens 552, cylindrical lens 553, polygonal mirror (being a rotary polygon) 554, fθ lens 555, cylindrical lens 556, mirror 557, temperature and humidity sensor 558 which detects the temperature and humidity in case 550, humidity controlling agent 559 which controls the humidity in case 550, shutter 560 which opens and closes the laser beam exposing aperture of case 550, magnetic rod 561 integral to shutter 560, magnetic plunger 562 which sucks magnetic rod 561, and pulling spring 563 integral to the shutter.

In the present invention, cylindrical lens 553, fθ lens constituting the imaging lens section, and cylindrical lens 556 are made of resins (plastics).

The resin lens may be a plastic lens composed of raw materials which enable ejection molding. For example, it is possible to employ lenses incorporating raw materials such as polycarbonate resins, polyolefin resins, or polyester resins. In the present invention, it is preferable to employ polyolefin resin based cycloolefin polymers which exhibit characteristics such as a minimal variation of refractive index, due to moisture absorption, and minimal optical distortion.

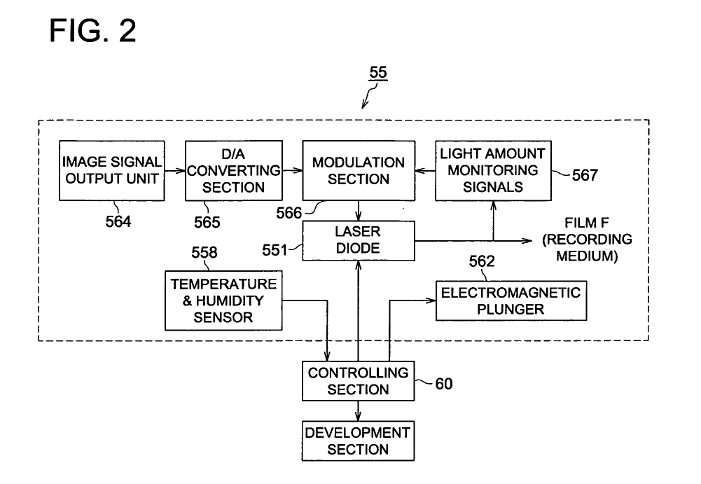

FIG. 2 is a block diagram to control the scanning exposure section. The scanning exposure section is composed of D/A converting section 565 which converts image signal S outputted from image signal output unit 564, modulation section 566 which has analog signals outputted from D/A conversion section 565 superposed high frequency, and light amount monitor signals 567 which monitor output from laser diode 551 which makes laser beam intensity constant, and is controlled by control section 60 of the main body.

In scanning exposure section 55, a latent image is formed on film F in such a manner that laser beam L, which is subjected to intensity modulation based on image signal S outputted from image signal putout unit 564, is deflected by polygonal mirror (being a rotary polygon) 554 and is primary-scanned onto film F via fθ lens 555, while secondary scanning is conducted by relatively moving film F in an approximately right angle direction to the primary scanning direction with respect to laser beam L. Image signal S, outputted from image signal output unit 564, is converted to analog signals in D/A converting section 565 and inputted into modulation section 566 incorporating a modulation circuit. Based on such analog signals, modulated 0 signals are formed in modulation section 566. The resultant signals are subjected to superposition of high frequency signals employing the high frequency superposition circuit arranged in modulation section 566 and then drives laser diode 551, which is a semiconductor laser, to form and makes laser beam L via laser diode 551 to expose the image.

Modulation section 566 incorporates a high frequency superposition circuit; applies electric current to laser diode 551; and modulates electric current outputted to laser diode 551, whereby it is possible to control light output of laser diode 551. More specifically, modulation section 566 allows laser diode 551 to drive high frequency superposition, and light emitted from laser diode 551 is subjected to direct analog modulation into the dynamic range of at least 1:100. Maximum 180 mA electric current is applied to above modulation section 566 so that it is possible to modulate oscillating laser light from above laser diode 551. Further, light amount monitor signals from a light amount sensor (not shown) which receives laser beam L emitted from laser diode 41 is inputted to modulation section 566, whereby control is achieved so that the intensity of laser beam L remains constant.

Laser diode 551 emits natural emission light and oscillating laser light corresponding to the amount of applied electric current, whereby it is possible to control light emission in response to the amount of applied electric current. Such a constitution is detailed below. No oscillating laser light is emitted when the applied electric current does not exceed a specified threshold electric current value (for example, 20 mA) and only natural emission light is emitted. As the applied electric current increases, natural emission light increases. However, when the electric current exceeds the threshold value, oscillating laser light is emitted. As the above emission increases, the ratio of the natural emission light in the total emission light becomes minimal and substantially only the oscillating laser light is emitted.

As shown in FIG. 1, laser beam L emitted from laser diode 551 passes through lens 552, is then converged only in the vertical direction by cylindrical lens 553, and is incident to polygonal mirror 554 as a linear vertical image to its driving axis. Polygonal mirror 554 allows laser beam L to reflect to the primary scanning direction resulting in deflection. After deflected laser beam L passes through imaging lens section incorporating fθ lens 555 and cylindrical lens 556, resultant laser beam L is reflected by mirror 557 arranged to extend into the light path in the primary scanning direction and repeatedly scans scanning surface Fa of film F.

Above fθ lens 555 is constituted to result in a magnified chromatic aberration of at most 5 μm/nm. Namely, constitution is achieved in such a manner that when the wavelength of laser beam L incident to fθ lens 555 is shifted by 10 nm with respect to the surface of film F, which is the surface for imaging, light is deviated to the position within at most 0.05 mm from the specified position, namely resulting in deviation of at most 5 μm with respect to 1 nm. In other words, constitution is achieved so that by varying the wavelength by 1 nm, an image point focused on the surface of film F via fθ lens moves within the range of only at most 5 μm.

Cylindrical lens 556, which constitutes the imaging lens section, along with fθ lens 555, functions so that incident laser beam L converges on scanned surface Fa of film F only in the secondary scanning direction. Further, the distance from fθ lens 451 to scanned surface Fa of film F is made to equal the entire focal distance of fθ lens 555. As noted above, scanning exposure section 55 is provided with cylindrical lens 553 and fθ lens 555, as well as an imaging lens section incorporating cylindrical lens 556. Laser beam L temporarily converges only in the secondary scanning direction on polygonal mirror 554. Consequently, when polygonal mirror 554 results in oblique plane or axis deviation, on scanned surface Fa of film F, the primary scanning position of laser beam L does not deviate to the secondary scanning direction, whereby it is possible to form scanning lines of an equal pitch. By doing as described above, image recording is carried out through the formation of latent image based on image signal S on film F in scanning exposure section 55.

As mentioned above, in scanning exposure section 55, the magnified chromatic aberration of fθ lens 555 in the imaging section, which exposes light from laser diode 551 which is subjected to high frequency superposition driving to the surface of film F, is regulated to at most 5 μm. Consequently, when images are recorded by exposing and scanning laser beam L from laser diode 551 onto film via fθ lens 555, it is possible to minimize the formation of interference fringes and to minimize also degradation of image sharpness by retarding the increase in the diameter of the laser beam. Further, the above embodiment may be constituted in such a manner that laser diode 551 is subjected to high frequency superposition modulation driving by employing modulation section 566 and light of laser diode 551 is subjected to analog direct modulation driving under a dynamic range of at least 1:100. Being not limited to the above, when the magnified chromatic aberration of fθ lens 555 is at most 5 μm/nm, a constitution may be so that at least either the high frequency superposition modulation drive or the analog direct modulation drive under a dynamic range of at least 1:100 is carried out. Needless to say, other than the above, it is possible to appropriately change specific fine structures. The present invention was specifically described based on each of several embodiments. However, the present invention is not limited thereto, and it is possible to achieve various alterations which are included within the range of the present invention.

With regard to exposure employed to expose the silver salt photothermographic dry imaging material of the present invention to light, or to exposure in the image forming method of the present invention, it is possible to accept various conditions of appropriate light sources and exposure time to obtain targeted images.

When the silver salt photothermographic dry imaging material of the present invention is subjected to image recording, it is preferable to employ a laser beam. Further, in the present invention, it is desired to employ an optimal light source for the spectral sensitivity provided with the above photosensitive material. For example, when the above photosensitive material is prepared to be sensitive to infrared light, it may be applicable to any light source in the infrared region. However, infrared semiconductor lasers (at 780 nm and 820 nm) are more preferably employed since they exhibit high power, and it is possible to make the silver salt photothermographic dry imaging material transparent.

As shown in FIG. 1, scanning exposure section 55 is in a tightly closed structure surrounded by case 550 and has an aperture portion only in the laser beam exposure section, and the aperture section is constituted so that it can be opened or closed by shutter 560. It is constituted in such a manner that during exposure of a laser beam, shutter 560 is opened, and in the other case, shutter 560 is closed. When an electric current is applied to electromagnetic plunger 562, magnetic rod 561 is drawn toward the left in FIG. 1 and acts so that shutter 560 is opened. Further, when application of an eclectic current to electromagnetic plunger 562 is terminated, magnetic rod 561 is not attracted and moves toward the right via force of a spring to result in a closing operation.

In such a manner as above, except for exposure of a laser beam, shutter 560 is closed, so that case 550 is tightly closed. Consequently, even though ambient humidity changes significantly, humidity in the interior is maintained at an almost constant value, whereby in the case of use of resin lenses as described in the present invention, any change of the refractive index of resin lenses and deformation of lens shape are retarded, and variation of beam diameter and imaging position is decreased, enabling preparation of high quality images.

Further, in scanning exposure section 55, humidity controlling agent 559 is provided and humidity variation is further minimized, whereby high quality images are prepared. The type and amount of the humidity controlling agents are not particularly limited as long as humidity variation is retarded within 20% relative humidity.

Further, in scanning exposure section 55, temperature and humidity sensor 558 is installed. Control section 60 controls the exposure amount of laser diode 551 based on the determined temperature or humidity, whereby it is possible to maintain consistently high image quality. For example, when ambient humidity is high, it is possible to realize consistent image density by decreasing the exposure amount.

(Layer Incorporating Radiation Absorbing Compounds)

Employed as radiation absorbing compounds incorporated in the layer on the side provided with a photosensitive layer on a support and in the layer on the side opposite the side provided with the photosensitive layer, across the above support, are various dyes and pigments known in the art. These dyes and pigments are not particularly specified, and examples include pigments and dyes described in the Color Index. Specific examples include pyrazoloazole dyes, anthraquinone dyes, azo dyes, azomethine dyes, oxonol dyes, carbocyanine dyes, styryl dyes, triphenylmethane dyes, indoaniline dyes, indophenol dyes, organic pigments such as phthalocyanine, and inorganic pigments.

Preferred dyes employed in the present invention include anthraquinone dyes (for example, Compounds 1-9 described on page 1441 of JP-A No. 5-341441, and Compounds 3-6-18 and 3-23-38 described in JP-A No. 5-165147), azomethine dyes (Compounds 17-47) described in JP-A No. 5-165147, indoaniline dyes (for example, Compounds 11-19 described in JP-A No. 5-289227, Compound 47 described in JP-A No. 5-341441, Compounds 2-10-11 described in JP-A No. 5-165147), and azo dyes (Compounds 10-16 described in JP-A No. 5-341441). When the heat developable photosensitive materials of the present invention are prepared as image recording materials for use of infrared light, it is preferable to employ squarylium dyes incorporating a thiopyrylium nucleus, squarylium dyes incorporating a pyrylium nucleus, or thiopyryliumcroconium dyes or pyryliumcroconium dyes similar to squarylium dyes. Compounds incorporating a squarylium nucleus, as described herein, refer to compounds which incorporate 1-cyclobutene-2-hydroxy-4-one in the molecular structure and compounds incorporating a croconium nucleus refer to compounds which incorporate 1-cyclopentane-2-hydroxy-4,5-dione in the molecular structure, wherein the hydroxyl group may dissociate. Preferred as dyes are compounds described in Japanese Patent Application Open to Public Inspection (under PCT Application) No. 9-509503 and Compounds AD-1-Ad-55 described in JP-A No. 2003-195450. When the heat developable materials of the present invention are made to image forming materials via blue light, preferably employed are Compounds No. 1-No. 93 described in JP-A No. 2003-215751 and Dye-1-Dye-51 described in JP-A No. 2005-157245. Employed as addition methods of these dyes may be any of the common methods employing solutions, emulsions, minute solid particle dispersions, or states in which dyes are mordanted by polymer mordants. The used amounts of these compounds are determined based on the targeted absorption amount. However, it is preferable that they are employed in the range of 1 μg-1 g per m² of the photosensitive material. In the heat developable photosensitive material of the present invention, the total absorbance at the exposure wavelength of all layers on the photosensitive layer-provided side on a support, which are specifically composed of a sublayer, a photosensitive layer, an interlayer, and a protective layer, radiation absorbing compounds (dyes or pigments) being preferably incorporated in the photosensitive layer, is set to the range of 0.30-1.00, while the total absorbance at the exposure wavelength of all layers on the side opposite the side on which the photosensitive layer is arranged, across the support, which are specifically composed of an antistatic sublayer, an antihalation layer, and a protective layer, radiation absorbing compounds (dyes or pigments) being preferably incorporated in the antihalation layer is set to the range of 0.20-1.50. By setting the absorbance as above, it is possible to realize targeted effects of the present invention. The total absorbance of all layers on the photosensitive layer side on the support is preferably 0.40-0.90, but is most preferably 0.50-0.80. Further, the total absorbance of all layers on the side opposite that on which the photosensitive layer is provided, across the support, is preferably 0.30-1.20, but is more preferably 0.40-1.00. By regulating the absorbance within the above range, it is possible to significantly improve image quality and to also significantly minimize density variation due to humidity change.

(Organic Silver Salts)

Organic silver salts usable in the present invention are non-photosensitive organic silver salts which can be a source to provide silver ions to for silver image in the photosensitive layer of the silver salt photothermographic dry imaging material.

Organic silver salts usable in the present invention are those which are relatively stable in light and form silver images in the presence of exposed photocatalysts (latent images of light-sensitive silver halide) when heated to at least 80° C.

Such light-insensitive organic silver salts are described in paragraphs (0048)-(0049) of JP-A No. 10-62899; line 24 on page 18-line 37 on page 19 of European Patent Publication Open to Public Inspection No. 962812A1; JP-A Nos. 11-349591, 2000-7683, 2000-72711, 2002-23301, 2002-23303, and 2002-49119; Japanese Patent Publication No. 196446; European Patent Publication Open to Public Inspection Nos. 1246001A1 and 1258775A1; JP-A Nos. 2003-140290, 2003-195445, 2003-295378, 2003-295379, 2002-295380, and 2003-295381.

In the present invention, employed together with the above organic silver salts may be silver salts of aliphatic carboxylic acid, particularly silver salts of long chain aliphatic carboxylic acid (having 10-30, but preferably 15-28 carbon atoms). The molecular weight of aliphatic carboxylic acids for forming silver salts is preferably 200-500, but is more preferably 250-400. Preferred examples of aliphatic silver salts include silver behenate, silver arachidate, silver stearate, silver oleate, silver laurate, silver caproate, silver myristate, silver palmitate, as well as mixtures thereof.

In the present invention, of these aliphatic acid silver salts, it is preferable to use aliphatic silver salts which incorporate silver behenate in an amount of preferably at least 50 mol percent, more preferably 80-99.9 mol percent, but still more preferably 90-99.9 mol percent.

Prior to preparation of silver aliphatic carboxylates, it is necessary to prepare alkaline metal salts of aliphatic carboxylic acid. In such a case, examples of the type of usable alkaline metal salts include sodium hydroxide, potassium hydroxide, and lithium hydroxide. Of these, it is preferable to employ one type of alkaline metal salt such as potassium hydroxide, but it is also preferable to simultaneously employ sodium hydroxide and potassium hydroxide. The ratio of the simultaneous use of those is preferably in the range of 10:90-75:25 in terms of mol ratio of these hydroxide salts. When an alkaline metal salt is formed via reaction with aliphatic carboxylic acid in the above region, it is possible to control the viscosity of the resultant reaction liquid in the desired state.

Further, when silver aliphatic carboxylates are prepared in the presence of silver halide grains at an average diameter of at most 0.050 μm, it is preferable that the ratio of potassium in alkaline metals of alkaline metal salts is higher than the other since dissolution of silver halide grains and Ostwald ripening are retarded. Further, as the ratio of potassium salts increases, it is possible to decrease the size of aliphatic acid silver salt grains. The ratio of potassium salts is preferably 50-100% with respect to all alkaline metal salts used in the production process of silver aliphatic carboxylates. The concentration of alkaline metal salts is preferably 0.1-0.3 mol/1,000 ml.

The average sphere equivalent diameter of non-photosensitive silver aliphatic carboxylate grains refers to the diameter of a sphere which has the same volume as that of one non-photosensitive silver aliphatic carboxylate grain, and is determined as follows. After coating, a sample is observed via a transmission type electron microscope, and the grain volume is obtained based on the projective area and the thickness of the observed grain, and the diameter of the sphere which has the same volume as the observed grain is obtained, followed by averaging the resultant values. It is possible to readily control the average sphere equivalent diameter of non-photosensitive silver aliphatic carboxylates by regulating the ratio of potassium salts, for example, to be higher during preparation of silver aliphatic carboxylates, or by appropriately regulating the particle diameter of zirconia beads, the peripheral rate, and the dispersion time of a dispersion mill employed during dispersion of a photosensitive emulsion. In order to realize sufficient density after heat development, the average sphere equivalent diameter of non-photosensitive silver carboxylate grains is preferably 0.05-0.50 μm, is more preferably 0.10-0.45 μm, but is most preferably 0.15-0.40 μm.

Also employed as organic silver other than those described above may be core-shell organic silver salts (JP-A No. 2002-23303), silver salts of polyhydric carboxylic acids (European Patent No. 1,246,001 as well as JP-A No. 2004-061948), and polymer silver salts (JP-A Nos. 2000-292881, 2003-295378-2003-295381).

The form of organic silver salts usable in the present invention is not particularly limited and may include any of a needle form, a rod form, tabular form, or a scaly form. In the present invention, scaly organic silver salts are preferred. In addition, preferably employed are a short acicular form at a length ratio of the minor axis to the major axis of at least 5, a rectangular parallelepiped, a cube, and a potato-shaped irregular particle.

Scaly organic acid silver salts, as described in the present invention, are defined as follows. Organic acid silver salts are observed employing an electron microscope, and the shape of the organic silver salt particles is approximated to a cube. Then, the sides of the cube are determined and are represented by a, b, and c in the order of the shortest to the longest, and x is obtained employing the formula below.
x=b/a

In such a manner, x, of about 200 particles, is determined and averaged. When the resulting average is represented by x (average), those which satisfy the relationship of x (average)≧1.5 are defined as being scaly. The above relationship is preferably 30≧x (average)≧1.5, but is more preferably 20≧x (average)≧2.0. Incidentally, a acicular form meets the relationship of 1≦x≦1.5.

With regard to the scaly particles, it is possible to regard “a” as thickness of tabular particles in which the plane having sides of “b” and “c” is the major plane. The average of “a” is preferably 0.01-0.23 μm, but is more preferably 0.1-0.20 μm. The average of c/b is preferably 1-6, is more preferably 1.05-4, is still more preferably 1.1-3, but is most preferably 1.1-2.

The particle size distribution of organic silver salts is preferably a monodispersion. In a monodispersion, as described herein, the percentage of the value obtained by dividing the standard deviation of each of the minor axis and the major axis by each of the length of the minor axis and the major axis is preferably at most 100 percent, is more preferably at most 80 percent, but is most preferably at most 50 percent. It is possible to determine the shape of organic silver salts utilizing electron microscopic images of an organic silver salt dispersion. Another method to determine monodispersion includes one in which the standard deviation of the volume weighted-average diameter of organic silver salts is determined. The percentage (being a variation coefficient) of the value, obtained by dividing by the volume weighted-average diameter, is preferably at most 100 percent, is more preferably at most 80 percent, but is most preferably at most 50 percent. The measurement method follows. For example, a laser beam is irradiated to organic silver salts dispersed into a liquid. Subsequently, it is possible to determine the above values based on the particle size (being a volume weighted-average diameter which is obtained by determining the autocorrelation function with respect to the time variation of the fluctuation of scattered light).

It is possible to produce and disperse organic acid silver employed in the present invention, by employing methods known in the art. It is possible to refer, for example, to the aforesaid JP-A No. 10-62899, European Patent Publication Open to Public Inspection Nos. 803763A1 and 9628122A1, as well as JP-A Nos. 2001-167022, 2000-7683, 2000-72711, 2001-1638899, 2001-163890, 2001-163827, 2001-33907, 2001-188313, 2001-83652, 2002-6442, 2002-31870, and 2003-280135.

Incidentally, during dispersion of organic silver salts, when light-sensitive salts are simultaneously present, fog increases and photographic speed markedly decreases. Due to that, it is preferable that during the dispersion, the substantial amount of light-sensitive silver salts is not incorporated. In the present invention, the amount of light-sensitive silver salts in an aqueous dispersion, into which those salts are dispersed, is preferably at most 1 mol per mol of the organic acid silver salts in the above liquid, but is more preferably at most 0.1 mol. It is further more preferable that the light-sensitive silver salts are not added.

In the present invention, it is possible to produce light-sensitive materials by blending an aqueous organic silver salt dispersion with an aqueous light-sensitive silver salt dispersion. The mixing ratio of the organic silver salts to the light-sensitive silver salts may be chosen depending on purposes. The ratio of the light-sensitive silver salts to the organic silver salts is preferably in the range of 1-30 mol percent, is more preferably 2-20 mol percent, but is most preferably 3-15 mol percent. When mixed, blending at least two types of aqueous organic silver salt dispersions with at least two types of aqueous light-sensitive silver salt dispersion is a method which is preferably employed to control photographic characteristics.

It is possible to use the organic silver salts of the present invention in the desired amount. However, an amount in terms of silver is preferably 0.1-5 g/m², is more preferably 0.3-3 g/m², but is still more preferably 0.5-3 g/m².

<Silver Halide Grains>

Photosensitive silver halide grains (hereinafter simply referred to as silver halide grains) will be described which are employed in the silver salt photothermographic dry imaging material of the present invention (hereinafter simply referred to as the photosensitive material of the present invention).

The photosensitive silver halide grains, as described in the present invention, refer to silver halide crystalline grains which can originally absorb light as an inherent quality of silver halide crystals, can absorb visible light or infrared radiation through artificial physicochemical methods and are treatment-produced so that physicochemical changes occur in the interior of the silver halide crystal and/or on the crystal surface, when the crystals absorb any radiation from ultraviolet to infrared.

Silver halide grains employed in the present invention can be prepared in the form of silver halide grain emulsions, employing publicly known methods. Namely, any of an acidic method, a neutral method, or an ammonia method may be employed. Further, employed as methods to allow water-soluble silver salts to react with water-soluble halides may be any of a single-jet precipitation method, a double-jet precipitation method, or combinations thereof. However, of these methods, the so-called controlled double-jet precipitation method is preferably employed in which silver halide grains are prepared while controlling formation conditions.

Grain formation is commonly divided into two stages, that is, the formation of silver halide seed grains (being nuclei) and the growth of the grains. Either method may be employed in which two stages are continually carried out, or in which the formation of nuclei (seed grains) and the growth of grains are carried out separately. A controlled double-jet precipitation method, in which grains are formed while controlling the pAg and pH which are grain forming conditions, is preferred, since thereby it is possible to control grain shape as well as grain size. For example, when the method, in which nucleus formation and grain growth are separately carried out, is employed, initially, nuclei (being seed grains) are formed by uniformly and quickly mixing water-soluble silver salts with water-soluble halides in an aqueous gelatin solution. Subsequently, under the controlled pAg and pH, silver halide grains are prepared through a grain growing process which grows the grains while supplying water-soluble silver salts as well as water-soluble halides.

After grain formation, unnecessary salts can be eliminated using a desalting method so as to obtain targeted silver halide grains. Examples of desalting methods are, a noodle method, a flocculation method, an ultrafiltering method and an electrodialysis.

In the present invention, silver halide grains are preferably in a state of monodispersion. Monodispersion, as described herein, means that the variation coefficient, obtained by the formula described below, is less than or equal to 30 percent. The aforesaid variation coefficient is preferably less than or equal to 20 percent, and is more preferably less than or equal to 15 percent.
Variation coefficient (in percent) of grain diameter=standard deviation of grain diameter/average of grain diameter×100

Cited as shapes of silver halide grains may be cubic, octahedral and tetradecahedral grains, planar grains, spherical grains, rod-shaped grains, and roughly elliptical-shaped grains. Of these, cubic, octahedral, tetradecahedral, and planar silver halide grains are particularly preferred.

When the aforesaid planar silver halide grains are employed, their average aspect ratio is preferably 1.5 to 100, and is more preferably 2 to 50. These are described in U.S. Pat. Nos. 5,264,337, 5,314,798, and 5,320,958, and incidentally it is possible to easily prepare the aforesaid target planar grains. Further, it is possible to preferably employ silver halide grains having rounded corners.

The crystal habit of the external surface of silver halide grains is not particularly limited. However, when spectral sensitizing dyes, which exhibit crystal habit (surface) selectiveness are employed, it is preferable that silver halide grains are employed which have the crystal habit matching their selectiveness in a relatively high ratio. For example, when sensitizing dyes, which are selectively adsorbed onto a crystal plane having a Miller index of (100), it is preferable that the ratio of the (100) surface on the external surface of silver halide grains is high. The ratio is preferably at least 50 percent, is more preferably at least 70 percent, and is most preferably at least 80 percent. Incidentally, it is possible to obtain a ratio of the surface having a Miller index of (100), based on T. Tani, J. Imaging Sci., 29, 165 (1985), utilizing adsorption dependence of sensitizing dye in a (111) plane as well as a (100) surface.

The silver halide grains, employed in the present invention, are preferably prepared employing low molecular weight gelatin, having an average molecular weight of less than or equal to 50,000 during the formation of the grains, which are preferably employed during formation of nuclei.

The low molecular weight gelatin refers to gelatin having an average molecular weight of less than or equal to 50,000. The molecular weight is preferably from 2,000 to 40,000, and is more preferably from 5,000 to 25,000. It is possible to measure the molecular weight of gelatin employing gel filtration chromatography.

The low molecular weight gelatin can be obtained from usually used gelatin with a molecular weight of about 100,000 employing various methods. Examples of such methods are, degradation of a high molecular weight gelatin solution with gelatin degradation enzyme, hydrolysis with acid or alkali under heating condition, thermal degradation under an atmospheric pressure or under pressure, ultrasonic degradation or using the combined method thereof.

The concentration of dispersion media during the formation of nuclei is preferably less than or equal to 5 percent by weight. It is more effective to carry out the formation at a low concentration of 0.05 to 3.00 percent by weight.

During formation of the silver halide grains employed in the present invention, it is possible to use a compound represented by the Formula described below.
YO(CH₂CH₂O)ₘ(CH(CH₃)CH₂O)ₚ(CH₂CH₂O)ₙY Formula
wherein Y represents a hydrogen atom, —SO₃M, or —CO—B—COOM; M represents a hydrogen atom, an alkali metal atom, an ammonium group, or an ammonium group substituted with an alkyl group having less than or equal to 5 carbon atoms; B represents a chained or cyclic group which forms an organic dibasic acid; m and n each represents 0 through 50; and p represents 1 through 100.

When silver halide photosensitive photographic materials are produced, polyethylene oxides, represented by the above Formula, have been preferably employed as anti-foaming agents to counter marked foaming which occurs while stirring and transporting emulsion raw materials in a process in which an aqueous gelatin solution is prepared, in the process in which water-soluble halides as well as water-soluble silver salts are added to the gelatin solution, and in a process in which the resultant emulsion is applied onto a support. Techniques to employ polyethylene oxides as an anti-foaming agent are disclosed in, for example, JP-A No. 44-9497. The polyethylene oxides represented by the above Formula function as an anti-foaming agent during nuclei formation.

The content ratio of polyethylene oxides, represented by the above Formula, is preferably less than or equal to 1 percent by weight with respect to silver, and is more preferably from 0.01 to 0.10 percent by weight.

It is desired that polyethylene oxides, represented by the above Formula, are present during nuclei formation. It is preferable that they are previously added to the dispersion media prior to nuclei formation. However, they may also be added during nuclei formation, or they may be employed by adding them to an aqueous silver salt solution or an aqueous halide solution which is employed during nuclei formation. However, they are preferably employed by adding them to an aqueous halide solution, or to both aqueous solutions in an amount of 0.01 to 2.00 percent by weight. Further, it is preferable that they are present during at least 50 percent of the time of the nuclei formation process, and it is more preferable that they are present during at least 70 percent of the time of the same. The polyethylene oxides, represented by the above Formula, may be added in the form of powder or they may be dissolved in a solvent such as methanol and then added.

Incidentally, temperature during nuclei formation is commonly from 5 to 60° C., and is preferably from 15 to 50° C. It is preferable that the temperature is controlled within the range, even when a constant temperature, a temperature increasing pattern (for example, a case in which temperature at the initiation of nuclei formation is 25° C., subsequently, temperature is gradually increased during nuclei formation and the temperature at the completion of nuclei formation is 40° C.), or a reverse sequence may be employed.

The concentration of an aqueous silver salt solution and an aqueous halide solution, employed for nuclei formation, is preferably less than or equal to 3.5 M, and is more preferably in the lower range of 0.01 to 2.50 M. The silver ion addition rate during nuclei formation is preferably from 1.5×10⁻³ to 3.0×10⁻¹ mol/minute, and is more preferably from 3.0×10⁻³ to 8.0×10⁻² mol/minute.

The pH during nuclei formation can be set in the range of 1.7 to 10.0. However, since the pH on the alkali side broadens the particle size distribution of the formed nuclei, the preferred pH is from 2 to 6. Further, the pBr during nuclei formation is usually from about 0.05 to about 3.00, is preferably from 1.0 to 2.5, and is more preferably from 1.5 to 2.0.

In the present invention, an average grain size of silver halide grains is usually from 10 to 50 nm, preferably from 10 to 40 nm, and more preferably from 10 to 35 nm. When the average grain size is less than 10 nm, the image density may be decreased or light fastness of the image may be deteriorated. When the average grain size is more than 50 nm, the image density may be also decreased.

Incidentally, grain diameter, as described herein, refers to the edge length of silver halide grains which are so-called regular crystals such as a cube or an octahedron. Further, when silver halide gains are planar, the grain diameter refers to the diameter of the circle which has the same area as the projection area of the main surface.

When the silver halide grains are not regular crystals, such as spherical shape, rod shape, the grain sizes are calculated based on the sphere having the same volume. An average grain size can be obtained from 300 grains measured by electron microscope.

Further, in the present invention, by employing silver halide grains, at an average grain size of 55-100 nm, together with silver halide grains of an average grain size of 10-50 nm, it is possible to enhance image density and minimize a decrease in image density during storage. The ratio (being the weight ratio) of silver halide grains of an average grain size of 10-50 nm to silver halide grains of an average grain size of 55-100 nm is preferably 95:5-50:50, but is more preferably 90:10-60:40.

As noted above, when two types of silver halide grain emulsions which differ in the average grain diameter are employed, the above two types of silver halide emulsions may be blended and incorporated in a photosensitive layer. Further, to regulate the contrast, it is preferable that the photosensitive layer is composed of at least two layers and the two types of silver halide grain emulsions, as described above, are individually incorporated.

(Silver Halide Containing Silver Iodide in an Amount of 5-100 mol Percent)

In silver halide grains of the present invention, with regard to silver halide compositions, the content of silver iodide is preferably 5-100 mol percent. The content of silver iodide is more preferably 40-100 mol percent, still more preferably 70-100 more percent, and further more preferably 90-100 mol percent. When a silver iodide content ratio is in the above range, the composition distribution in a grain may be uniform or continuously varied.

Further, preferably employed may be silver halide grains having a core/shell structure in which the silver iodide content ratio is greater in the interior and/or on the surface. Preferred as structures is a 2- to 5-layered structure. Core/shell grains of a 2- to 4-layered structure are more preferred.

Introduction of silver iodide to silver halide grains is preferably performed employing a method in which an aqueous alkali iodide solution is added during grain formation, a method in which at lest one of minute silver iodide grains, minute silver iodobromide grains, minute iodochloride grains, or minute iodochlorobromide grains is added, and a method in which iodide ion releasing agents, described in JP-A Nos. 5-323487 and 6-11780, are employed.

It is preferable that the silver halides of the present invention exhibit, between 350 and 440 nm, direct transition absorption due to the silver iodide crystalline structure. Detection of whether these silver halides exhibit direct transition absorption is readily performed by observing excitonic absorption near 400-430 nm due to direct transition.

<Silver Halide Grains of Internal Latent Formation after Thermal Development>

The photosensitive silver halide grains according to the present invention are characterized in that they have a property to change from a surface latent image formation type to an internal latent image formation type after subjected to thermal development. This change is caused by decreasing the speed of the surface latent image formation by the effect of thermal development.

When the silver halide grains are exposed to light prior to thermal development, latent images capable of functioning as a catalyst of development reaction are formed on the surface of the aforesaid silver halide grains. “Thermal development” is a reduction reaction by a reducing agent for silver ions. On the other hand, when exposed to light after the thermal development process, latent images are more formed in the interior of the silver halide grains than the surface thereof. As a result, the silver halide grains result in retardation of latent image formation on the surface.

It was not known in the field of a photothermographic material to employ the above-mentioned silver halide grains which largely change their latent image formation function before and after thermal development.

Generally, when photosensitive silver halide grains are exposed to light, silver halide grains themselves or spectral sensitizing dyes, which are adsorbed on the surface of photosensitive silver halide grains, are subjected to photo-excitation to generate free electrons. Generated electrons are competitively trapped by electron traps (sensitivity centers) on the surface or interior of silver halide grains. Accordingly, when chemical sensitization centers (chemical sensitization specks) and dopants, which are useful as an electron trap, are much more located on the surface of the silver halide grains than the interior thereof and the number is appropriate, latent images are dominantly formed on the surface, whereby the resulting silver halide grains become developable. Contrary to this, when chemical sensitization centers (chemical sensitization specks) and dopants, which are useful as an electron trap, are much more located in the interior of the silver halide grains than the surface thereof and the number is appropriate, latent images are dominantly formed in the interior, whereby it becomes difficult to develop the resulting silver halide grains. In other words, in the former, the surface speed is higher than interior speed, while in the latter, the surface speed is lower than the interior speed. The former type of latent image is called “a surface latent image”, and the latter is called “an internal latent image”. Examples of the references are:

(1) T. H. James ed., “The Theory of the Photographic Process” 4^{th} edition, Macmillan Publishing Co., Ltd. 1977; and

(2) Japan Photographic Society, “Shashin Kogaku no Kiso” (Basics of Photographic Engineering), Corona Publishing Co. Ltd., 1998.

The photosensitive silver halide grains of the present invention are preferably provided with dopants which act as electron trapping in the interior of silver halide grains at least in a stage of exposure to light after thermal development. This is required so as to achieve high photographic speed grains as well as high image keeping properties.

It is especially preferred that the dopants act as a hole trap during an exposure step prior to thermal development, and the dopants change after a thermal development step resulting in functioning as an electron trap.

Electron trapping dopants, as described herein, refer to silver, elements except for halogen or compounds constituting silver halide, and the aforesaid dopants themselves which exhibit properties capable of trapping free electron, or the aforesaid dopants are incorporated in the interior of silver halide grains to generate electron trapping portions such as lattice defects. For example, listed are metal ions other than silver ions or salts or complexes thereof, chalcogen (such as elements of oxygen family) sulfur, selenium, or tellurium, inorganic or organic compounds comprising nitrogen atoms, and rare earth element ions or complexes thereof.

Listed as metal ions, or salts or complexes thereof may be lead ions, bismuth ions, and gold ions, or lead bromide, lead carbonate, lead sulfate, bismuth nitrate, bismuth chloride, bismuth trichloride, bismuth carbonate, sodium bismuthate, chloroauric acid, lead acetate, lead stearate, and bismuth acetate.

Employed as compounds comprising chalcogen such as sulfur, selenium, and tellurium may be various chalcogen releasing compounds which are generally known as chalcogen sensitizers in the photographic industry. Further, preferred as organic compounds comprising chalcogen or nitrogen are heterocyclic compounds which include, for example, imidazole, pyrazole, pyridine, pyrimidine, pyrazine, pyridazine, triazole, triazine, indole, indazole, purine, thiazole, oxadiazole, quinoline, phthalazine, naphthylizine, quinoxaline, quinazoline, cinnoline, pteridine, acridine, phenanthroline, phenazine, tetrazole, thiazole, oxazole, benzimidazole, benzoxazole, benzothiazole, indolenine, and tetraazaindene. Of these, preferred are imidazole, pyrazine, pyrimidine, pyrazine, pyridazine, triazole, triazine, thiadiazole, oxadiazole, quinoline, phthalazine, naphthylizine, quinoxaline, quinazoline, cinnoline, tetrazole, thiazole, oxazole, benzimidazole, benzoxazole, benzothiazole, and tetraazaindene.

Incidentally, the aforesaid heterocyclic compounds may have substituent(s). Preferable substituents include an alkyl group, an alkenyl group, an aryl group, an alkoxy group, an aryloxy group, an acyloxy group, an acyl group, an alkoxycarbonyl group, an aryloxycarbonyl group, an acyloxy group, an acylamino group, an alkoxycarbonylamino group, an aryloxycarbonylamino group, a sulfonylamino group, a sulfamoyl group, a carbamoyl group, a sulfonyl group, a ureido group, a phosphoric acid amide group, a halogen atom, a cyano group, a sulfo group, a carboxyl group, a nitro group, a heterocyclic group. Of these, more preferred are an alkyl group, an aryl group, an alkoxy group, an aryloxy group, an acyl group, an acylamino group, an alkoxycarbonylamino group, an aryloxycarbonylamino group, a sulfonylamino group, a sulfamoyl group, a carbamoyl group, a ureido group, a phosphoric acid amido group, a halogen atom, a cyano group, a nitro group, and a heterocyclic group. More preferred are an alkyl group, an aryl group, an alkoxy group, an aryloxy group, an acyl group, an acylamino group, a sulfonylamino group, a sulfamoyl group, a carbamoyl group, a halogen atom, a cyano group, a nitro group, and a heterocyclic group.

Incidentally, ions of transition metals which belong to Groups 6 through 11 in the Periodic Table may be chemically modified to form a complex employing ligands of the oxidation state of the ions and incorporated in silver halide grains employed in the present invention so as to function as an electron trapping dopant, as described above, or as a hole trapping dopant. Preferred as aforesaid transition metals are W, Fe, Co, Ni, Cu, Ru, Rh, Pd, Re, Os, Ir, and Pt.

In the present invention, aforesaid various types of dopants may be employed individually or in combination of at least two of the same or different types. It is required that at least one of the dopants act as an electron trapping dopant during an exposure time after being thermal developed. They may be incorporated in the interior of the silver halide grains in any forms of chemical states.

It is not recommended to use a complex or a salt of Ir or Cu as a single dopant without combining with other dopant.

The content ratio of dopants is preferably in the range of 1×10⁻⁹ to 1×10 mol per mol of silver, and is more preferably 1×10⁻⁶ to 1×10⁻² mol.

However, the optimal amount varies depending the types of dopants, the diameter and shape of silver halide grains, and ambient conditions. Accordingly, it is preferable that addition conditions are optimized taking into account these conditions.

In the present invention, preferred as transition metal complexes or complex ions are those represented by the Formula described below.
Formula [ML₆]^{m}
wherein M represents a transition metal selected from the elements of Groups 6 through 11 in the Periodic Table; L represents a ligand; and m represents 0, -, 2-, 3-, or 4-. Listed as specific examples of ligands represented by L are a halogen ion (a fluoride ion, a chloride ion, a bromide ion, or an iodide ion), a cyanide, a cyanate, a thiocyanate, a selenocyanate, a tellurocyanate, an azide, and an aqua ligand, and nitrosyl and thionitrosyl. Of these, aqua, nitrosyl, and thionitrosyl are preferred. When the aqua ligand is present, one or two ligands are preferably occupied by the aqua ligand. L may be the same or different.

It is preferable that compounds, which provide ions of these metals or complex ions, are added during formation of silver halide grains so as to be incorporated in the silver halide grains. The compounds may be added at any stage of, prior to or after, silver halide grain preparation, namely nuclei formation, grain growth, physical ripening or chemical ripening. However, they are preferably added at the stage of nuclei formation, grain growth, physical ripening, are more preferably added at the stage of nuclei formation and growth, and are most preferably added at the stage of nuclei formation. They may be added over several times upon dividing them into several portions. Further, they may be uniformly incorporated in the interior of silver halide grains. Still further, as described in JP-A Nos. 63-29603, 2-306236, 3-167545, 4-76534, 6-110146, and 5-273683, they may be incorporated so as to result in a desired distribution in the interior of the grains.

These metal compounds may be dissolved in water or suitable organic solvents (for example, alcohols, ethers, glycols, ketones, esters, and amides) and then added. Further, addition methods include, for example, a method in which either an aqueous solution of metal compound powder or an aqueous solution prepared by dissolving metal compounds together with NaCl and KCl is added to a water-soluble halide solution, a method in which silver halide grains are formed by a silver salt solution, and a halide solution together with a the compound solution as a third aqueous solution employing a triple-jet precipitation method, a method in which, during grain formation, an aqueous metal compound solution in a necessary amount is charged into a reaction vessel, or a method in which, during preparation of silver halide, other silver halide grains which have been doped with metal ions or complex ions are added and dissolved. Specifically, a method is preferred in which either an aqueous solution of metal compound powder or an aqueous solution prepared by dissolving metal compounds together with NaCl and KCl is added to a water-soluble halide solution. When added onto the grain surface, an aqueous metal compound solution in a necessary amount may be added to a reaction vessel immediately after grain formation, during or after physical ripening, or during chemical ripening.

Incidentally, it is possible to introduce non-metallic dopants into the interior of silver halide employing the same method as the metallic dopants.

In the imaging materials in accordance with the present invention, it is possible to evaluate whether the aforesaid dopants exhibit electron trapping properties or not, while employing a method which has commonly employed in the photographic industry. Namely a silver halide emulsion comprised of silver halide grains, which have been doped with the aforesaid dopant or decomposition product thereof so as to be introduced into the interior of grains, is subjected to photoconduction measurement, employing a microwave photoconduction measurement method. Subsequently, it is possible to evaluate the aforesaid electron trapping properties by comparing the resulting decrease in photoconduction to that of the silver halide emulsion comprising no dopant as a standard. It is also possible to evaluate the same by performing experiments in which the internal speed of the aforesaid silver halide grains is compared to the surface speed.

Further, a method follows which is applied to a finished photothermographic dry imaging material to evaluate the electron trapping dopant effect in accordance with the present invention. For example, prior to exposure, the aforesaid imaging material is heated under the same conditions as the commonly employed thermal development conditions. Subsequently, the resulting material is exposed to white light or infrared radiation through an optical wedge for a definite time (for example, 30 seconds), and thermally developed under the same thermal development conations as above, whereby a characteristic curve (or a densitometry curve) is obtained. Then, it is possible to evaluate the aforesaid electron trapping dopant effect by comparing the speed obtained based on the characteristic curve to that of the imaging material which is comprised of the silver halide emulsion which does not comprise the aforesaid electron trapping dopant. Namely, it is necessary to confirm that the speed of the former sample comprised of the silver halide grain emulsion comprising the dopant in accordance with the present invention is lower than the latter sample which does not comprise the aforesaid dopant.

After exposure, for the specified time of white light or light of the specified optical sensitizing region through an optical wedge to the above material, or after exposure in such a manner that illuminance of the laser beam on the photosensitive material is varied stepwise, the exposed material is thermally developed under commonly employed heat development conditions. Subsequently, a characteristic curve is prepared whereby photographic speed (S₁) is obtained. Further, prior to exposure, the above material is heated under the same conditions as above and then exposed under the same exposure conditions as above and photographic speed (S₂) is obtained based on the resulting characteristic curve. The ratio of (S₂/S₁) is preferably at most 1/10, but is more preferably at most 1/20. Further, the above ratio of imaging materials, which have undergone chemical sensitization, is at most 1/50, resulting in low photographic speed. Further, in the case in which chemical sensitization is carried out or the case in which the same is not carried out, it is most preferable that the surface of the material after heat development exhibits no photosensitivity.

Common heat development conditions, as described herein, refer to conditions which are assumed in the optimal range with regard to temperature, development time and ambient humidity. When in medical institutions such as hospitals, a silver salt photothermographic dry imaging material is thermally developed employing a commercial laser imager and images are formed which are suitable for the use such as diagnosis.

According to the present invention, addition methods of silver halide grains to the photosensitive layer are not particularly limited. For example, it is preferable that silver halide grains of the present invention, particularly thermal conversion internal latent image forming type silver halide grains, are previously prepared and added to a solution to prepare silver aliphatic carboxylate grains, since the preparation process of silver halide grains and the preparation process of silver aliphatic carboxylate grains are separately handled, and it is also preferable in terms of production control. Further, a method is more preferred in which silver halide grains and silver aliphatic carboxylate grains each are separately prepared and just prior to the coating process, each of them is added to a photosensitive layer liquid composition.

The separately prepared photosensitive silver halide particles are subjected to desalting employing desalting methods known in the photographic art, such as a noodle method, a flocculation method, an ultrafiltration method, and an electrophoresis method, while they may be employed without desalting.

The aforesaid silver halide grains are employed commonly in an amount of 0.001 to 0.7 mol per mol of aliphatic carboxylic acid silver salts and preferably in an amount of 0.03 to 0.5 mol.

<Chemical Sensitization>

The photosensitive silver halide of the present invention may undergo chemical sensitization. For instance, it is possible to create chemical sensitization centers (being chemical sensitization nuclei) utilizing compounds which release chalcogen such as sulfur, as well as noble metal compounds which release noble metals ions, such as gold ions, while employing methods described in, for example, JP-A Nos. 2001-249428 and 2001-249426.

The chemical sensitization nuclei is capable of trapping an electron or a hole produced by a photo-excitation of a sensitizing dye.

It is preferable that the aforesaid silver halide is chemically sensitized employing organic sensitizers containing chalcogen atoms, as described below.

It is preferable that the aforesaid organic sensitizers, comprising chalcogen atoms, have a group capable of being adsorbed onto silver halide grains as well as unstable chalcogen atom positions.

Employed as the aforesaid organic sensitizers may be those having various structures, as disclosed in JP-A Nos. 60-150046, 4-109240, and 11-218874. Of these, the aforesaid organic sensitizer is preferably at least one of compounds having a structure in which the chalcogen atom bonds to a carbon atom, or to a phosphorus atom, via a double bond. More specifically, a thiourea derivative having a heterocylic group and a triphenylphosphine derivative are preferred.

Chemical sensitization methods of the present invention can be applied based on a variety of methods known in the field of wet type silver halide materials. Examples are disclosed in: (1) T. H. James ed., “The Theory of the Photographic Process” 4^{th} edition, Macmillan Publishing Co., Ltd. 1977; and (2) Japan Photographic Society, “Shashin Kogaku no Kiso” (Basics of Photographic Engineering), Corona Publishing, 1979.

Specifically, when a silver halide emulsion is chemically sensitized, then mixed with a light-insensitive organic silver salt, the conventionally known chemical sensitizing methods ca be applied.

The employed amount of chalcogen compounds as an organic sensitizer varies depending on the types of employed chalcogen compounds, silver halide grains, and reaction environments during performing chemical sensitization, but is preferably from 10⁻⁸ to 10⁻² mol per mol of silver halide, and is more preferably from 10⁻⁷ to 10⁻³ mol.

The chemical sensitization environments are not particularly limited. However, it is preferable that in the presence of compounds which diminish chalcogenized silver or silver nuclei, or decrease their size, especially in the presence of oxidizing agents capable of oxidizing silver nuclei, chalcogen sensitization is performed employing organic sensitizers, containing chalcogen atoms. The sensitization conditions are that the pAg is preferably from 6 to 11, but is more preferably from 7 to 10, while the pH is preferably from 4 to 10, but is more preferably from 5 to 8. Further, the sensitization is preferably carried out at a temperature of less than or equal to 30° C.

Further, it is preferable that chemical sensitization, employing the aforesaid organic sensitizers, is carried out in the presence of either spectral sensitizing dyes or compounds containing heteroatoms, which exhibit the adsorption onto silver halide grains. By carrying out chemical sensitization in the presence of compounds which exhibit adsorption onto silver halide grains, it is possible to minimize the dispersion of chemical sensitization center nuclei, whereby it is possible to achieve higher speed as well as lower fogging. Though spectral sensitizing dyes will be described below, the compounds comprising heteroatoms, which result in adsorption onto silver halide grains, as descried herein, refer to, as preferable examples, nitrogen containing heterocyclic compounds described in JP-A No. 3-24537. Listed as heterocycles in nitrogen-containing heterocyclic compounds may be a pyrazole ring, a pyrimidine ring, a 1,2,4-triazine ring, a 1,2,3-triazole ring, a 1,3,4-thiazole ring, a 1,2,3-thiazole ring, a 1,2,4-thiadiazole ring, a 1,2,5-thiadiazole ring, 1,2,3,4-tetrazole ring, a pyridazine ring, and a 1,2,3-triazine ring, and a ring which is formed by combining 2 or 3 of the rings such as a triazolotriazole ring, a diazaindene ring, a triazaindene ring, and a pentaazaindenes ring. It is also possible to employ heterocyclic rings such as a phthalazine ring, a benzimidazole ring, an indazole ring and a benzothiazole ring, which are formed by condensing a single heterocyclic ring and an aromatic ring.

Of these, preferred is an azaindene ring. Further, preferred are azaindene compounds having a hydroxyl group, as a substituent, which include compounds such as hydroxytriazaindene, tetrahydroxyazaindene, and hydroxypentaazaindene.

The aforesaid heterocyclic ring may have substituents other than a hydroxyl group. As substituents, the aforesaid heterocyclic ring may have, for example, an alkyl group, a substituted alkyl group, an alkylthio group, an amino group, a hydroxyamino group, an alkylamino group, a dialkylamino group, an arylamino group, a carboxyl group, an alkoxycarbonyl group, a halogen atom, and a cyano group.

The added amount of these heterocyclic compounds varies widely depending on the size and composition of silver halide grains, and other conditions. However, the amount is in the range of about 10⁻⁶ to 1 mol per mol with respect to silver halide, and is preferably in the range of 10⁻⁴ to 10⁻¹ mol.

The photosensitive silver halide of the present invention may undergo noble metal sensitization utilizing compounds which release noble metal ions such as gold ions. For example, employed as gold sensitizers may be chloroaurates and organic gold compounds disclosed in JP-A No. 11-194447.

Further, other than the aforesaid sensitization methods, it is possible to employ a reduction sensitization method. Employed as specific compounds for the reduction sensitization may be ascorbic acid, thiourea dioxide, stannous chloride, hydrazine derivatives, boron compounds, silane compounds, and polyamine compounds. Further, it is possible to perform reduction sensitization by ripening an emulsion while maintaining a pH higher than or equal to 7 or a pAg less than or equal to 8.3.

Silver halide which undergoes the chemical sensitization, according to the present invention, includes one which has been formed in the presence of organic silver salts, another which has been formed in the absence of organic silver salts, or still another which has been formed by mixing those above.

In the present invention, it is preferable that the surface of photosensitive silver halide grains undergoes chemical sensitization and the resulting chemical sensitizing effects are substantially lost after the thermal development process. “Chemical sensitization effects are substantially lost after the thermal development process”, as described herein, means that the speed of the aforesaid imaging material which has been achieved by the aforesaid chemical sensitization techniques decreases to 1.1 times or less compared to the speed of aforesaid material which does not undergo chemical sensitization.

In order to decrease the effect of chemical sensitization after thermal development treatment, it is required to incorporate sufficient amount of an oxidizing agent capable to destroy the center of chemical sensitization by oxidation in an photosensitive emulsion layer or non-photosensitive layer of the imaging material. An example of such compound is a aforementioned compound which release a halogen radical. An amount of incorporated oxidizing agent is preferably adjusted by considering an oxidizing power of the oxidizing agent and the degree of the decrease the effect of chemical sensitization.

<Spectral Sensitization>

It is preferable that photosensitive silver halide in the present invention is adsorbed by spectral sensitizing dyes so as to result in spectral sensitization. Employed as spectral sensitizing dyes may be cyanine dyes, merocyanine dyes, complex cyanine dyes, complex merocyanine dyes, homopolar cyanine dyes, styryl dyes, hemicyanine dyes, oxonol dyes, and hemioxonol dyes. For example, employed may be sensitizing dyes described in JP-A Nos. 63-159841, 60-140335, 63-231437, 63-259651, 63-304242, and 63-15245, and U.S. Pat. Nos. 4,639,414, 4,740,455, 4,741,966, 4,751,175, and 4,835,096.

Useful sensitizing dyes, employed in the present invention, are described in, for example, Research Disclosure, Item 17645, Section IV-A (page 23, December 1978) and Item 18431, Section X (page 437, August 1978) and publications further cited therein. It is specifically preferable that those sensitizing dyes are used which exhibit spectral sensitivity suitable for spectral characteristics of light sources of various types of laser imagers, as well as of scanners. For example, preferably employed are compounds described in JP-A Nos. 9-34078, 9-54409, and 9-80679.

Useful cyanine dyes include, for example, cyanine dyes having basic nuclei such as a thiazoline nucleus, an oxazoline nucleus, a pyrroline nucleus, a pyridine nucleus, an oxazole nucleus, a thiazole nucleus, a selenazole nucleus, and an imidazole nucleus. Useful merocyanine dyes, which are preferred, comprise, in addition to the basic nuclei, acidic nuclei such as a thiohydantoin nucleus, a rhodanine nucleus, an oxazolizinedione nucleus, a thiazolinedione nucleus, a barbituric acid nucleus, a thiazolinone nucleus, a marononitryl nucleus, and a pyrazolone nucleus.

In the present invention, it is possible to employ sensitizing dyes which exhibit spectral sensitivity, specifically in the infrared region. Listed as preferably employed infrared spectral sensitizing dyes are infrared spectral sensitizing dyes disclosed in U.S. Pat. Nos. 4,536,473, 4,515,888, and 4,959,294.

It is preferable that at least one selected from the sensitizing dyes represented by Formulas (1) and (2) described in U.S. Patent Publication Open to Public Inspection No. 20040224266 is incorporated in the silver salt photothermographic dry imaging material employed in the heat development method of the present invention. It is more preferable that at least one selected from the dyes represented by Formulas (5) and (6) described in the above patent is incorporated. To improve exposure wavelength dependency during exposure, it is particularly preferable to employ the sensitizing dye represented by Formula (5) together with the sensitizing dye represented by Formula (6).

It is possible to easily synthesize the aforesaid infrared sensitizing dyes, employing the method described in F. M. Harmer, “The Chemistry of Heterocyclic Compounds, Volume 18, The Cyanine Dyes and Related Compounds (A. Weissberger ed., published by Interscience, New York, 1964).

These infrared sensitizing dyes may be added at any time after preparing the silver halide. For example, the dyes may be added to solvents, or the dyes, in a so-called solid dispersion state in which the dyes are dispersed into minute particles, may be added to a photosensitive emulsion comprising silver halide grains or silver halide grains/aliphatic carboxylic acid silver salts. Further, in the same manner as the aforesaid heteroatoms containing compounds which exhibit adsorption onto silver halide grains, the dyes are adsorbed onto silver halide grains prior to chemical sensitization, and subsequently, undergo chemical sensitization, whereby it is possible to minimize the dispersion of chemical sensitization center nuclei so at to enhance speed, as well as to decrease fogging.

In the present invention, the aforesaid spectral sensitizing dyes may be employed individually or in combination. Combinations of sensitizing dyes are frequently employed when specifically aiming for supersensitization, for expanding or adjusting a spectral sensitization range.

An emulsion comprising photosensitive silver halide as well as aliphatic carboxylic acid silver salts, which are employed in the silver salt photothermographic dry imaging material of the present invention, may comprise sensitizing dyes together with compounds which are dyes having no spectral sensitization or have substantially no absorption of visible light and exhibit supersensitization, whereby the aforesaid silver halide grains may be supersensitized.

Useful combinations of sensitizing dyes and dyes exhibiting supersensitization, as well as materials exhibiting supersensitization, are described in Research Disclosure Item 17643 (published December 1978), page 23, Section J of IV; Japanese Patent Publication Nos. 9-25500 and 43-4933; and JP-A Nos. 59-19032, 59-192242, and 5-431432. Preferred as supersensitizers are hetero-aromatic mercapto compounds or mercapto derivatives.
Ar—SM
wherein M represents a hydrogen atom or an alkali metal atom, and Ar represents an aromatic ring or a condensed aromatic ring, having at least one of a nitrogen, sulfur, oxygen, selenium, or tellurium atom. Hetero-aromatic rings are preferably benzimidazole, naphthoimidazole, benzimidazole, naphthothiazole, benzoxazole, naphthooxazole, benzoselenazole, benztellurazole, imidazole, oxazole, pyrazole, triazole, triazine, pyrimidine, pyridazine, pyrazine, pyridine, purine, quinoline, or quinazoline. On the other hand, other hetero-aromatic rings are also included.

Incidentally, mercapto derivatives, when incorporated in the dispersion of aliphatic carboxylic acid silver salts and/or a silver halide grain emulsion, are also included which substantially prepare the mercapto compounds. Specifically, listed as preferred examples are the mercapto derivatives described below.
Ar—S—S—Ar
wherein Ar is the same as the mercapto compounds defined above.

The aforesaid hetero-aromatic rings may have a substituent selected from the group consisting of, for example, a halogen atom (for example, Cl, Br, and I), a hydroxyl group, an amino group, a carboxyl group, an alkyl group (for example, an alkyl group having at least one carbon atom and preferably having from 1 to 4 carbon atoms), and an alkoxy group (for example, an alkoxy group having at least one carbon atom and preferably having from 1 to 4 carbon atoms).

Other than the aforesaid supersensitizers, employed as supersensitizers may be compounds represented by Formula (5), shown below, which is disclosed in JP-A No. 2001-330918 and large ring compounds containing a hetero atom.

The amount of a supersensitizer of the present invention used in a photosensitive layer containing an organic silver salt and silver halide grains and in the present invention is in the range of 0.001 to 1.0 mol per mol of Ag. More preferably, it is 0.01 to 0.5 mol per mol of Ag.

In the present invention, it is preferable that the surface of photosensitive silver halide grains undergoes chemical sensitization and the resulting chemical sensitizing effects are substantially lost after the thermal development process. “Chemical sensitization effects are substantially lost after the thermal development process”, as described herein, means that the speed of the aforesaid imaging material which has been achieved by the aforesaid chemical sensitization techniques decreases to 1.1 times or less compared to the speed of aforesaid material which does not undergo chemical sensitization.

In order to decrease the effect of chemical sensitization after thermal development treatment, it is required to incorporate sufficient amount of an oxidizing agent capable to destroy the center of chemical sensitization by oxidation in an photosensitive emulsion layer or non-photosensitive layer of the imaging material. An example of such compound is a aforementioned compound which release a halogen radical. An amount of incorporated oxidizing agent is preferably adjusted by considering an oxidizing power of the oxidizing agent and the degree of the decrease the effect of chemical sensitization.

(Reducing Agents)

The reducing agents according to the present invention are those capable of reducing silver ions in the photosensitive layer, which are also called developing agents. In the present invention, it is preferable that the compounds represented by Formula (RD1) are employed individually or in combinations with the other reducing agents having a different chemical structure.

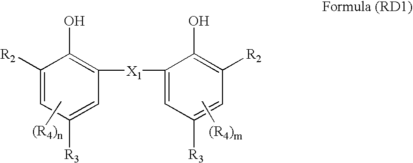

In the above formula, X₁ represents a chalcogen atom or CHR₁ wherein R₁ represents a hydrogen atom, a halogen atom, an alkyl group, an alkenyl group, or a heterocyclic group. Each R₂ represents an alkyl group and they may be the same or different. R₃ represents a hydrogen atom or a group capable of being substituted to a benzene ring. R₄ represents a group capable of being substituted to a benzene ring, while m and n each represents an integer of 0-2.

In the present invention, it is preferable that in order to yield desired tone, a compound of Formula (RD1) is simultaneously used with a compound represented by Formula (RD2) below.

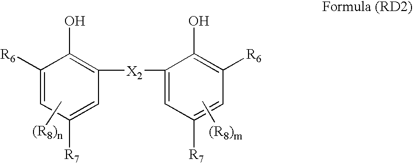

wherein X₂ represents a chalcogen atom or CHR₅ wherein R₅ represents a hydrogen atom, a halogen atom, an alkyl group, an alkenyl group, an aryl group, or a heterocyclic group; each R₆ represents an alkyl group which may be the same or different, but may not be a secondary or tertiary alkyl group; R₇ represents a hydrogen atom or a group capable of being substituted on a benzene ring; R₈ represents a group capable of being substituted on a benzene ring; and m and n each represents an integer of 0-2.

As a combination use ratio, being (weight of Formula (RD1) Compound):(weight of compound represented by Formula (RD2) is preferably 5:95-45:55, but is more preferably 10:90-40:60.

X₁ in Formula (RD1) represents a chalcogen atom or CHR₁. Specifically listed as chalcogen atoms are a sulfur atom, a selenium atom, and a tellurium atom. Of these, a sulfur atom is preferred.

R₁ in CHR₁ represents a hydrogen atom, a halogen atom, an alkyl group, an alkenyl group, an alkynyl group, an aryl group or a heterocyclic group. Listed as halogen atoms are, for example, a fluorine atom, a chlorine atom, and a bromine atom. Listed as alkyl groups are, alkyl groups having 1-20 carbon atoms, for example, a methyl group, an ethyl group, a propyl group, a butyl group, a hexyl group, a heptyl group and a cycloalkyl group. Examples of alkenyl groups are, a vinyl group, an allyl group, a butenyl group, a hexenyl group, a hexadienyl group, an ethenyl-2-propenyl group, a 3-butenyl group, a 1-methyl-3-propenyl group, a 3-pentenyl group, a 1-methyl-3-butenyl group and a cyclohexenyl group. Examples of aryl groups are, a phenyl group and a naphthyl group. Examples of heterocylic groups are, a thienyl group, a furyl group, an imidazolyl group, a pyrazolyl group and a pyrrolyl group. Of these, cyclic groups such as cycloalkyl groups and cycloalkenyl groups are preferred.

These groups may have a substituent. Listed as said substituents are a halogen atom (for example, a fluorine atom, a chlorine atom, or a bromine atom), a cycloalkyl group (for example, a cyclohexyl group or a cyclobutyl group), a cycloalkenyl group (for example, a 1-cycloalkenyl group or a 2-cycloalkenyl group), an alkoxy group (for example, a methoxy group, an ethoxy group, or a propoxy group), an alkylcarbonyloxy group (for example, an acetyloxy group), an alkylthio group (for example, a methylthio group or a trifluoromethylthio group), a carboxyl group, an alkylcarbonylamino group (for example, an acetylamino group), a ureido group (for example, a methylaminocarbonylamino group), an alkylsulfonylamino group (for example, a methanesulfonylamino group), an alkylsulfonyl group (for example, a methanesulfonyl group and a trifluoromethanesulfonyl group), a carbamoyl group (for example, a carbamoyl group, an N,N-dimethylcarbamoyl group, or an N-morpholinocarbonyl group), a sulfamoyl group (for example, a sulfamoyl group, an N,N-dimethylsulfamoyl group, or a morpholinosulfamoyl group), a trifluoromethyl group, a hydroxyl group, a nitro group, a cyano group, an alkylsulfonamido group (for example, a methanesulfonamido group or a butanesulfonamido group), an alkylamino group (for example, an amino group, an N,N-dimethylamino group, or an N,N-diethylamino group), a sulfo group, a phosphono group, a sulfite group, a sulfino group, an alkylsulfonylaminocarbonyl group (for example, a methanesulfonylaminocarbonyl group or an ethanesulfonylaminocarbonyl group), an alkylcarbonylaminosulfonyl group (for example, an acetamidosulfonyl group or a methoxyacetamidosulfonyl group), an alkynylaminocarbonyl group (for example, an acetamidocarbonyl group or a methoxyacetamidocarbonyl group), and an alkylsulfinylaminocarbonyl group (for example, a methanesulfinylaminocarbonyl group or an ethanesulfinylaminocarbonyl group). Further, when at least two substituents are present, they may be the same or different. Most preferred substituent is an alkyl group.

R₂ represents an alkyl group. Preferred as the alkyl groups are those, having 1-20 carbon atoms, which are substituted or unsubstituted. Specific examples include a methyl, ethyl, i-propyl, butyl, i-butyl, t-butyl, t-pentyl, t-octyl, cyclohexyl, 1-methylcyclohexyl, or 1-methylcyclopropyl group.

Substituents of the alkyl group are not particularly limited and include, for example, an aryl group, a hydroxyl group, an alkoxy group, an aryloxy group, an alkylthio group, an arylthio group, an acylamino group, a sulfonamide group, a sulfonyl group, a phosphoryl group, an acyl group, a carbamoyl group, an ester group, and a halogen atom. In addition, (R₄)ₙ and (R₄)ₘ may form a saturated ring. R₂ is preferably a secondary or tertiary alkyl group and preferably has 2-20 carbon atoms. R₂ is more preferably a tertiary alkyl group, is still more preferably a t-butyl group, a t-pentyl group, or a methylcyclohexyl group, and is most preferably a t-butyl group.

R₃ represents a hydrogen atom or a group capable of being substituted to a benzene ring. Listed as groups capable of being substituted to a benzene ring are, for example, a halogen atom such as fluorine, chlorine, or bromine, an alkyl group, an aryl group, a cycloalkyl group, an alkenyl group, a cycloalkenyl group, an alkynyl group, an amino group, an acyl group, an acyloxy group, an acylamino group, a sulfonylamino group, a sulfamoyl group, a carbamoyl group, an alkylthio group, a sulfonyl group, an alkylsulfonyl group, a sulfonyl group, a cyano group, and a heterocyclic group.

Preferably listed as R₃ are methyl, ethyl, i-propyl, t-butyl, cyclohexyl, 1-methylcyclohexyl, 2-hydroxyethyl and 3-hydroxypropyl.

These groups may further have a substituent. Employed as such substituents may be those listed in aforesaid R₁.

R₃ is preferably an alkyl group having 1-20 carbon atoms, incorporating a hydroxyl group as a substituent or an alkyl group having 1-20 carbon atoms, incorporating, as a substituent, a group capable of forming a hydroxyl group by being deblocked, but is more preferably an alkyl group having 3-10 carbon atoms incorporating a hydroxyl group as a substituent or an alkyl group having 3-10 carbon atoms incorporating, as a substituent, a group capable of forming a hydroxyl group by being deblocked. It is preferable to limit the number of carbon atoms of the alkyl group within the above range, since it is thereby possible to produce images in the average gradient range of 1.8-6.0 without an increase in contrast of images. R₃ is most preferably an alkyl group having 3-5 carbon atoms incorporating a hydroxyl group as a substituent. Cited as R₃ are, for example, 3-hydroxypropyl, 4-hydroxybutyl, and 5-hydroxypentyl. These groups may further have a substituent, and employed as such substituents may be the above substituents represented by R₁.

Preferably cited as a group which forms a hydroxyl group by being deblocked is a group which forms a hydroxyl group by being deblocked via the action of acid and/or heat.

Specifically listed are an ether group (a methoxy group, a tert-butoxy group, an allyloxy group, a benzoyloxy group, a triphenylmethoxy group, or a trimethylsilyloxy group), a hemiacetal group (a tetrahydropyranyloxy group), an ester group (an acetyloxy group, a benzoyloxy group, a p-nitrobenzoyloxy group, a formyloxy group, a trifluoroacetyloxy group, or a pivaloyloxy group), a carbonato group (an ethoxycarbonyloxy group, a phenoxycarbonyloxy group, and a tert-butyloxycarbonyloxy group), a sulfonato group (a p-toluenesulfonyloxy group and a benzenesulfonyloxy group), a carbamoyloxy group (a phenylcarbamoyloxy group), a thiocarbonyloxy group (a benzylthiocarbonyloxy group), a nitric acid ester group, or a sulfenato group (2,4-dinitrobenzenesulfenyloxy group).

R₃ is most preferably a primary alkyl group having 3-5 carbon atoms incorporating a hydroxyl group or its precursor group, and include, for example, 3-hydroxypropyl. The most preferred combination of R₂ and R₃ is that R₂ is a tertiary alkyl group (t-butyl, t-amyl, t-pentyl, or 1-methylcyclohexyl) while R₃ is a primary alkyl group (3-hydroxypropyl or 4-hydroxybutyl) having 3-10 carbon atoms incorporating a hydroxyl group or its precursor group. Plural R₂ and R₃ may be the same or different.

R₄ represents a group capable of being substituted to a benzene ring. Listed as specific examples may be an alkyl group having 1-25 carbon atoms (methyl, ethyl, propyl, i-propyl, t-butyl, pentyl, hexyl, or cyclohexyl), a halogenated alkyl group (trifluoromethyl or perfluorooctyl), a cycloalkyl group (cyclohexyl or cyclopentyl); an alkynyl group (propargyl), a glycidyl group, an acrylate group, a methacrylate group, an aryl group (phenyl), a heterocyclic group (pyridyl, thiazolyl, oxazolyl, imidazolyl, furyl, pyrrolyl, pyradinyl, pyrimidyl, pyridadinyl, selenazolyl, piperidinyl, sliforanyl, piperidinyl, pyrazolyl, or tetrazolyl), a halogen atom (chlorine, bromine, iodine or fluorine), an alkoxy group (methoxy, ethoxy, propyloxy, pentyloxy, cyclopentyloxy, hexyloxy, or cyclohexyloxy), an aryloxy group (phenoxy), an alkoxycarbonyl group (methyloxycarbonyl, ethyloxycarbonyl, or butyloxycarbonyl), an aryloxycarbonyl group (phenyloxycarbonyl), a sulfonamido group (methanesulfonamide, ethanesulfonamide, butanesulfonamide, hexanesulfonamide group, cyclohexabesulfonamide, benzenesulfonamide), sulfamoyl group (aminosulfonyl, methyaminosulfonyl, dimethylaminosulfonyl, butylaminosulfonyl, hexylaminosulfonyl, cyclohexylaminosufonyl, phenylaminosulfonyl, or 2-pyridylaminosulfonyl), a urethane group (methylureido, ethylureido, pentylureido, cyclopentylureido, phenylureido, or 2-pyridylureido), an acyl group (acetyl, propionyl, butanoyl, hexanoyl, cyclohexanoyl, benzoyl, or pyridinoyl), a carbamoyl group (aminocarbonyl, methylaminocarbonyl, dimethylaminocarbonyl, propylaminocarbonyl, a pentylaminocarbonyl group, cyclohexylaminocarbonyl, phenylaminocarbonyl, or 2-pyridylaminocarbonyl), an amido group (acetamide, propionamide, butaneamide, hexaneamide, or benzamide), a sulfonyl group (methylsulfonyl, ethylsulfonyl, butylsulfonyl, cyclohexylsulfonyl, phenylsulfonyl, or 2-pyridylsulfonyl), an amino group (amino, ethylamino, dimethylamino, butylamino, cyclopentylamino, anilino, or 2-pyridylamino), a cyano group, a nitro group, a sulfo group, a carboxyl group, a hydroxyl group, and an oxamoyl group. Further, these groups may further be substituted with these groups. Each of n and m represents an integer of 0-2. However, the most preferred case is that both n and m are 0. A plurality of R₄s may be the same or different.

Further, R₄ may form a saturated ring together with R₂ and R₃. R₄ is preferably a hydrogen atom, a halogen atom, or an alkyl group, and is more preferably a hydrogen atom.

In Formula (RD2), R₅ is a group similar to R₁, and R₇ is a group similar to R₃, while R₈ is a group similar to R₄. Each R₆ represents an alkyl group which may be the same or different, but are neither a secondary nor tertiary alkyl group.

R₇ represents a hydrogen atom or a group capable of being substituted to a benzene ring. Listed as groups capable of being substituted to a benzene ring are, for example, a halogen atom such as fluorine, chlorine, or bromine, an alkyl group, an aryl group, a cycloalkyl group, an alkenyl group, a cycloalkenyl group, an alkynyl group, an amino group, an acyl group, an acyloxy group, an acylamino group, a sulfonylamino group, a sulfamoyl group, a carbamoyl group, an alkylthio group, a sulfonyl group, an alkylsulfonyl group, a sulfonyl group, a cyano group, and a heterocyclic group.

Preferably listed as R₇ are methyl, ethyl, i-propyl, t-butyl, cyclohexyl, 1-methylcyclohexyl, 2-hydroxyethyl and 3-hydroxypropyl. More preferred are methyl and 3-hydroxypropyl.

Preferred as alkyl groups are those which are substituted or unsubstituted and have 1-20 carbon atoms. Specific examples include a methyl group, an ethyl group, a propyl group and a butyl group.

Substituents of the alkyl group are not particularly limited, and examples include an aryl group, a hydroxyl group, an alkoxy group, an aryloxy group, an alkylthio group, an arylthio group, an acylamino group, a sulfonamido group, a sulfonyl group, a phosphoryl group, an acyl group, a carbamoyl group, an ester group, and a halogen atom.

Further, a saturated ring may be formed with (R₈)ₙ and (R₈)ₘ. R₆ is preferably methyl group.

Preferable compound represented by Formula (RD2) are these compounds of Formulas (S) and (T) described in European Patent No. 1,278,101, and specific examples of the compounds include compounds (1-24), (1-28)-(1-54), and (1-56)-(1-75).

Specific examples of the compounds represented by Formulas (RD1) and (RD2) are listed below, however, the present invention is not limited thereto.

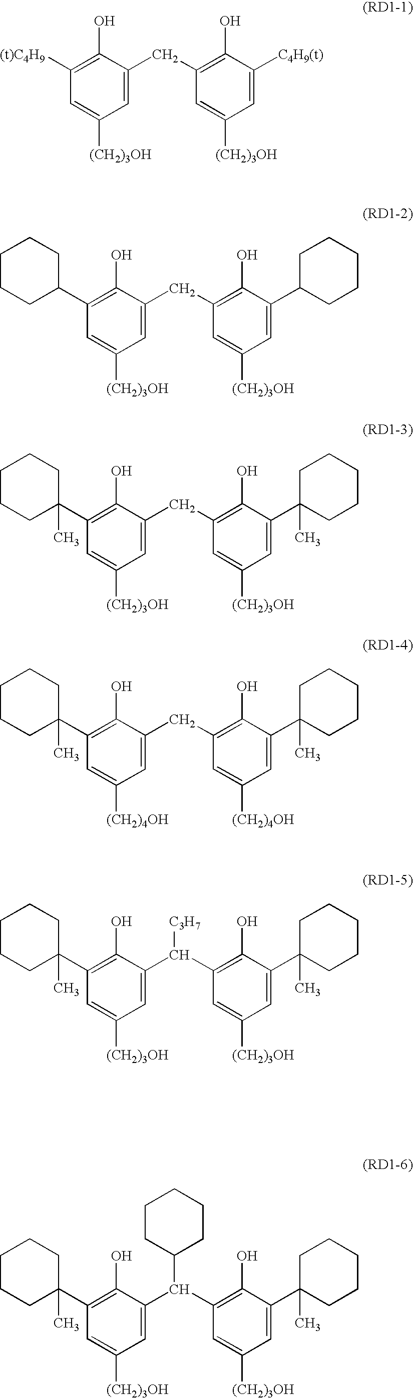

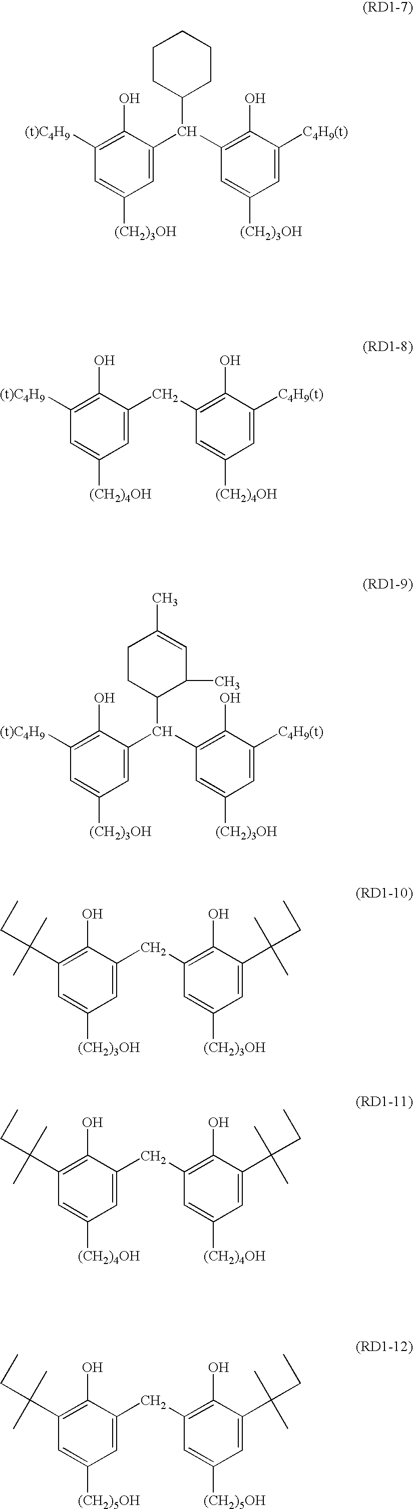

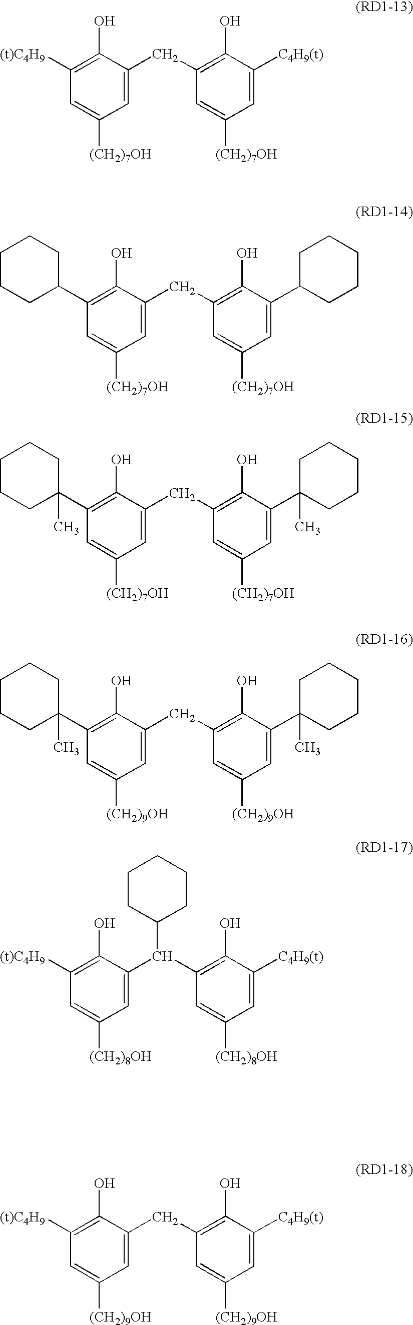

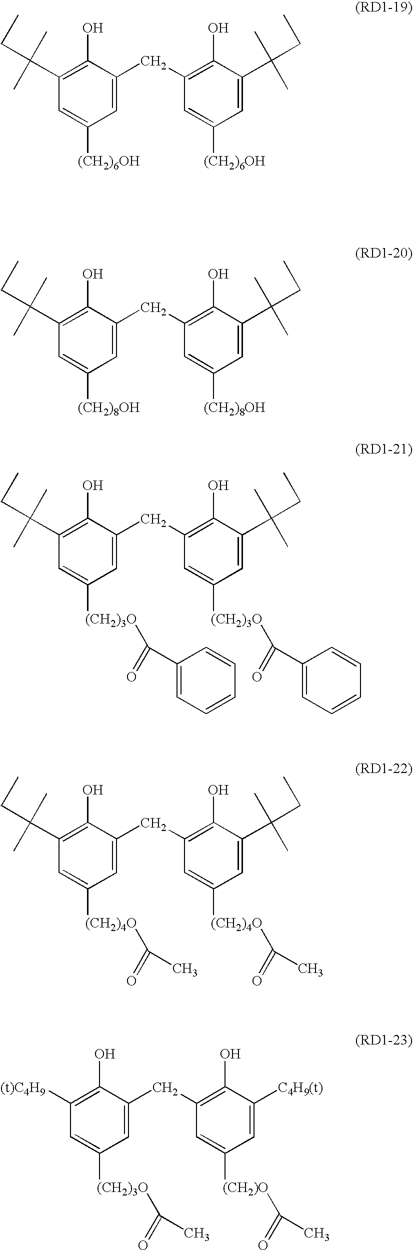

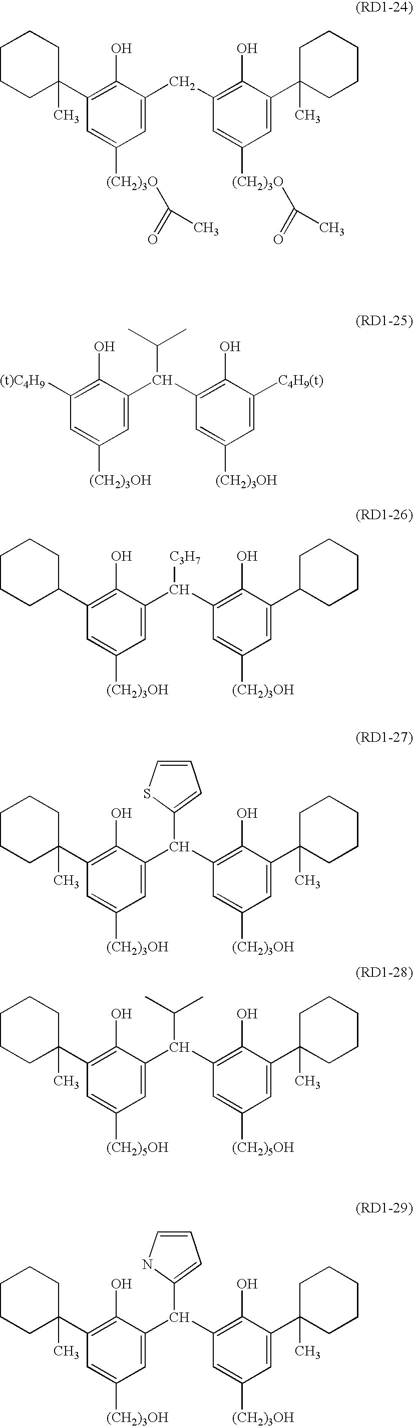

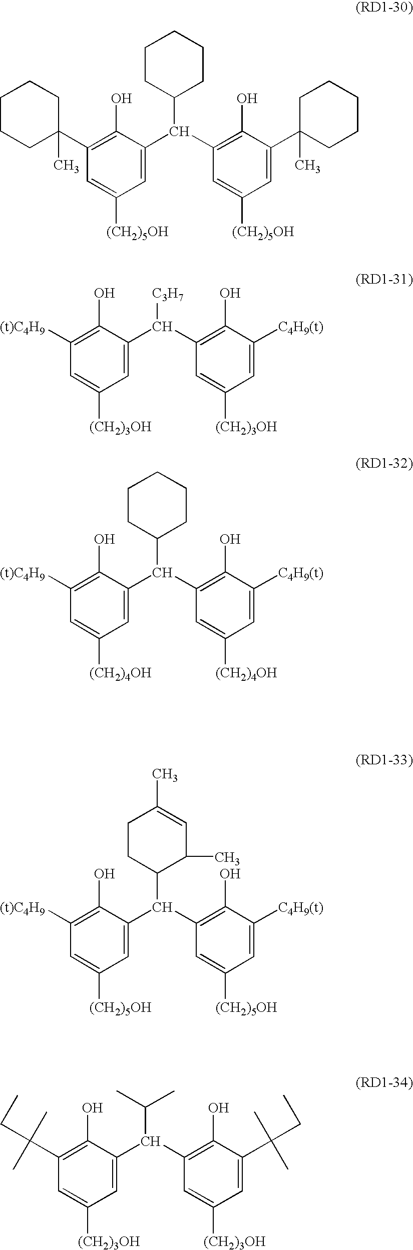

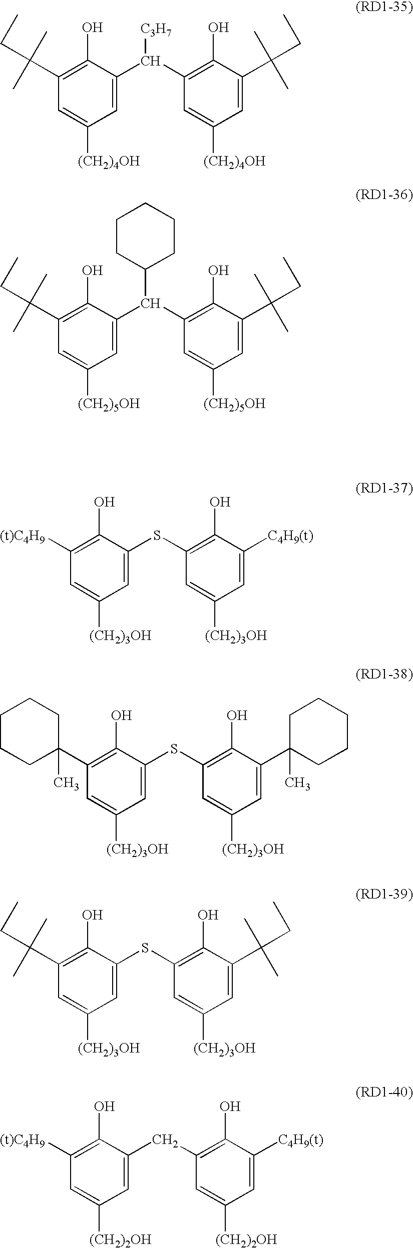

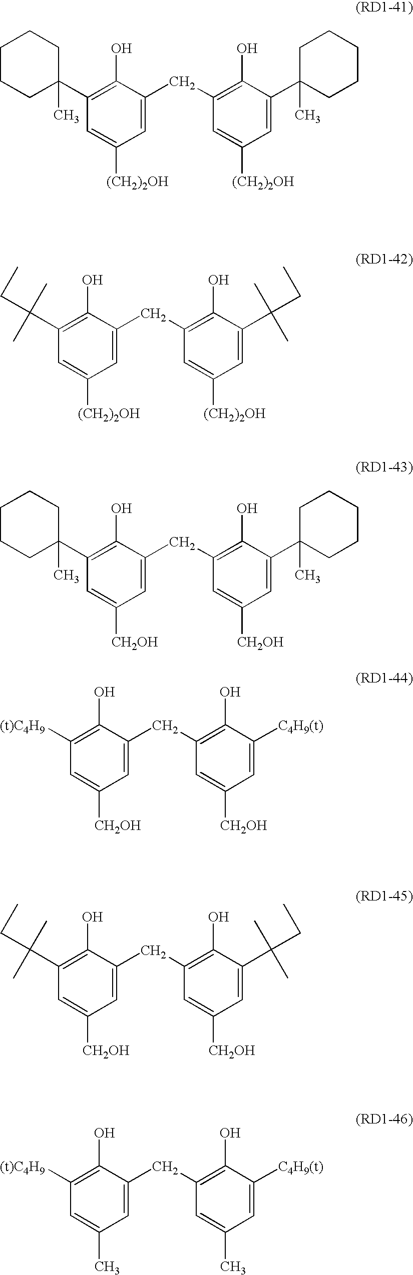

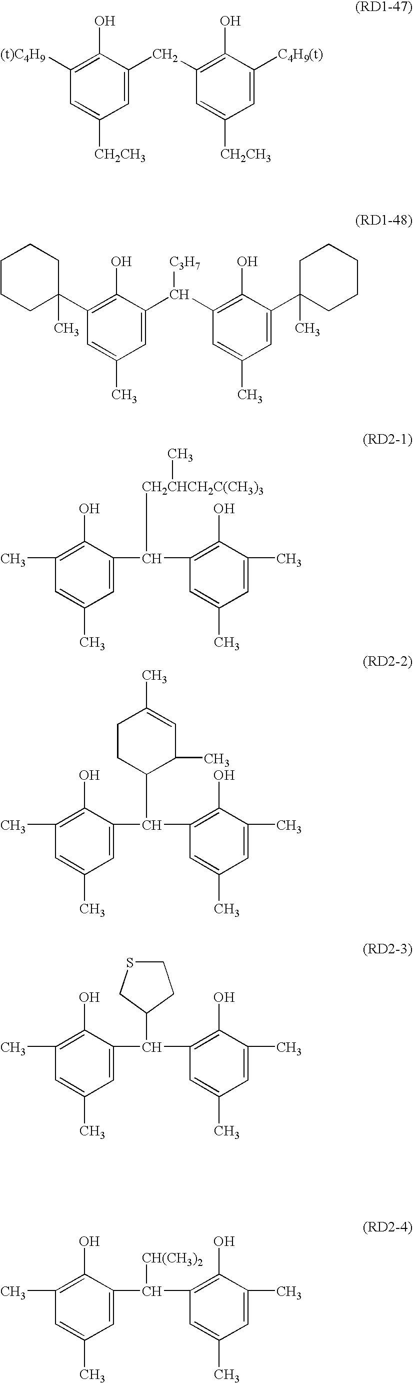

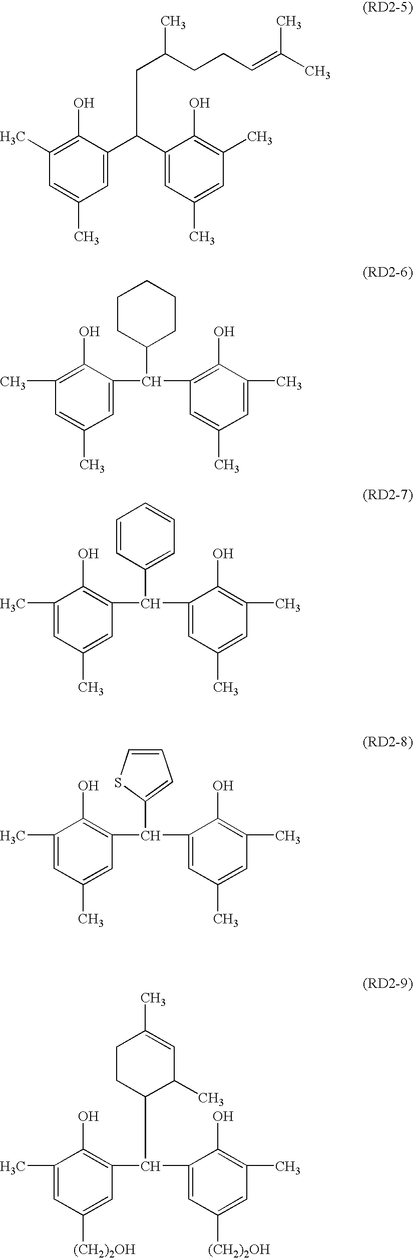

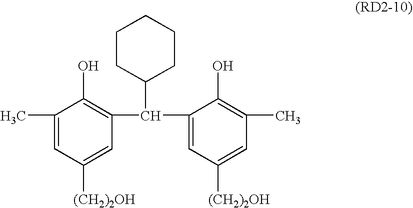

The bisphenol compounds represented by these Formulas (RD1) and (RD2) can easily be synthesized employing conventional methods known in the art.

Employed as reducing agents which are used together with the reducing agents of the present invention are, for example, those described in U.S. Pat. Nos. 3,770,448, 3,773,512, and 3,593,863; RD Nos. 17029 and 29963; and JP-A Nos. 11-119372 and 2002-62616.

The used amount of the reducing agents, represented by aforesaid Formula (RD1) and the like, is preferably 1×10⁻²-10 mol per mol of silver, but is most preferably 1×10⁻²-1.5 mol.

<Tone Controlling Agent>

The tone of images obtained by thermal development of the imaging material is described.

It has been pointed out that in regard to the output image tone for medical diagnosis, cold image tone tends to result in more accurate diagnostic observation of radiographs. The cold image tone, as described herein, refers to pure black tone or blue black tone in which black images are tinted to blue. On the other hand, warm image tone refers to warm black tone in which black images are tinted to brown.

The tone is more described below based on an expression defined by a method recommended by the Commission Internationale de l'Eclairage (CIE) in order to define more quantitatively.

“Colder tone” as well as “warmer tone”, which is terminology of image tone, is expressed, employing minimum density Dₘᵢₙ and hue angle h_{ab} at an optical density D of 1.0. The hue angle h_{ab} is obtained by the following formula, utilizing color specifications a* and b* of L*a*b* Color Space which is a color space perceptively having approximately a uniform rate, recommended by Commission Internationale de l'Eclairage (CIE) in 1976.
h_{ab}=tan⁻¹(b*/a*)

In the present invention, h_{ab} is preferably in the range of 180 degrees<h_{ab}<270 degrees, is more preferably in the range of 200 degrees<h_{ab}<270 degrees, and is most preferably in the range of 220 degrees<h_{ab}<260 degrees.

This finding is also disclosed in JP-A 2002-6463.

Incidentally, as described, for example, in JP-A No. 2000-29164, it is conventionally known that diagnostic images with visually preferred color tone are obtained by adjusting, to the specified values, u* and v* or a* and b* in CIE 1976 (L*u*v*) color space or (L*a*b*) color space near an optical density of 1.0.

Diligent investigation was performed for the silver salt photothermographic imaging material according to the present invention. As a result, it was discovered that when a linear regression line was formed on a graph in which in the CIE 1976 (L*u*v*) color space or the (L*a*b*) color space, u* or a* was used as the abscissa and v* or b* was used as the ordinate, the aforesaid materiel exhibited diagnostic properties which were equal to or better than conventional wet type silver salt photosensitive materials by regulating the resulting linear regression line to the specified range. The condition ranges of the present invention will now be described.

(1) It is preferable that the coefficient of determination value R² of the linear regression line which is made by arranging u* and v* in terms of each of the above optical densities is 0.998-1.000; value v* of the intersection point of the aforesaid linear regression line with the ordinate is −5-+5; and gradient (v*/u*) is 0.7-2.5.

(2) The coefficient of determination value R² of the linear regression line is preferably 0.998-1.000, which is formed in such a manner that each of optical density of 0.5, 1.0, and 1.5 and the minimum optical density of the aforesaid imaging material is measured, and a* and b* in terms of each of the above optical densities are arranged in two-dimensional coordinates in which a* is used as the abscissa of the CIE 1976 (L*a*b*) color space, while b* is used as the ordinate of the same.

In addition, value b* of the intersection point of the aforesaid linear regression line with the ordinate is −5-+5, while gradient (b*/a*) is 0.7-2.5.

A method for making the above-mentioned linear regression line, namely one example of a method for determining u* and v* as well as a* and b* in the CIE 1976 color space, will now be described.

By employing a thermal development apparatus, a 4-step wedge sample including an unexposed portion and optical densities of 0.5, 1.0, and 1.5 is prepared. Each of the wedge density portions prepared as above is determined employing a spectral chronometer (for example, CM-3600d, manufactured by Minolta Co., Ltd.) and either u* and v* or a* and b* are calculated. Measurement conditions are such that an F7 light source is used as a light source, the visual field angle is 10 degrees, and the transmission measurement mode is used. Subsequently, either measured u* and v* or measured a* and b* are plotted on the graph in which u* or a* is used as the abscissa, while v* or b* is used as the ordinate, and a linear regression line is formed, whereby the coefficient of determination value R as well as intersection points and gradients are determined.

The specific method enabling to obtain a linear regression line having the above-described characteristics will be described below.

In the present invention, by regulating the added amount of the aforesaid toning agents, developing agents, silver halide grains, and aliphatic carboxylic acid silver, which are directly or indirectly involved in the development reaction process, it is possible to optimize the shape of developed silver so as to result in the desired tone. For example, when the developed silver is shaped to dendrite, the resulting image tends to be bluish, while when shaped to filament, the resulting imager tends to be yellowish. Namely, it is possible to adjust the image tone taking into account the properties of shape of developed silver.

Usually, toning agents such as phthalazinones or a combinations of phthalazine with phthalic acids, or phthalic anhydride are employed.

Examples of suitable image toning agents are disclosed in Research Disclosure, Item 17029, and U.S. Pat. Nos. 4,123,282, 3,994,732, 3,846,136, and 4,021,249.

In the present invention, rapid processing is carried out employing a downsized laser imager for a short distance in a cooling section. However, compared to normal processing, one drawback which has appeared is one in which silver tone has significantly deviated from the preferred neutral tone. The above drawback has not been overcome by employing the above conventional toners, whereby compounds (including leuco dyes and couplers), which are subjected to imagewise color formation during heat development to form dye images, are demanded. Preferred as such compounds are those which are subjected to color formation during heat development to form dye images exhibiting a maximum absorption wavelength of 360-450 nm, or those which are subjected to color formation during heat development to form dye images exhibiting a maximum absorption wavelength of 600-700 nm. Further, cases in which both compounds are incorporated are particularly preferred since they result in the desired silver tone. Preferably employed as such compounds are couplers, or leuco dyes detailed below, disclosed in JP-A No. 11-288057 and European Patent No. 1,134,611A2.

<Leuco Dyes>

Employed as leuco dyes may be any of the colorless or slightly tinted compounds which are oxidized to form a colored state when heated at temperatures of about 80-about 200° C. for about 0.5-about 30 seconds. It is possible to use any of the leuco dyes which are oxidized by silver ions to form dyes. Compounds are useful which are sensitive to pH and oxidizable to a colored state.

Representative leuco dyes suitable for the use in the present invention are not particularly limited. Examples include biphenol leuco dyes, phenol leuco dyes, indoaniline leuco dyes, acrylated azine leuco dyes, phenoxazine leuco dyes, phenodiazine leuco dyes, and phenothiazine leuco dyes. Further, other useful leuco dyes are those disclosed in U.S. Pat. Nos. 3,445,234, 3,846,136, 3,994,732, 4,021,249, 4,021,250, 4,022,617, 4,123,282, 4,368,247, and 4,461,681, as well as JP-A Nos. 50-36110, 59-206831, 5-204087, 11-231460, 2002-169249, and 2002-236334.

In order to control images to specified color tones, it is preferable that various color leuco dyes are employed individually or in combinations of a plurality of types. In the present invention, for minimizing excessive yellowish color tone due to the use of highly active reducing agents, as well as excessive reddish images especially at a density of at least 2.0 due to the use of minute silver halide grains, it is preferable to employ leuco dyes which change to cyan. Further, in order to achieve precise adjustment of color tone, it is further preferable to simultaneously use yellow leuco dyes as well as other leuco dyes which change to cyan.

It is preferable to appropriately control the density of the resulting color while taking into account the relationship with the color tone of developed silver itself. In the present invention, color formation is performed so that the sum of maximum densities at the maximum adsorption wavelengths of dye images formed by leuco dyes is customarily 0.01-0.30, is preferably 0.02-0.20, and is most preferably 0.02-0.10. Further, it is preferable that images be controlled within the preferred color tone range described below.

<Yellow Forming Leuco Dyes>

It is preferable to use a leuco dye to control a tone in the present invention.

In the present invention, particularly preferably employed as yellow forming leuco dyes are color image forming agents represented by following Formula (YA) which increase absorbance between 360 and 450 nm via oxidation.

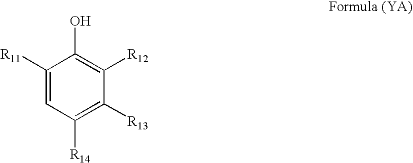

In Formula (YA), R₁₁ represents a substituted or unsubstituted alkyl group, R₁₂ represents a hydrogen atom, a substituted or unsubstituted alkyl group, a substituted or unsubstituted acylamino group. However, R₁₁ and R₁₂ each does not represents a 2-hydroxyphenylmethyl group. R₁₃ represents a hydrogen atom, a substituted or unsubstituted alkyl group; and R₁₄ represents a substituent which can be substituted with a hydrogen atom on a benzene ring.

The compounds represented by Formula (YA) will now be detailed.

In aforesaid Formula (YA), preferably as the alkyl groups represented by R₁₁ are those having 1-30 carbon atoms, which may have a substituent.

Specifically preferred is methyl, ethyl, butyl, octyl, i-propyl, t-butyl, t-octyl, t-pentyl, sec-butyl, cyclohexyl, or 1-methyl-cyclohexyl. Groups (i-propyl, i-nonyl, t-butyl, t-amyl, t-octyl, cyclohexyl, 1-methyl-cyclohexyl or adamantyl) which are three-dimensionally larger than i-propyl are preferred. Of these, preferred are secondary or tertiary alkyl groups and t-butyl, t-octyl, and t-pentyl, which are tertiary alkyl groups, are particularly preferred. Listed as substituents which R₁₁ may have are a halogen atom, an aryl group, an alkoxy group, an amino group, an acyl group, an acylamino group, an alkylthio group, an arylthio group, a sulfonamide group, an acyloxy group, an oxycarbonyl group, a carbamoyl group, a sulfamoyl group, a sulfonyl group, and a phosphoryl group.

R₁₂ represents a hydrogen atom, a substituted or unsubstituted alkyl group, or an acylamino group. The alkyl group represented by R₁₂ is preferably one having 1-30 carbon atoms, while the acylamino group is preferably one having 1-30 carbon atoms. Of these, description for the alkyl group is the same as for aforesaid R₁₁.

The acylamino group represented by R₁₂ may be unsubstituted or have a substituent. Specifically listed are an acetylamino group, an alkoxyacetylamino group, and an aryloxyacetylamino group. R₂ is preferably a hydrogen atom or an unsubstituted group having 1-24 carbon atoms, and specifically listed are methyl, i-propyl, and t-butyl. Further, neither R₁₁ nor R₁₂ is a 2-hydroxyphenylmethyl group.

R₁₃ represents a hydrogen atom, and a substituted or unsubstituted alkyl group. Preferred as alkyl groups are those having 1-30 carbon atoms. Description for the above alkyl groups is the same as for R₁₁. Preferred as R₁₃ are a hydrogen atom and an unsubstituted alkyl group having 1-24 carbon atoms, and specifically listed are methyl, i-propyl and t-butyl. It is preferable that either R₁₂ or R₁₃ represents a hydrogen atom.

R₁₄ represents a group capable of being substituted to a benzene ring, and represents the same group which is described for substituent R₁₄, for example, in aforesaid Formula (RD1). R₁₄ is preferably a substituted or unsubstituted alkyl group having 1-30 carbon atoms, as well as an oxycarbonyl group having 2-30 carbon atoms. The alkyl group having 1-24 carbon atoms is more preferred. Listed as substituents of the alkyl group are an aryl group, an amino group, an alkoxy group, an oxycarbonyl group, an acylamino group, an acyloxy group, an imide group, and a ureido group. Of these, more preferred are an aryl group, an amino group, an oxycarbonyl group, and an alkoxy group. The substituent of these alkyl group may be substituted with any of the above alkyl groups.

Among the compounds represented by Formula (YA), preferred compounds are bis-phenol compounds represented by the following Formula (YB).

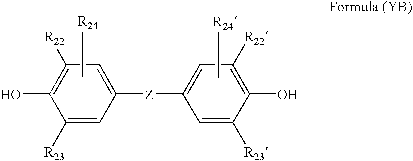

wherein, Z represents a —S— or —C(R₂₁) (R_{21′})— group. R₂₁ and R_{21′} each represent a hydrogen atom or a substituent. The substituents represented by R₁ and R_{1′} are the same substituents listed for R₁ in the aforementioned Formula (RD1). R₂₁ and R_{21′} are preferably a hydrogen atom or an alkyl group.

R₂₂, R₂₃, R_{22′} and R_{23′} each represent a substituent. The substituents represented by R₂₂, R23, R_{22′} and R_{23′} are the same substituents listed for R₂ and R₃ in the aforementioned Formula (RD1).

R₂₂, R₂₃, R_{22′} and R_{23′} are preferably, an alkyl group, an alkenyl group, an alkynyl group, an aryl group, a heterocyclic group, and more preferably, an alkyl group. Substituents on the alkyl group are the same substituents listed for the substituents in the aforementioned Formula (RD1).

R₂₂, R₂₃, R_{22′} and R_{23′} are more preferably tertiary alkyl groups such as t-butyl, t-amino, t-octyl and 1-methyl-cyclohexyl.

R₂₄ and R_{24′} each represent a hydrogen atom or a substituent, and the substituents are the same substituents listed for R₄ in the aforementioned Formula (RD1).

Examples of the compounds represented by Formulas (YA) and (YB) are, the compounds disclosed in JP-A No. 2002-169249, paragraph Nos. [0032]-[0038], Compounds (II-1) to (II-40); and EP 1211093, paragraph No. [0026], Compounds (ITS-1) to (ITS-12).

In the following, specific examples of bisphenol compounds represented by Formula (YA) and (YB) are shown. However, the present invention is not limited thereby.

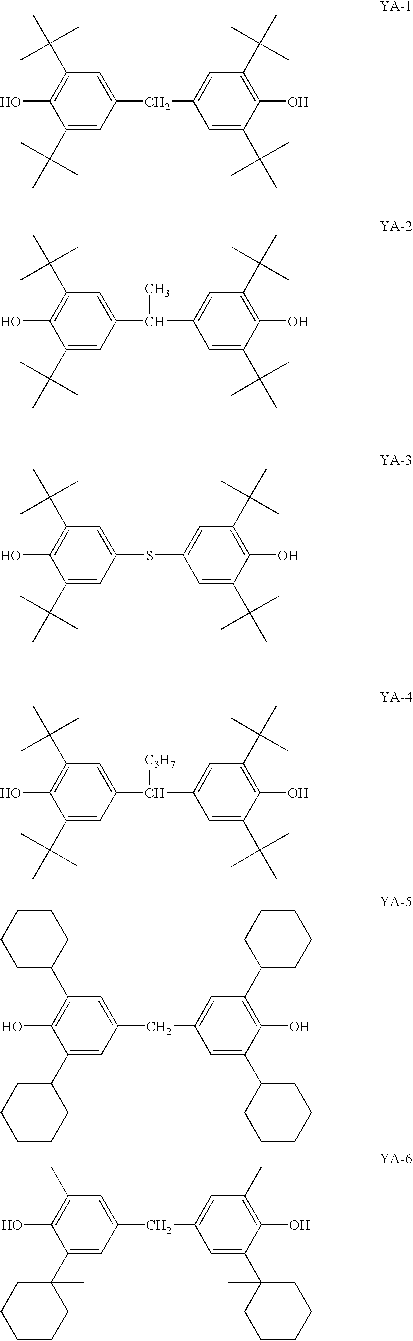

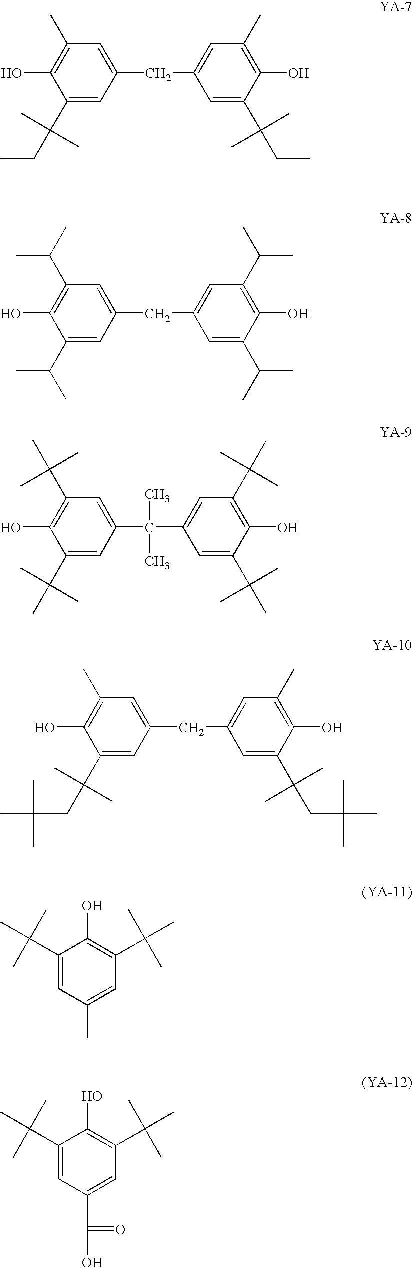

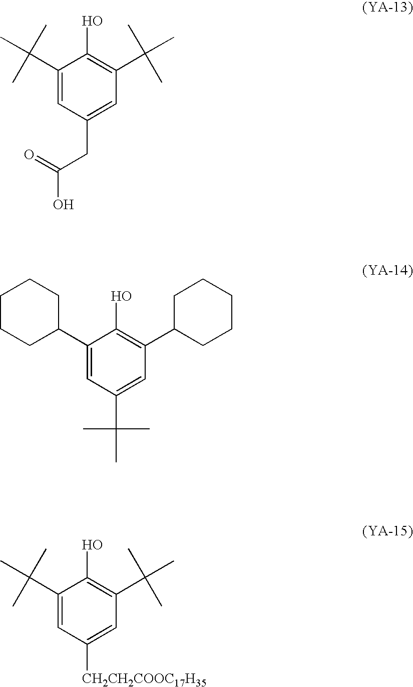

An amount of an incorporated compound represented by Formulas (YA) or (YB) is; usually, 0.00001 to 0.01 mol, and preferably, 0.0005 to 0.01 mol, and more preferably, 0.001 to 0.008 mol per mol of Ag.

A ratio of an added amount of a yellow leuco dye to a reducing agent represented by Formulas (RD1) or (RD2) is preferably from 0.001-0.2, more preferably from 0.005-0.1.

In the present invention, color formation is performed so that the sum of maximum densities at the maximum adsorption wavelengths of dye images formed by yellow leuco dyes is customarily 0.01-0.30, is preferably 0.02-0.20, and is most preferably 0.02-0.10.

In the present invention, it is preferable to use a cyan leuco dye in combination with a yellow leuco dye so as to adjust the reproduction tone.

Employed as cyan leuco dyes may be any of the colorless or slightly tinted compounds which are oxidized to form a colored state when heated at temperatures of about 80-about 200° C. for about 0.5-about 30 seconds. It is possible to use any of the leuco dyes which are oxidized by silver ions to form dyes. Compounds are useful which are sensitive to pH and oxidizable to a colored state.

<Cyan Forming Leuco Dyes>

Cyan forming leuco dyes will now be described. In the present invention, particularly preferably employed as cyan forming leuco dyes are color image forming agents which increase absorbance between 600 and 700 nm via oxidation, and include the compounds described in JP-A No. 59-206831 (particularly, compounds of λmax in the range of 600-700 nm), compounds represented by Formulas (I)-(IV) of JP-A No. 5-204087 (specifically, compounds (1)-(18) described in paragraphs ┌0032┘-┌0037┘), and compounds represented by Formulas 4-7 (specifically, compound Nos. 1-79 described in paragraph ┌0105┘) of JP-A No. 11-231460.

Cyan forming leuco dyes which are particularly preferably employed in the present invention are represented by following Formula (CL).

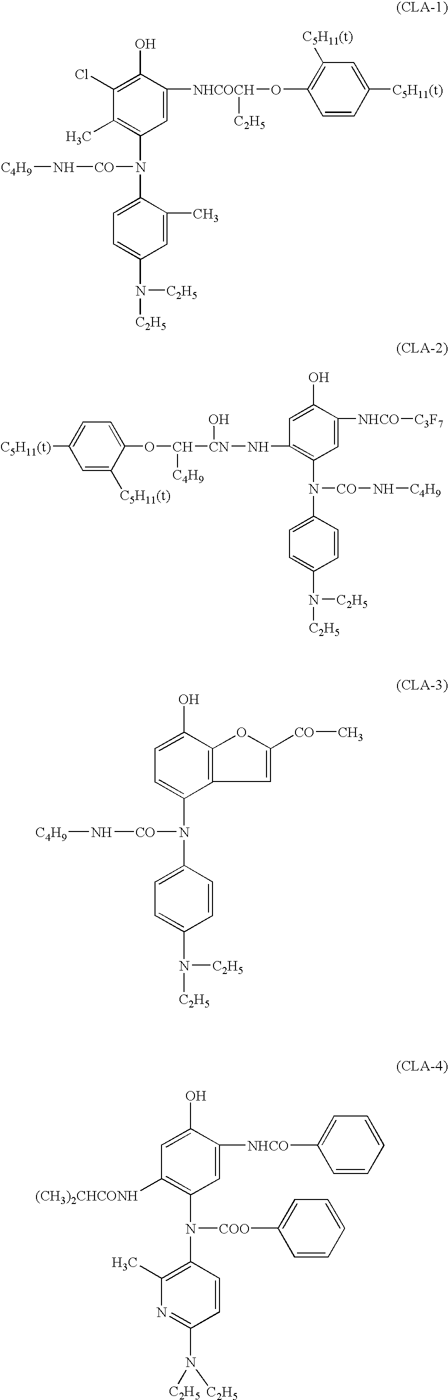

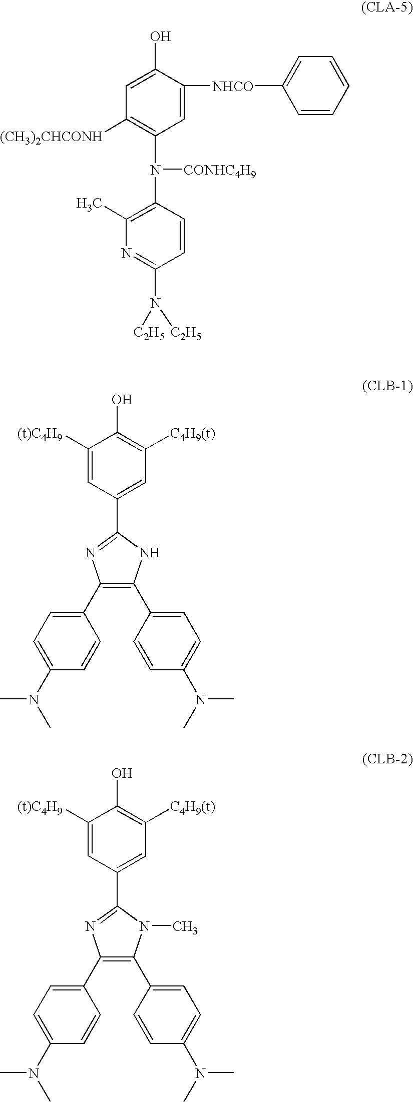

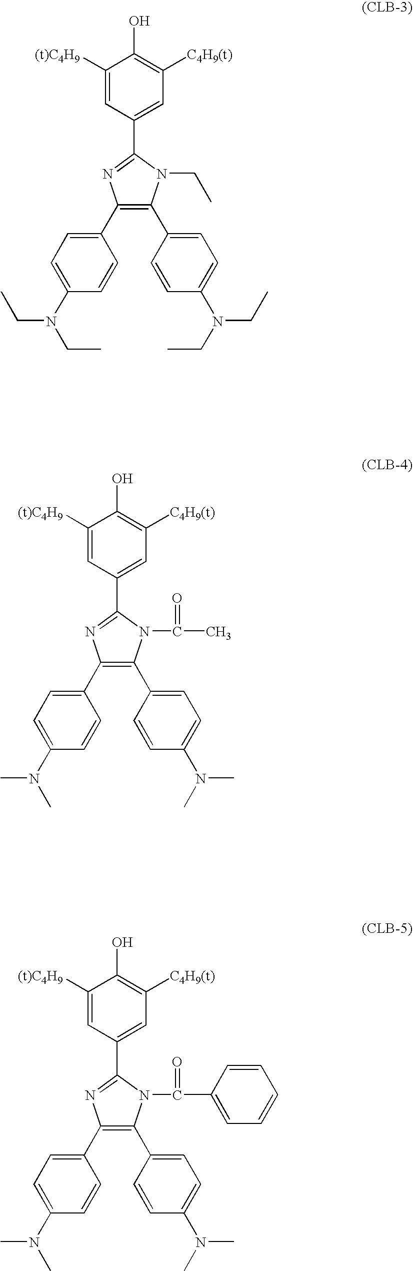

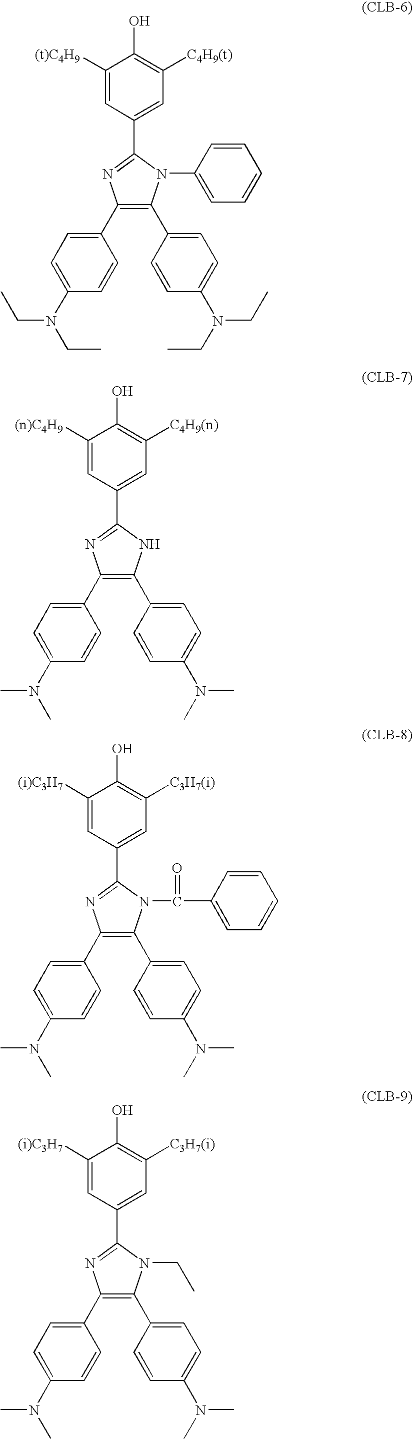

The added amount of cyan forming leuco dyes is commonly 0.00001-0.05 mol/mol of Ag, is preferably 0.0005-0.02 mol, but is more preferably 0.001-0.01 mol. The addition ratio of cyan forming leuco dyes to the total of the reducing agents represented by Formulas (RD1) and (RD2) is preferably 0.001-0.2 in terms of mol ratio, but is more preferably 0.005-0.1.

In the present invention, the sum of maximum density in the maximum absorption wavelength of dye images formed by cyan leuco dyes is controlled to be preferably 0.01-0.50, more preferably 0.02-0.30, but most preferably 0.03-0.10.

In the present invention, it is possible to further control delicate tone by combining magenta forming leuco dyes or yellow forming leuco dyes with the above cyan forming leuco dyes.

The compounds represented by Formulas (YA), (YB) and cyan forming leuco dyes may be added employing the same method as for the reducing agents represented by Formula (RD1). They may be incorporated in liquid coating compositions employing an optional method to result in a solution form, an emulsified dispersion form, or a minute solid particle dispersion form, and then incorporated in a photosensitive material.

It is preferable to incorporate the compounds represented by Formulas (RD1), (RD2), (YA), (YB) and cyan forming leuco dyes into an image forming layer containing organic silver salts. On the other hand, the former may be incorporated in the image forming layer, while the latter may be incorporated in a non-image forming layer adjacent to the aforesaid image forming layer. Alternatively, both may be incorporated in the non-image forming layer. Further, when the image forming layer is comprised of a plurality of layers, incorporation may be performed for each of the layers.

<Binder>

The silver salt photothermographic material of the present invention may contain a binder in a photosensitive or a non photosensitive layer for various purposes.

The binders incorporated in the photosensitive layer are those capable of holding an organic silver salt, silver halide grains, a reducing agent and other additives.

Suitable binders for the silver salt photothermographic material of the present invention are to be transparent or translucent and commonly colorless, and include natural polymers, synthetic resin polymers and copolymers, as well as media to form film. Examples of the binders are cited in JP-A No. 2001-330918.

Preferable binders for the photosensitive layer of the silver salt photothermographic dry imaging material of the present invention are poly(vinyl acetals), and a particularly preferable binder is poly(vinyl butyral), which will be detailed hereunder.

Polymers such as cellulose esters, especially polymers such as triacetyl cellulose, cellulose acetate butyrate, which exhibit higher softening temperature, are preferable for an overcoating layer as well as an undercoating layer, specifically for a light-insensitive layer such as a protective layer and a backing layer. Incidentally, if desired, the binders may be employed in combination of at least two types.

It is preferable that the binders of the present invention include at least one polar group selected from the group consisting of —COOM, —SO₃M, —OSO₃M, —P═O(OM)₂, —O—P═O(OM)₂ (wherein M represents a hydrogen atom or an alkali metal salt group), —N(R₄)₂, —N⁺(R)₃ (wherein R represents a hydrocarbon group, —SH, and —CN. Specifically preferred are —SO₃M and —OSO₃M. The amount of such polar groups is commonly from 10⁻¹ to 10⁻⁸ mol/g, and is preferably from 10⁻² to 10⁻⁶ mol/g.

Such binders are employed in the range of a proportion in which the binders function effectively.

Skilled persons in the art can easily determine the effective range. For example, preferred as the index for maintaining aliphatic carboxylic acid silver salts in a photosensitive layer is the proportion range of binders to aliphatic carboxylic acid silver salts of 15:1 to 1:2 and most preferably of 8:1 to 1:1. Namely, the binder amount in the photosensitive layer is preferably from 1.5 to 6 g/m², and is more preferably from 1.7 to 5 g/m². When the binder amount is less than 1.5 g/m², density of the unexposed portion markedly increases, whereby it occasionally becomes impossible to use the resultant material.

In the present invention, it is preferable that thermal transition point temperature is from 70 to 105° C. Thermal transition point temperature Tg, as described in the present invention, can be obtained with a differential scanning calorimeter. Tg is a intersection point of a base line and a tangent of a endothermic peak.

The glass transition temperature (Tg) is determined employing the method, described in Brandlap, et al., “Polymer Handbook”, pages from III-139 through III-179, 1966 (published by Wiley and Son Co.).

The Tg of the binder comprised of copolymer resins is obtained based on the following formula.

Tg of the copolymer (in ° C.)=v₁Tg₁+v₂Tg₂+ . . . +vₙTgₙ wherein v₁, v₂, . . . vₙ each represents the mass ratio of the monomer in the copolymer, and Tg₁, Tg₂, . . . , Tgₙ each represents Tg (in ° C.) of the homopolymer which is prepared employing each monomer in the copolymer. The accuracy of Tg, calculated based on the formula calculation, is ±5° C.

A sufficient amount of image density can be obtained after image formation when a binder having Tg of 70-105° C. is employed.

The polymers have a Tg of 70 to 105° C., a number average molecular weight of 1,000 to 1,000,000, preferably from 10,000 to 500,000, and a degree of polymerization of about 50 to about 1,000. Examples of such polymers include polymers or copolymers containing constituent units of ethylenic unsaturated monomers are listed in JP-A No. 2001-330918, paragraph No. [0069].

Of these, listed as preferable examples are alkyl methacrylates, aryl methacrylates, and styrenes. Of such polymers, those having an acetal group are preferably employed. Among polymers having an acetal group, specifically preferred are polyvinylacetals having a acetal structure in the molecule. Examples of such polymers are listed in U.S. Pat. Nos. 2,358,836, 3,003,879 and 2828204, GB Patent No. 771155.

Examples of specifically preferred polymers having an acetal group are listed in JP-A No. 2002-287299, paragraph No. [150], represented Formula (V).

Employed as polyurethane resins usable in the present invention may be those, known in the art, having a structure of polyester polyurethane, polyether polyurethane, polyether polyester polyurethane, polycarbonate polyurethane, polyester polycarbonate polyurethane, or polycaprolactone polyurethane. It is preferable that the molecular terminal of the polyurethane molecule has at least one OH group and at least two OH groups in total. The OH group cross-links with polyisocyanate as a hardening agent so as to form a 3-dimensional net structure. Therefore, the more OH groups which are incorporated in the molecule, the more preferred. It is particularly preferable that the OH group is positioned at the terminal of the molecule since thereby the reactivity with the hardening agent is enhanced. The polyurethane preferably has at least three OH groups at the terminal of the molecules, and more preferably has at least four OH groups. When polyurethane is employed, the polyurethane preferably has a glass transition temperature of 70 to 105° C., a breakage elongation of 100 to 2,000 percent, and a breakage stress of 0.5 to 100 M/mm².

These polymer compounds (or polymers) may be employed individually or in combinations via blending of at least two types.

It is preferable that the aforesaid polymers are used as a binder in the image forming layer of the present invention. As used herein, the term “main binder” refers to one which results in a state in which the aforesaid binder occupies at least 50 percent by weight of the total binders of the image forming layer. Accordingly, other polymers may be blended within the range of less than 50 percent by weight of the total binders. These polymers are not particularly limited as long as they are soluble in the solvents of the present invention. More preferred polymers include polyvinyl acetate, polyacryl resins, and urethane resins.

Organic gelling agents may be incorporated into the image forming layer. Organic gelling agents, as descried herein, refer to compounds which, for example, as polyhydric alcohols, their addition to organic liquid results in a yield value in the system and exhibits functions to eliminate or decrease fluidity.

An embodiment is also preferred in which an image forming layer liquid coating composition incorporates polymer latexes in the form of a water based dispersion. In this case, it is preferable that at least 50 percent by weight of the total binder in the image forming layer liquid coating composition is composed of polymer latexes in the form of water based dispersion. Further, when the image forming layer incorporates polymer latexes, it is preferable that at least 50 percent of the total binders in the image forming layer is composed of polymer latexes, but it is still more preferable that at least 70 percent by weight of the same is composed of polymer latexes.

Polymer latexes, as described herein, refer to those which are prepared in such a manner that water-insoluble hydrophobic polymers are dispersed into a water based dispersion media in the form of minute particles. Dispersion states include any of the states in which polymers are emulsified in a dispersion medium, are prepared by emulsification polymerization, or are subjected to micelle dispersion, or further molecular chains themselves are subjected to molecular dispersion while having a partial hydrophilic structure in the polymer molecule. The average diameter of dispersion particles is preferably in the range of 1-50,000 nm, but is more preferably in the range of 5-1,000 nm. The size distribution of dispersion particles is not particularly limited and those having a broad particle size distribution or a monodispersion size distribution may are acceptable.

Polymer latexes employed in the present invention may be so-called core/shell type latexes, other than common polymer latexes having a uniform structure. In this case, a core and a shell are occasionally preferable when Tg is varied. The minimum filming temperature (MFT) of the polymer latexes according to the present invention is preferably from −30 to 90° C., but is more preferably from about 0 to about 70° C. Further, in order to control the minimum filming temperatures, film forming aids may be incorporated.

The above film forming aids are called plasticizers and are organic compounds (commonly organic solvents) which lower the minimum filming temperature of polymer latexes. They are described, for example, in “Gosei Latex no Kagaku (Chemistry of Synthesis Latexes)” (written by Soichi Muroi, published by Kobunshi Kankokai, 1770).

Polymer species employed for polymer latexes include acryl resins, vinyl acetate resins, polyester resins, polyurethane resins, rubber based resins, vinyl chloride resins, vinylidene chloride resins, and polyolefin resins, or copolymers thereof. Polymers may include straight chain polymers, branched chain polymers, and crosslinked polymers. Further, polymers include homopolymers which are prepared by copolymerizing identical monomers, as well as copolymers which are prepared by polymerizing at least two types of monomers. In the case of copolymers, either random polymers or block polymers are acceptable. The molecules weight of polymers is commonly 5,000-1,000,000 in terms of number average molecular weight, but is preferably about 10,000-about 100,000. Polymers having an excessively small molecular weight result in insufficient dynamic strength of the light-sensitive layers, while those having an excessively large molecular weather results in degraded film forming properties, whereby both cases are not preferable.

The equilibrium water content ratio of polymer latexes at 25° C. and 60 percent RH (relative humidity) is preferably 0.01-2 percent by weight, but is more preferably 0.01-1 percent by weight. With regard to the measurement methods of the equilibrium water content ratio as well as its definition, it is possible to refer, for example, to “Kobunshi Kogaku Koza 14, Kobunshi Zairyo Siken Ho (Polymer Engineering Lecture 14, Test Methods of Polymer Materials)” (edited by Kobunshi Gakkai, Chizin Shokan)”.

Specific examples of polymer latexes include each of the latexes described in paragraph ^{┌}0173_{┘} of JP-A No. 2002-287299. These polymers may be employed individually or, if desired, in combinations via blending at least two types. Preferred as polymer species of polymer latexes are those which incorporate carboxylic acid components such as acrylate or methacrylate in an amount of about 0.1-about 10 percent by weight.

Further, if desired, incorporated may be hydrophilic polymers such as gelatin, polyvinyl alcohol, methylcellulose, hydroxypropyl cellulose, carboxymethyl cellulose, or hydroxypropyl methylcellulose in the range of at most 50 percent by weight of the total binders. The added amount of these hydrophilic polymers is preferably at most 30 percent by weight of the total binders of the aforesaid light-sensitive layer.

During preparation of an image forming layer liquid coating composition, with regard to the addition order, any of the organic silver salts and polymer latexes in the form of water based dispersion may be added initially, or both may be simultaneously added. However, it is preferable that the polymer latexes are added later.

Further, it is preferable that prior to the addition of polymer latexes, organic silver salts and in addition, reducing agents are mixed. Still further, after blending the organic silver salts with the polymer latexes, when the temperature during storage is excessively low, problems occur in which the resulting coating surface is degraded, while when it is excessively high, problems occur in which fogging is increased. Consequently, it is preferable that the coating liquid composition after blending is maintained between 30-65° C. during the above standing period. Still further, it is preferable to maintain it between 35-60° C. and it is most preferable to maintain it between 35-55° C. To make it possible to maintain the temperatures as above, the tanks used to prepare the liquid coating composition may be heated.

With regard to coating of image forming liquid coating compositions, it is preferable to use the liquid coating composition 0.5-24 hours after blending organic silver salts with polymer latexes in the form of water based dispersion, while it is more preferable to use the same 1-12 hours after blending, but it is most preferable to use the same 2-10 hours after blending.

As used herein, the term “after blending” means that after organic silver salts and polymer latexes in the form of water based dispersion are added, added components are uniformly dispersed.

<Cross-Linking Agent>

The photosensitive layer of the present invention may contain a cross-linking agent. It is known that by employing cross-linking agents in the aforesaid binders, the resulting layer adhesion is assured, and uneven development is minimized. In addition, effects are also exhibited in which fogging during storage is retarded and the formation of print-out silver after development is also retarded.

Employed as cross-linking agents are various cross-linking agents used for light-sensitive photographic materials, examples of which include aldehyde based, epoxy based, ethyleneimine based, vinylsulfone based, sulfonic acid ester based, acryloyl based, carbodiimide based, and silane compound based cross-linking agents described in JP-A No. 50-96216. Of these, preferred are the isocyanate based, silane compound based, epoxy based compounds or acid anhydrides.

The aforesaid isocyanate based cross-linking agents are isocyanates having at least two isocyanate groups and adducts thereof. More specifically, listed are aliphatic isocyanates, aliphatic isocyanates having a ring group, benzene diisocyanates, naphthalene diisocyanates, biphenyl isocyanates, diphenylmethane diisocyanates, triphenylmethane diisocyanates, triisocyanates, tetraisocyanates, and adducts of these isocyanates and adducts of these isocyanates with dihydric or trihydric polyalcohols.

Employed as specific examples may be isocyanate compounds described on pages 10 through 12 of JP-A No. 56-5535.

Incidentally, adducts of isocyanates with polyalcohols are capable of markedly improving the adhesion between layers and further of markedly minimizing layer peeling, image dislocation, and air bubble formation. Such isocyanates may be incorporated in any portion of the silver salt photothermographic dry imaging material. They may be incorporated in, for example, a support (particularly, when the support is paper, they may be incorporated in a sizing composition), and optional layers such as a photosensitive layer, a surface protective layer, an interlayer, an antihalation layer, and a subbing layer, all of which are placed on the photosensitive layer side of the support, and may be incorporated in at least two of the layers.

Further, as thioisocyanate based cross-linking agents usable in the present invention, compounds having a thioisocyanate structure corresponding to the isocyanates are also useful.

The amount of the cross-linking agents employed in the present invention is in the range of 0.001 to 2.000 mol per mol of silver, and is preferably in the range of 0.005 to 0.500 mol.

Isocyanate compounds as well as thioisocyanate compounds, which may be incorporated in the present invention, are preferably those which function as the cross-linking agent. However, it is possible to obtain the desired results by employing compounds which have a v of 0, namely compounds having only one functional group.

Listed as examples of silane compounds which can be employed as a cross-linking agent in the present invention are compounds represented by General Formulas (1) to (3), described in JP-A No. 2001-264930.

Compounds, which can be used as a cross-linking agent, may be those having at least one epoxy group. The number of epoxy groups and corresponding molecular weight are not limited. It is preferable that the epoxy group be incorporated in the molecule as a glycidyl group via an ether bond or an imino bond. Further, the epoxy compound may be a monomer, an oligomer, or a polymer. The number of epoxy groups in the molecule is commonly from about 1 to about 10, and is preferably from 2 to 4. When the epoxy compound is a polymer, it may be either a homopolymer or a copolymer, and its number average molecular weight Mn is most preferably in the range of about 2,000 to about 20,000.

Acid anhydrides are compounds which have at least one acid anhydride group having the structural formula described below.

The acid anhydrites are to have at least one such acid anhydride group. The number of acid anhydride groups, and the molecular weight are not limited.
—CO—O—CO—

These acid anhydrides may be employed individually or in combinations of at least two types. The added amount is not particularly limited, but is preferably in the range of 1×10⁻⁶ to 1×10⁻² mol/m² and is more preferably in the range of 1×10⁻⁵ to 1×10⁻³ mol/m².

<Silver Saving Agent>

In the present invention, either a photosensitive layer or a light-insensitive layer may comprise silver saving agents. A silver saving agent indicates a compound which can reduce an amount of silver required to produce a predetermined silver image density.

The mechanisms of reducing an amount of silver can be variously considered. The preferable compound is a compound which is provided with an ability to improve the covering power of developed silver. The silver saving agent may be present in a photosensitive layer or in a light-insensitive layer, or in both layers.

Examples of silver saving agents are, hydrazine derivatives, vinyl compounds, phenol compounds, naphthol compounds, quaternary onium compounds and silane compounds.

Specific examples of hydrazine derivatives include compounds H-1-H-29 described in columns 11-20 of U.S. Pat. No. 5,545,505, as well as compounds 1-12 described in columns of U.S. Pat. No. 5,464,738; and compounds H-1-1-H-1-28, H-2-1-H-2-9, H-3-1-H-3-12, H-4-1-H-4-21, and H-5-1-H-5-5 described in paragraphs ^{┌}0042_{┘}-^{┌}0052_{┘} of JP-A No. 2001-27790.

Specific examples of vinyl compounds include compounds CN-01-CN-13 described in columns 13-14 of U.S. Pat. No. 5,545,515, compounds HET-01-HET-02 described in column 10 of U.S. Pat. No. 5,635,339, compounds MA-01-MA-07 described in columns 9-10 of U.S. Pat. No. 5,654,130, compounds IS-01-IS-04 described in columns 9-10 of U.S. Pat. No. 5,705,324, and compounds 1-1-218-2 described in paragraphs ^{┌}0043_{┘}-^{┌}0088_{┘} of JP-A No. 2001-125224.

Specific examples of phenol derivatives and naphthol derivatives include compounds A-1-A-89 described in paragraphs ^{┌}0075_{┘}-^{┌}0078_{┘} of JP-A No. 2003-267222, as well as compounds A-1-A-258 described in paragraphs ^{┌}0025_{┘}-^{┌}0045_{┘} of JP-A No. 2003-66558.

Specific example of quaternary onium compounds includes triphenyltetrazolium.

In the present invention, it is preferable that at least one of silver saving agents is a silane compound.

The silane compounds employed as a silver saving agent in present invention are preferably alkoxysilane compounds having at least two primary or secondary amino groups or salts thereof, as described in JP-A No. 2003-5324, paragraph No. [0027]-[0029], compounds A1-A33.

The added amount of a silver saving agent is preferably in the range of 1×10⁻⁵ to 1 mol per 1 mole of an organic silver salt, and more preferably in the range of 1×10⁻⁴ to 5×10⁻¹ mol.

Particularly preferred silver conservation agents of the present invention are the compounds represented by following Formulas (SE1) and (SE2).
Q₁-NHNH-Q₂ Formula (SE1)

Q₁ represents an aromatic group combined with —NHNH-Q₂ with a carbon atom, or a heterocycle group. Q₂ represents a carbamoyl group, an acyl group, an alkoxy carbonyl group, an aryloxycarbonyl group, a sulfonyl group, or a sulfamoyl group.

In Formula (SE1), an aromatic group or a heterocyclic group represented by Q₁ is preferably an unsaturated ring of 5-7 member. Cited as preferable examples are as follows: a benzene ring, a pyridine ring, a pyrazine ring, a pyrimidine ring, a pyridazine ring, a 1,2,4-triazine ring, a 1,3,5-triazine ring, a pyrrole ring, an imidazole ring, a pyrazole ring, a 1,2,3-triazole ring, a 1,2,4-triazole ring, a tetrazole ring, a 1,3,4-thiadiazole ring, a 1,2,4-thiadiazole ring, a 1,2,5-thiadiazole ring, a 1,3,4-oxydiazole ring, a 1,2,4-oxydiazole ring, a 1,2,5-oxydiazole ring, a thiazole ring, an oxazole ring, an isothiazole ring, an isoxazole ring, a thiophene ring. The rings mutually condensed with the above-described rings are also preferable.

These rings may have a substituent, and when it has two or more substituents, those substituents may be the same or different. Cited example as a substituent are as follows: a halogen atom, an alkyl group, an aryl group, a carbonamide group, an alkylsulfonamide group, an arylsulfonamide group, an alkoxy group, an aryloxy group, an alkylthio group, the arylthio group, a carbamoyl group, a sulfamoyl group, a cyano group, an alkylsulfonyl group, an arylsulfonyl group, an alkoxycarbonyl group, an aryloxycarbonyl group, and an acyl group.

These groups may have further a substituent when it is possible. Cited examples of such substituent are as follows: a halogen atom, an alkyl group, an aryl group, a carbonamide group, an alkylsulfonamide group, an arylsulfonamide group, an alkoxy group, an aryloxy group, an alkylthio group, an aryl thio group, an acyl group, an alkoxycarbonyl group, an aryloxycarbonyl group, a carbamoyl group, a cyano group, a sulfamoyl group, an alkylsulfonyl group, an arylsulfonyl group, and an acyloxy group.

A carbamoyl group represented by Q₂ has preferably 1 to 50 carbon atoms, more preferably it is a carbamoyl group of 6 to 40 carbon atoms. Cited examples are as follows: nonsubstituted carbamoyl, methylcarbamoyl, N-ethylcarbamoyl, N-propylcarbamoyl, N-sec-butylcarbamoyl, N-octylcarbamoyl, N-cyclohexylcarbamoyl, N-tert-butylcarbamoyl, N-dodecylcarbamoyl, N-(3-dodecyloxypropyl)carbamoyl, N-octadecylcarbamoyl, N-{3-(2,4-tert-pentylphenoxy)propyl}carbamoyl, N-(2-hexyldecyl)carbamoyl, N-phenylcarbamoyl, N-(4-dodecyloxyphenyl)carbamoyl, N-(2-chloro-5-dodecyloxycarbonyl phenyl)carbamoyl, N-naphthylcarbamoyl, N-3-pyridylcarbamoyl, and N-benzyl carbamoyl.

An acyl group represented by Q₂ has preferably 1 to 50 carbon atoms, and more preferably it is an acyl group of 6 to 40 carbon atoms. Cited examples are as follows: formyl, acetyl, 2-methylpropanoyl, cyclohexylcarbonyl, octanoyl, 2-hexyldecanoyl, dodecanoil, chloroacetyl, trifluoroacetyl, benzoyl, 4-dodecyloxybenzoyl, and 2-hydroxymethyl benzoyl.

An alkoxycarbonyl group represented by Q₂ has preferably 2 to 50 carbon atoms, and more preferably it is an alkoxycarbonyl group of 6 to 40 carbon atoms. Cited examples are as follows: methoxycarbonyl, ethoxycarbonyl, isobutyloxycarbonyl, cyclohexyloxycarbonyl, dodecyloxycarbonyl, and benzyloxycarbonyl.

An aryloxycarbonyl group represented by Q₂ has preferably 7 to 50 carbon atoms, and more preferably it is an aryloxycarbonyl group of 7 to 40 carbon atoms. Cited examples are as follows: phenoxy carbonyl, 4-octyloxyphenoxycarbonyl, 2-hydroxymethylphenoxycarbonyl, and 4-dodecyloxyphenoxy carbonyl.

A sulfonyl group represented by Q₂ has preferably 1 to 50 carbon atoms, and more preferably it is a sulfonyl group of 6 to 40 carbon atoms. Cited examples are as follows: a methylsulfonyl, a butylsulfonyl, an octylsulfonyl, 2-hexadecylsulfonyl, 3-dodecyloxypropylsulfonyl, a 2-octyloxy-5-tert-octylphenylsulfonyl, and 4-dodecyloxyphenylsulfonyl.

A sulfamoyl group represented by Q₂ has preferably 0 to 50 carbon atoms, and more preferably it is a sulfamoyl group of 6 to 40 carbon atoms. Cited examples are as follows: a nonsubstituted sulfamoyl, N-ethylsulfamoyl, N-(2-ethylhexyl)sulfamoyl, N-decylsulfamoyl, N-hexadecylsulfamoyl, N-{3-(2-ethylhexyloxy)propyl}sulfamoyl, N-(2-chloro-5-dodecyloxycarbonylphenyl)sulfamoyl and N-(2-tetradecyloxyphenyl)sulfamoyl.

The group represented by Q₂ may have the group cited as examples of the substituents of the unsaturated ring of 5-7 member for Q₁. When it has two or more substituents, they may be the same or different.

Next, the preferable extent of the compounds represented by Formula (SE1) is described.

As Q₁, an unsaturated ring of 5-6 member is preferable. Cited examples are as follows: a benzene ring, a pyrimidine ring, a 1,2,3-triazole ring, a 1,2,4-triazole ring, a tetrazole ring, a 1,3,4-thiadiazole ring, a 1,2,4-thiadiazole ring, a 1,3,4-oxydiazole ring, a 1,2,4-oxydiazole ring, a thiazole ring, an oxazole ring, an isothiazole ring, an isoxazole ring. And the rings formed from the above-described rings condensed with benzene ring or unsaturated heterocyclic ring are still more preferable.

Moreover, Q₂ is preferably a carbamoyl group, a carbamoyl group which has a hydrogen atom on a nitrogen atom is more preferable.

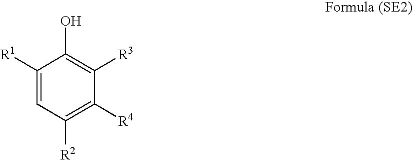

In Formula (SE2), R₁ represents an alkyl group, an acyl group, an acylamino group, a sulfonamide group, an alkoxy carbonyl group, or a carbamoyl group.

R₂ represents a hydrogen atom, a halogen atom, an alkyl group, an alkoxy group, the aryloxy group, an alkylthio group, an arylthio group, an acyloxy group, or a carbonate group.

R₃ and R₄ each respectively represents the group which can be substituted on a benzene ring cited in the examples of a substituent of Formula (SE1). R₃ and R₄ may be connected mutually to form a condensed ring.

R₁ is preferably an alkyl group of 1 to 20 carbon atoms (for example, a methyl group and an ethyl group, an isopropyl group, a butyl group, a tert-octyl group, a cyclohexyl group), an acylamino group (for example, an acetylamino group, a benzoylamino group, and a methylureido group, and a 4-cyanophenyl ureido group), a carbamoyl groups (an n-butylcarbamoyl group, an N,N-diethyl carbamoyl group, a phenyl carbamoyl group, a 2-chlorophenylcarbamoyl group, and a 2, a 4-dichlorophenylcarbamoyl group). An acylamino group (an ureido group and a urethane group are included) is more preferable.

R₂ preferably a halogen atom (preferably a chlorine atom, and a bromine atom), an alkoxy group (for example, a methoxy group, a butoxy group, a n-hexyloxy group, a n-decyloxy group, a cyclohexyloxy group, and a benzyloxy group), an aryloxy group (a phenoxy group and a naphthoxy group).

R₃ is preferably a hydrogen atom, a halogen atom, and an alkyl group of 1 to 20 carbon atoms. Among them, a halogen atom is the more preferable.

R₄ is preferably a hydrogen atom, an alkyl group, and an acylamino group. An alkyl group and an acylamino group are more preferable.

Cited examples of these preferable substituents are the same as those for R₁.

When R₄ is an acylamino group, it is preferable that R₄ is combined with R₃ to form a carbostyryl ring.

When R₃ and R₄ are combined mutually to form a condensed ring in Formula (SE2), especially preferable condensed ring is a naphthalene ring.

The naphthalene ring may have the same substituent given as examples for Formula (SE1). When Formula (SE2) is a compound of a naphthol system, it is preferable that R₁ is a carbamoyl group. It is more preferable that R₁ is a benzoyl group.

As for R₂, it is preferable that it is an alkoxy group or an aryloxy group, and it is more preferable that R₂ is an alkoxy group.

Hereafter, preferable examples of a silver-saving agent of the present invention are given. However, the present invention is not limited to these. 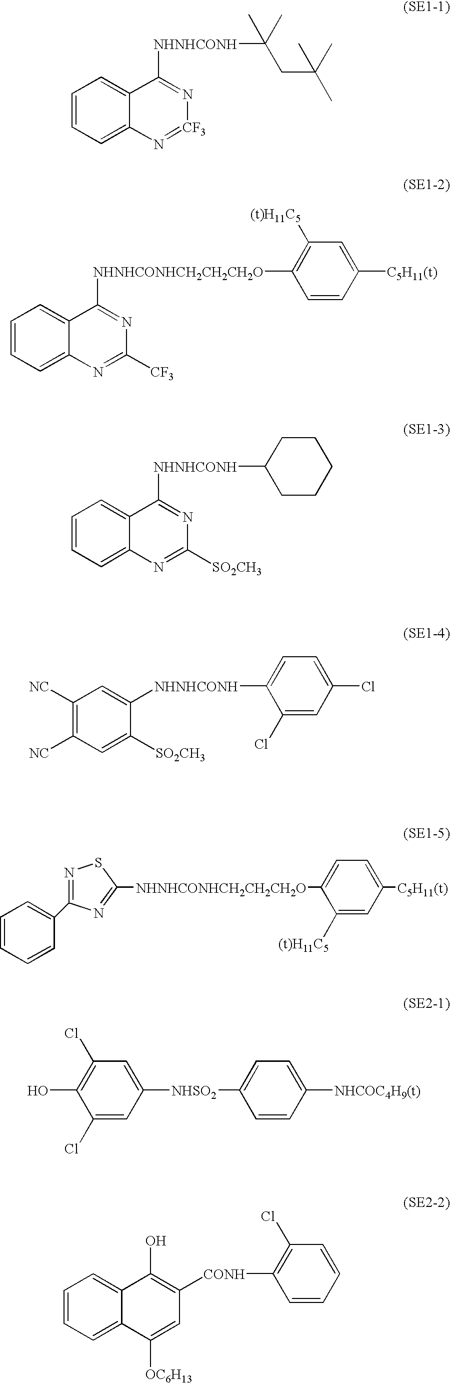 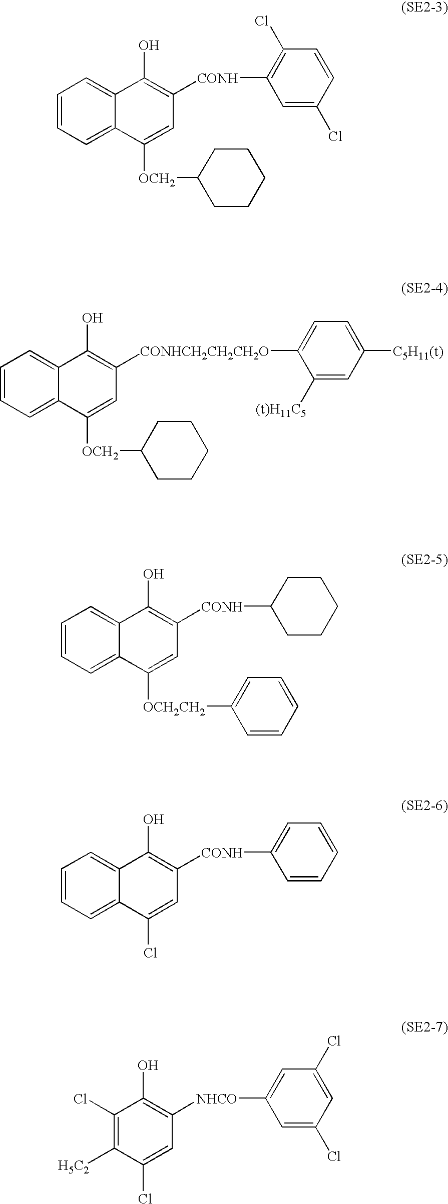
(Thermal Solvents)

It is preferable that the silver salt photothermographic dry imaging material of the present invention incorporates thermal solvents. Thermal solvents, as described herein, are defined as components capable of lowering the heat development temperature of a thermal solvent incorporating photothermographic dry imaging material by at least 1° C. than that incorporating non-thermal solvents. More preferred components are those capable of lowering the heat development temperature by at least 2° C., but the most preferred ones are those capable of lowering the heat development temperature by at least 3° C. Herein, a photothermographic dry imaging material incorporating thermal solvents is designated as A, while that of incorporating non-thermal solvents is designated as B. When the density of B after exposure and heat development at 120° C. for 20 seconds, is obtained by A after the same amount of exposure and heat development at less than or equal to 119° C., the component incorporated in A is designated as a thermal solvent. The thermal solvent has a polarity group as a substituent, and although representing with a Formula (TS) is preferable, it is not limited to these.
(Y)ₙZ Formula (TS)

In Formula (TS), Y represents an alkyl group, an alkenyl group, an alkynyl group, an aryl group, or a heterocycle group.

Z represents the group chosen from a hydroxy group, a carboxy group, an amino group, an amide group, a sulfonamide group, a phosphoric acid amide group, a cyano group, an imide group, an ureido group, a sulfoxide group, a sulfone group, a phosphine group, a phosphine oxide group, and an nitrogen containing heterocyclic group.

n represents an integer of 1-3, and when Z is a group of mono valent, n is 1; and when Z is a group of more than divalent, n is the same as that of the valence of Z. When n is two or more, two or more Y may be the same or different.

Y may further have a substituent and may have a substituent represented by Z.

Y is described in more detail.

In Formula (TS), Y represents a normal chain alkyl group, a branched chain alkyl group or a cyclic alkyl group (preferably 1 to 40 carbon atoms, more preferably 1-30 carbon atoms, still more preferably 1-25 carbon atoms), for example, methyl, ethyl, n-propyl, iso-propyl, sec-butyl, t-butyl, t-octyl, n-amyl, t-amyl, n-dodecyl, n-tridecyl, octadecyl, icosyl, docosyl, cyclopentyl, and cyclohexyl; an alkenyl group (preferably 2 to 40 carbon atoms, more preferably 2-30 carbon atoms, still more preferably 2-25 carbon atoms), for example, vinyl, an allyl, 2-butenyl, and 3-pentenyl; an aryl group (preferably 6 to 40 carbon atoms, more preferably 6-30 carbon atoms, still more preferably 6-25 carbon atoms), for example, phenyl, p-methylphenyl, and naphthyl; a heterocyclic group (preferably 2 to 20 carbon atoms, more preferably 2-16 carbon atoms, still more preferably 2-12 carbon atoms), for example, pyridyl, a pyrazyl, imidazoyl, and pyrrolidyl.

These substituents may be further substituted with the other substituent. Moreover, they may be combined with each other to form the ring.

Y may further incorporate substituents. Examples of such substituents are those described in ┌0015┘ of JP-A No. 2004-21068. Reasons in which development is activated by employing thermal solvents are assumed to be as follows. Thermal solvents melt at near development temperature to become compatible with materials related to the development, whereby it is possible to carry out reaction at a lower temperature than that when the thermal solvents are not incorporated. Since heat development is a reduction reaction in which relatively high polar carboxylic acid and a silver ion transport body are participated, it is preferable to form a reaction field exhibiting appropriate polarity via thermal solvents carrying a polar group.

The melting point of the thermal solvents, which are preferably employed in the present invention, is 50-200° C., but is more preferably 60-150° C. In heat developable photosensitive materials which are highly concerned with stability such as image retention properties against exterior circumstances, thermal solvents of a melting point of 100-150° C. are preferred.

Cited as specific examples of thermal solvents may be the compounds described in ┌0017┘ of JP-A No. 2004-21068 and compounds, MF-1-MF-3, MF-6, MF-7, MF-9-MF-12, and MF-15-MF-22, described in ┌0027┘ of U.S. Patent Publication Open to Public Inspection US2002/0025498.

The added amount of thermal solvents in the present invention is preferably 0.01-5.0 g/m², is more preferably 0.05-1.5 g/m², but is still more preferably 0.1-1.5 g/m². It is preferable that the thermal solvents are incorporated in the photosensitive layer. Further, thermal solvents may be employed individually or in combinations of at least two types. In the present invention, addition methods of thermal solvents are not particularly limited and may be incorporated in a liquid coating composition in any of the common forms such as a solution, an emulsion, or a minute solid particle dispersion and then incorporated in photosensitive materials.

Listed as a well known emulsification dispersion method is one in which dissolution is carried out employing oil such as dibutyl phthalate, tricresyl phosphate, or cyclohexane, and auxiliary solvents such as ethyl acetate or cyclohexane, whereby an emulsification dispersion is mechanically prepared.

Further, listed as a minute solid particle dispersion method is one in which powdered thermal solvents are dispersed into suitable solvents such as water, employing a ball mill, a colloid mill, a vibration-ball mill, a sand mill, a jet mill, a roller mill, or ultrasonic waves. Further, in the above case, employed may be protective colloid (for example, polyvinyl alcohol) and surface active agents (for example, anionic surface active agents such as sodium triisopropylnaphthalene sulfonate (a mixture in which the substitution positions of three isopropyl groups differ). In the above mills, beads such as zirconia are commonly employed as a dispersion medium, and Zr eluted from such beads is occasionally mixed into a dispersion. The mixing range is commonly 1-1,000 ppm, though it varies depending on dispersion conditions. The content of Zr in photosensitive materials of at most 0.5 mg per g of the incorporated silver results in no practical problem. It is preferable to incorporate antiseptics (for example, benzoisothiazolinone sodium salts) in aqueous dispersions.

(Antifogging Agents and Image Stabilizing Agents)

It is preferable that antifogging agents which minimize fog formation during storage prior to heat development and image stabilizing agents which minimize image degradation after heat development are incorporated into any of the constituting layers of the silver salt photothermographic dry imaging material of the present invention.

The antifogging agents and image stabilizing agents usable in the silver salt photothermographic dry imaging material of the present invention will now be described.

Mainly employed as the reducing agents according to the present invention are proton-incorporating reducing agents such as bisphenols and sulfonamidophenols. Consequently, it is preferable that compounds capable of stabilizing such hydrogen to inactivate reducing agents and retarding the silver ion reducing reaction are incorporated. Further, it is preferable the compounds are incorporated which are capable of oxidize-bleaching silver atoms or metallic silver (silver cluster) formed during storage of unexposed film or images. Listed as specific examples of compounds, which exhibit such functions, may be imidazolyl compounds and iodonium compounds. The added amount of the above imidazolyl compounds and iodonium compounds is commonly in the range of 0.001-0.1 mol/m², but is preferably in the range of 0.005-0.05 mol/m².

In cases in which reducing agents employed in the present invention have a hydroxyl group (—OH), specifically in cases of bisphenols, it is preferable to simultaneously use non-reducing compounds having a group capable of forming a hydrogen bond with these groups.

Listed as specific examples of particularly preferred hydrogen bonding compounds are compounds (II-1)-(II-40) described in paragraphs ^{┌}0061_{┘}-^{┌}0064_{┘} of JP-A No. 2002-90937.

Further, known as fog inhibiting and image stabilizing agents are many compounds capable of releasing halogen atoms as an active species. Specific examples of compounds generating such active halogen atoms, include the compounds represented by General Formula (9) described in ^{┌}0264_{┘}-^{┌}0271_{┘} of JP-A No. 2002-287299.

The added amount of these compounds is preferably in the range in which an increase in print-out silver due to the formation of silver halide causes substantially no problems. The ratio to compounds which do not generate active halogen radicals is preferably at most maximum 150 percent, but is preferably at most 100 percent. Listed as specific examples which generate these active halogen atoms may be compounds (III-1)-(III-23) described in paragraphs ^{┌}0086_{┘}-^{┌}0087_{┘} of JP-A No. 2002-169249, compounds 1-1a-1-1o and 1-2a-1-2o described in paragraphs ^{┌}0031_{┘}-^{┌}0034_{┘} and compounds 2a-2z, 2aa-2ll, and 2-1a-2-1f described in paragraphs ^{┌}0050_{┘}-^{┌}0056_{┘} of JP-A No. 2003-50441, and compounds 4-1-4-32 described in paragraphs ^{┌}0055_{┘}-^{┌}0058_{┘} and compounds 5-1-5-10 described in paragraphs ^{┌}0069_{┘}-^{┌}0072_{┘} of JP-A No. 2003-91054.

Antifogging agents preferably employed in the present invention, other than the above, will now be described. Listed as antifogging agents preferably employed in the present invention may, for example, be compound examples “a”-“j” in paragraph ^{┌}0012_{┘} of JP-A No. 8-314059, thiosulfonate esters A-K in paragraph ^{┌}0028_{┘} of JP-A No. 7-209797, compound examples (1)-(44) described from page 14 of JP-A No. 55-140833, compounds (1-1)-(1-6) described in paragraph ^{┌}0063_{┘} and (C-1)-(C-3) described in paragraph ^{┌}0066_{┘} of JP-A No. 2001-13627, compounds (III-1)-(III-108) described in paragraph ^{┌}0027_{┘} of JP-A No. 2002-90937, compounds VS-1-VS-7 and compounds HSD-1-HS-5 described in paragraph ^{┌}0013_{┘} of JP-A No. 6-208192 as a vinylsulfone and/or β-halosulfone compound, compounds KS-1-KS-8 described in JP-A No. 2000-330235 as a sulfonylbenzotriazole compound, PR-01-PR-08 described in Japanese Patent Publication Open to Public Inspection (under PCT application) No. 2000-515995 as a substituted propanenitrile compound, and compounds (1)-1-(1)-132 described in paragraphs ^{┌}0042_{┘}-^{┌}0051_{┘} of JP-A No. 2002-207273.

The aforesaid antifogging agents are employed in an amount of at least 0.001 mol with respect to mol of silver. The range is commonly 0.01-5 mol with respect to mol of silver, but is preferably 0.02-0.6 mol with respect to mol of silver.

Incidentally, in addition to the aforesaid compounds, those, which have conventionally been known as an antifogging agent, may be incorporated in the photothermographic material of the present invention. These include compounds which generate reaction active species which are the same as the above compounds or compounds which exhibit different fog inhibiting mechanism. Examples include the compounds described in U.S. Pat. Nos. 3,589,903, 4,546,075, and 4,452,885, JP-A No. 59-57234, U.S. Pat. Nos. 3,874,946 and 4,756,999, JP-A Nos. 9-2883238 and 9-905560. In addition, listed as other antifogging agents are compounds disclosed in U.S. Pat. No. 5,028,523, as well as European Patent Nos. 600,587, 605,981 and 631,176.

<Toner (Toning Agent)>

The photothermographic material of the present invention forms photographic images via thermal photographic processing, and it is preferable that toners, which control silver tone, are, if desired, incorporated commonly in the dispersed state in an (organic) binder matrix.

Examples of appropriate toners employed in the present invention are disclosed in RD No. 17029, as well as U.S. Pat. Nos. 4,123,282, 3,994,732, 3,846,136, and 4,021,249, examples of which include the following.

Imides (e.g., succinimide, phthalimide, naphthalimide, and N-hydroxy-1,8-naphthalimide); mercaptans (e.g., 3-mercapto-1,2,4-triazole); phthalazinone derivatives or metal salts thereof (e.g., phthalazinone, 4-(1-naphthyl)phthalazinone, 6-chlorophthalazinone, 5,7-dimethyloxyphthalazinone, and 2,3-dihydro-1,4-phthalazinedione); combinations of phthalazine with phthalic acids (e.g., phthalic acid, 4-methylphthalic acid, 4-nitrophthalic acid and tetrachlorophthalic acid; and combinations of phthalazine with at least one compound selected from maleic anhydrides, phthalic acid, 2,3-naphthalenedicarboxylic acid or o-phenylenic acid derivatives and anhydrides thereof (e.g., phthalic acid, 4-methylphthalic acid, 4-nitrophthalic acid and tetrachlorophthalic anhydride). Particularly preferred toners are phthalazinone or combinations of phthalazine with phthalic acids or phthalic anhydrides.

<Fluorine Based Surface Active Agents>

In the present invention, in order to improve film conveyance properties in a thermal processor and environmental adaptability (accumulating properties in living bodies), the fluorine based surface active agents, represented by Formula (SF) below, are preferably employed.
(Rf-(L₁)ₙ₁-)ₚ-(Y)ₘ₁-(A)_{q} Formula (SF)
wherein Rf represents a substituent incorporating a fluorine atom, L₁ represents a divalent linking group having no fluorine atom, Y represents a (p+q) valent linking group having no fluorine atom, A represents an anionic group or salts thereof, n1 and m1 each represent an integer of 0 or 1, p represents an integer of 1-3, and q represents an integer of 1-3, provided that when q represents 1, n1 and m1 are not simultaneously 0.

In the above Formula (SF), Rf represents a substituent containing a fluorine atom. Listed as the above substituents containing a fluorine atom are, for example, a fluorinated alkyl group (e.g., a trifluoromethyl group, a trifluoroethyl group, a perfluoroethyl group, a perfluorobutyl group, a perfluorooctyl group, a perfluorodecyl group, and a perfluorooctadecyl group) or a fluorinated alkenyl group (e.g., a perfluoropropenyl group, a perfluoronobutenyl group, a perfluorononenyl group, and a perfluorododecenyl group).

L₁ represents a divalent linking group with no fluorine atom. Listed as such divalent linking groups with no fluorine atom are, for example, an alkylene group (e.g., a methylene group, an ethylene group, and a butylene group); an alkyleneoxy group (e.g., a methylenoxy group, an ethyleneoxy group, and a butyleneoxy group); an oxyalkylene group (e.g., an oxymethylene group, an oxyethylene group, an oxybutylene grip); an oxyaklyleneoxy group (e.g., an oxymethyleneoxy group an oxyethyleneoxy group and an oxyethyleneoxyethyleneoxy group); a phenylene group, an oxyphenylene group, a phenyloxy group, and an oxyphenyloxy group, or a group formed by combining these groups.

“A” represents an anionic group or salts thereof. Examples include a carboxylic acid group or salts thereof (sodium salts, potassium salts, and lithium salts), a sulfonic acid group or salts thereof (sodium salts, potassium salts, and lithium salts), a sulfuric acid half ester group or salts thereof (sodium salts, potassium salts, and lithium salts), and a phosphoric acid group or salts thereof (sodium salts, and potassium salts).

Y represents a (p+q) valent linking group. Examples of trivalent or tetravalent linking groups with no fluorine atom include a group of atoms composed of nitrogen atoms or carbons atoms as a main component, while n1 represents an integer of 0 or 1 but 1 is preferred.

The fluorine based surface active agents represented by Formula (SF) are prepared as follows. Compounds (being alkanol compounds which are subjected to partial Rf reaction) are prepared via addition reaction or condensation reaction of fluorine atom-introduced alkyl compounds having 1-25 carbon atoms (for example, compounds having a trifluoromethyl group, a pentafluoroethyl group, a perfluorobutyl group, a perfluorooctyl group, or a perfluorooctadecyl group), and alkenyl compounds (for example, a perfluorohexenyl group and a perfluorononenyl group) with tri- to haxa-valent alkanol compounds, each of which has no introduced fluorine atom and aromatic compounds having 3-4 hydroxyl groups or hetero compounds, and subsequently, anion group (A) is introduced into the above compounds via, for example, sulfuric acid esterification.

Listed as the above tri- to hexa-valent compounds are glycerin, pentaerythritol, 2-methyl-2-hydroxymethyl-1,3-propanediol, 2,4-dihydroxy-3-hydroxymethylpentane, 1,2,6-hexanetriol, 1,1,1-tris (hydroxymethyl)propane, 2,2-bis(butanol)-3, aliphatic triol, tetramethylolmethane, D-sorbitol, xylitol, and D-mannitol.

Further, listed as the above aromatic compounds having 3-4 hydroxyl groups are 1,3,5-trohydroxybenzene and 2,4,6-trihydroxypyridine.

Examples of the above-described fluorine based surface active agents as listed as follows: (FS-1) to (FS-66) in paragraphs [0029]-[0040] of JP-A No. 2003-149766; compounds 1-1 to 1-4 in the paragraph [0014], compounds 2-1 to 2-10 in paragraph [0019] of JP-A No. 2004-021084; and compounds in paragraphs [0025] and [0030] of JP-A No. 2004-077792.

Specific compounds of the preferred fluorine based surface active agents, represented by Formula (SF), will now be listed.

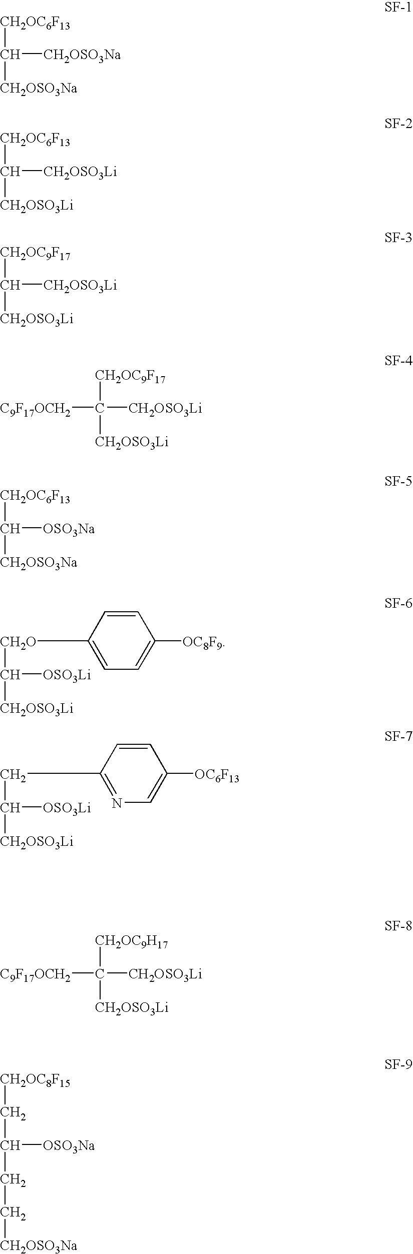

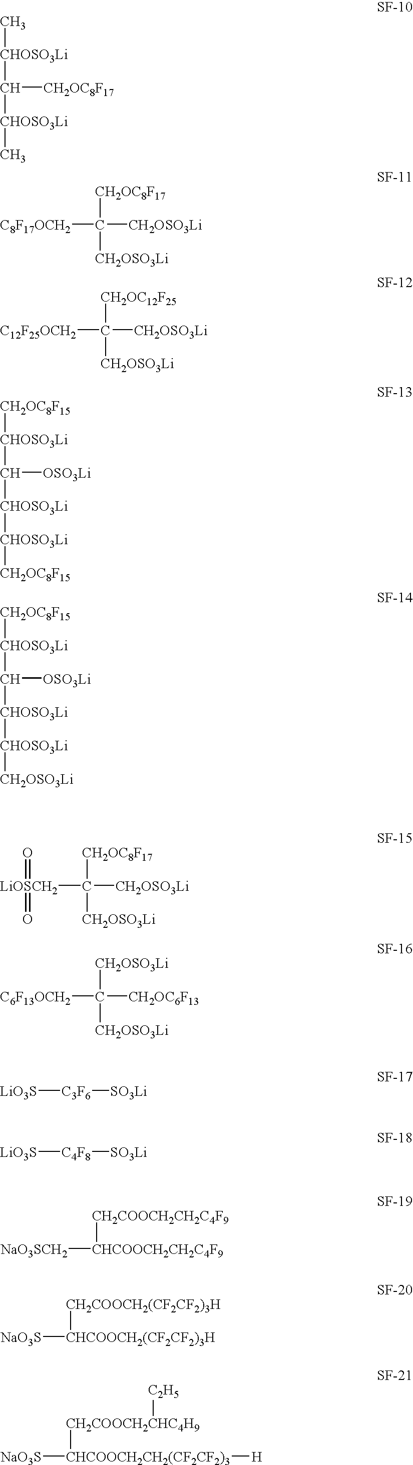

Other fluorine based surfactant which may be used are disclosed: in [0035] of JP-A No. 2004-117505; JP-A No. 2000-214554; JP-A No. 2003-156819; JP-A No. 2003-177494; JP-A No. 2003-114504; JP-A No. 2003-270754; and JP-A No. 2003-270760.

In the present invention, a combination of an anionic fluorine surfactant represented by Formula (SF) and known nonionic surfactant is preferred with respect to a charging behavior and improving coating property. 2003-270760.

It is possible to add the fluorine based surface active agents represented by Formulas (SF) to liquid coating compositions, employing any conventional addition methods known in the art. Namely, they are dissolved in solvents such as alcohols including methanol or ethanol, ketones such as methyl ethyl ketone or acetone, and polar solvents such as dimethylformamide, and then added. Further, they may be dispersed into water or organic solvents in the form of minute particles at a maximum size of 1 μm, employing a sand mill, a jet mill, or an ultrasonic homogenizer and then added. Many techniques are disclosed for minute particle dispersion, and it is possible to perform dispersion based on any of these. It is preferable that the aforesaid fluorine based surface active agents represented by Formulas (SF) are added to the protective layer which is the outermost layer.

The added amount of the aforesaid fluorine based surface active agents is preferably 1×10⁻⁸-1×10⁻¹ mol per m², more preferably 1×10⁻⁵-1×10⁻² mol per m². When the added amount is less than the lower limit, it is not possible to achieve desired charging characteristics, while it exceeds the upper limit, storage stability degrades due to an increase in humidity dependence.

(Lubricants)

Employed as lubricants may be those described, for example, in paragraphs ┌0061┘-┌0064┘ of JP-A No. 11-84573. Further, it is preferable to employ solid lubricant particles and liquid lubricants at normal temperature. Listed as lubricants which are liquid at normal temperature are compounds described, for example, in paragraph ┌0019┘ of JP-A No. 2003-15259. As solid lubricant particles, it is preferable to employ organic solid lubricant particles of an average particle diameter of 1-30 μm, and the melting point of organic solid lubricants is preferably 110-200° C.

<Surface Layer>

Ten-point mean roughness (Rz), maximum roughness (Rt), and center line mean roughness (Ra) in the present invention are defined based on JIS Surface Roughness (B 0601). The term, “ten-point mean roughness” refers to the value represented in micrometers which is the difference between the average value of height from the highest summit to the fifth highest summit which are determined in the longitudinal magnification direction from a straight line which is parallel to the parallel line and does not cross the cross-sectional curve in the portion which is picked out by the standard length and the average value of the depth from the deepest valley to the fifth deepest valley. The term, “maximum roughness (Rt)” refers to the value represented in micrometer of the value which is determined in such a manner that the roughness curve is picked out by standard length L, and when the picked-out portion is interposed by two straight lines parallel to the center line, the gap between the resulting two lines is determined in the longitudinal magnification direction of the roughness curve. The term, “center line mean roughness (Ra)” refers to the value in micrometers, which is obtained by the following formula when a portion of measurement length L is picked out in the center line direction from the roughness curve, and the roughness curve is expressed by y=f(x), wherein the center line is taken as the X axis and the longitudinal magnification is taken as the Y axis.

$$Ra = \frac{1}{L} {\int }_{0}^{L} \vert f ( x ) \vert ⅆ x$$

Samples were subjected to moisture control at 25° C. and 65 percent relative humidity for 24 hours under no overlapping conditions, and subsequently, Rz, Rt, and Ra were determined at the same ambience. The term, “no overlapping conditions” refers to any of the methods in which, for example, winding is performed in such a manner that the edge portions are raise, films are overlapped while a paper sheet is inserted between the films, and a flame is prepared employing cardboard and the four corners are fixed. Listed as a usable measurement apparatus may, for example, be a RSTPLUS non-contact three-dimensional minute surface state measurement system.

It is possible to readily control Rz, Rt, and Ra of the front and rear surface of light-sensitive materials to be within the range of the present invention by appropriately combining the following technical means.

(1) types, average particle diameter, added amount, and surface treatment methods of matting agents (inorganic or organic powders) incorporated in the layer on the side having an image forming layer and the layer on the side opposite the image forming layer;

(2) dispersion conditions of matting agents (types of employed homogenizers, dispersion time, types of beads employed for dispersion, average particle diameter, types and amounts of dispersing agents used during dispersion, content of a polar group;

(3) drying conditions after coating (coating rate, distance of heated air blowing nozzle from the coating surface, and drying air amount) and the amount of residual solvents;

(4) types of filters employed to filter liquid coating compositions and filtration time; and

(5) in cases in which a calendar treatment is performed after coating, the employed conditions (for example, calendering temperature of 40-80° C., pressure of 50-300 kg/cm, line speed of 20-100 m, and the number of nips being 2-6).

In the present invention, the value of Rz(E)/Rz(B) is preferably 0.1-0.7, is more preferably 0.2-0.6, but is still more preferably 0.3-0.55. By controlling the above value to be in this range, of effects of the present invention, it is possible to markedly improve film conveyance and to minimize generation of uneven density.

In the present invention, the value of Ra(E)/Ra(B) is preferably 0.6-1.5, is more preferably 0.6-1.3, but is still more preferably 0.7-1.1. By controlling the above values to be in such a range, of effects of the present invention, particularly, it is possible to minimize an increase in fogging over an elapse of time, improve film conveyance, and minimize the generation of uneven density.

In the image forming method of the present invention, Lb/Le is preferably 2.0-10, but is more preferably 3.0-4.5, wherein Le (in μm) represents the average particle diameter of matting agents, having the maximum average particle diameter incorporated in the surface on the side having an image forming layer, while Lb (in μm) is the average particle diameter of matting agents having the maximum average particle diameter incorporated in the surface on the side having a back coat layer.

By controlling Lb/Le to be in such a range, of effects of the present invention, particularly, it is possible to minimize uneven density during heat development. Further, in the image forming method of the present invention, the value of Rz(E)/Ra(E) is preferably 12-60, but is more preferably 14-50. By controlling Rz(E)/Ra(E) to be in such a range, of effects of the present invention, particularly, it is possible to minimize uneven density during heat development and to improve storage characteristics over an elapse of time.

Still further, in the image forming method of the present invention, the value of Rz(B)/Ra(B) is preferably 25-65, but is more preferably 30-60. By controlling Rz(B)/Ra(B) to be in such a range, of effects of the present invention, particularly, it is possible to minimize uneven density during heat development and to improve storage characteristics over an elapse of time.

<<Measurement of Surface Roughness>>

The samples prior to applying thermal development are measured with a non-contact 3 dimensional surface analyzing apparatus (RST/PLUS, made by WYKO Co. Ltd.). The conditions for measurement are as follows.

(1) Object lens: ×10.0; middle lens: ×1.0

(2) Range of measurement: 463.4 μm×623.9 μm

(3) Pixel size: 368×238

(4) Filter: cylinder correction and gradient correction

(5) Smoothing: medium smoothing

(6) Scanning speed: low

Ra, Rz, and Rt are obtained based on JIS surface roughness (B0601). Samples having 10 cm×10 cm are divided into 100 grids of 1 cm×1 cm. An average value is derived from all of the measurement for the 100 grids.

In the present invention, it is preferable to use organic or inorganic powders as a matting agent in the surface layer (on the side of the image forming layer, or even in cases in which a non-image forming layer is provided, on the side opposite the image forming layer across the surface of the support) in order to achieve the purpose of the present invention and control the surface roughness.

Preferably employed as powders used in the present invention are those of a Mohs hardness of at least 5. Appropriately selected and employed as powders may be inorganic and organic powders known in the art. Listed as inorganic powders may, for example, be titanium oxide, boron nitride, SnO₂, SiO₂, Cr₂O₃, α-Al₂O₃, α-Fe₂O₃, α-FeOOH, SiC, cerium oxide, corundum, artificial diamond, garnet, mica, quartzite, silicon nitride, and silicon carbide. Listed as organic powders may, for example, be powders of polymethyl methacrylate, polystyrene, and TEFLON (a registered trade name). Of these, preferred are inorganic powders such as SiO₂, titanium oxide, barium sulfate, α-Al₂O₃, α-Fe₂O₃, α-FeOOH, Cr₂O₃, or mica. Of these, preferred are SiO₂ and α-Al₂O₃, while α-Al₂O₃ is particularly preferred.

In the present invention, it is preferable that the aforesaid powders are, for example, subjected to a surface treatment. A surface treatment layer is formed as follows. After crushing inorganic powder components in a dry state, water and dispersing agents are added and subsequently, the resulting mixture is subjected to wet crushing, followed by rough particle size classification by employing centrifugal separation. Thereafter, a minute particle slurry is transferred to a surface treatment vessel and surface coating of metal hydroxides is performed. Initially, an aqueous solution of salts such as Al, Si, Ti, Zr, Sb, Sn, or Zn is added and acid or alkali, which neutralizes the resultant mixture, is added, whereby the surface of inorganic powder particles is coated employing the resulting hydrate oxides. Water-soluble salts formed as a by-product are removed employing decantation, filtration and washing. Finally, the pH of the slurry is controlled and the resulting slurry is washed with pure water. The washed cake is dried employing a spray drier or a portable dryer. Finally, the resulting dried material is crushed employing a jet mill to form a product. Alternatively, it is possible to perform an Al, Si surface treatment in such a manner that vapor of AlCl₃ and SiCl₄ is flowed into non-magnetic inorganic powders and thereafter steam is flowed in. With regard to other surface treatment methods, it is possible to refer to “Characterization of Powder Surface”, Academic Press.

In the present invention, it is preferable that the surface treatment is performed employing Si or Al compounds. Use of powders, which have been subjected to such a surface treatment, makes it possible to improve the dispersion state during matting agent dispersion. With regard to the content of the above Si and Al, it is preferable that Si is 0.1-10 percent by weight with respect to the above powders, while Al is 0.1-10 percent by weight. It is more preferable that Si is 0.1-5 percent by weight and Al is 0.-5 percent by weight, but it is most preferable that Si is 0.1-2 percent by weight and Al is 0.1-2 percent by weight. Further, the weight ratio of Si to Al is preferably in the relationship of Si<Al. It is possible to perform the surface treatment employing the method described in JP-A No. 2-83219. The average particle diameter of the powders in the present invention refers to the average diameter of spherical particles in the particle powders, the average major axis length of acicular particles in acicular particle powder, and the average of the length of the maximum diagonal of the tabular plane of tabular particles in the tubular particle powder. It is easily determine such a diameters based on measurements employing an electron microscope.

The average particle diameter of the above organic or inorganic powders is preferably 0.5-10 μm, but is more preferably 1.0-8.0 μm.

The average particle diameter of organic or inorganic powders incorporated in the outermost layer on the image forming layer side is commonly 0.5-8.0 μm, is preferably 1.0-6.0 μm, but is more preferably 2.0-5.0 μm.

The added amount is commonly 1.0-20 percent by weight with respect to the binder weight (the weight of cross-linking agents is included in the weight of binders) employed in the outermost layer, is preferably 2.0-15 percent by weight, but is more preferably 3.0-10 percent by weight.

The average particle diameter of organic or inorganic powders incorporated into the outermost layer opposite the image forming layer side across the support is commonly 2.0-15.0 μm, is preferably 3.0-12 μm, but is more preferably 4.0-10.0 μm. The added amount is commonly 1.0-10 percent by weight with respect to the binder weight (the weight of cross-linking agents is included in the weight of binders) employed in the outermost layer, is preferably 0.4-7 percent by weight, but is more preferably 0.6-5 percent by weight.

Further, the variation coefficient of the particle size distribution of powders is preferably at most 50 percent, is more preferably at most 40 percent, but is most preferably at most 30 percent. The variation coefficient of the particle size distribution, as described herein, refers to the value represented by the formula below.
{(standard variation of particle diameter)/(average value of particle diameter)}×100

Organic or inorganic powders may be added employing a method in which they are previously dispersed in a liquid coating composition and coated, or in which after coating a liquid costing composition, organic or inorganic powders are sprayed onto the coating prior to the completion of drying. Further, in cases in which a plurality of types of powders is added, both methods may simultaneously be employed.

<Support>

Listed as materials of the support employed in the silver salt photothermographic dry imaging material of the present invention are various kinds of polymers, glass, wool fabric, cotton fabric, paper, and metal (for example, aluminum). From the viewpoint of handling as information recording materials, flexible materials, which can be employed as a sheet or can be wound in a roll, are suitable. Accordingly, preferred as supports in the silver salt photothermographic dry imaging material of the present invention are plastic films (for example, cellulose acetate film, polyester film, polyethylene terephthalate film, polyethylene naphthalate film, polyamide film, polyimide film, cellulose triacetate film or polycarbonate film). Of these, in the present invention, biaxially stretched polyethylene terephthalate film is particularly preferred. The thickness of the supports is commonly from about 50 to about 300 μm, and is preferably from 70 to 180 μm.

In the present invention, in order to minimize static-charge buildup, electrically conductive compounds such as metal oxides and/or electrically conductive polymers may be incorporated in composition layers. The compounds may be incorporated in any layer, but are preferably incorporated in a subbing layer, a backing layer, and an interlayer between the photosensitive layer and the subbing layer. In the present invention, preferably employed are electrically conductive compounds described in columns 14 through 20 of U.S. Pat. No. 5,244,773. Especially, it is preferable to incorporate a conductive metal oxide compound in a surface protective layer located on the same side as a baking layer. It was found that the effect of the present invention (especially, transporting property of the photothermographic material during heat processing.

Electrically conductive metal oxides, as described herein, include crystalline metal oxide particles. Those which contain oxygen defects, as well as a small amount of foreign atoms, which form a donor to metal oxides, are preferably employed since they are generally highly conductive. Specifically, the latter is particularly preferred since no fogging results in silver halide emulsions. Preferred as examples of metal oxides are ZnO, TiO₂, SnO₂, Al₂O₃, In₂O₃, SiO₂, MgO, BaO, MoO₃, and V₂O₅, as well as composite oxides thereof. Of these, particularly preferred are ZnO, TiO₂, and SnO₂. In examples containing foreign atoms, the addition of Al and In to ZnO, the addition of Sb, Nb, P, and halogen atoms to SnO₂, as well as the addition of Nb and Ta to TiO₂ are effective. The added amount of these foreign atoms is preferably in the range of 0.01-30 mol percent, but is most preferably in the range of 0.1-10 mol percent. Further, in order to improve minute particle dispersibility as well as transparency, silicon compounds may be incorporated during formation of minute particles.

Minute metal oxide particles employed in the present invention exhibit electric conductivity and volume resistivity thereof is at most 10⁷ Ω·cm, but is specifically at most 10⁵ Ω·cm. These oxides are described in JP-A Nos. 56-143431, 56-120519, and 58-62647. In addition, as described in Japanese Patent Publication No. 59-6235, employed may be electrically conductive components which are prepared by adhering the above metal oxides onto other crystalline metal oxide particles or fibrous materials (titanium oxide).

The preferred particle size is at most 1 μm. Particles at a maximum size of 0.5 μm are easily used since stability after dispersion is higher. Further, in order to reduce light scattering as much as possible, it is most preferable to use conductive particles of a maximum size of 0.3 μm since it is possible thereby to prepare transparent light-sensitive materials. Further, in cases in which conductive metal oxides are acicular or fibrous, it is preferable that their length is at most 30 μm and the diameter is at most 1 μm. It is also most preferable that the length is at most 10 μm and the diameter is at most 1 μm, while the length/diameter ratio is at least 3. Incidentally, SnO₂ is commercially available from Ishihara Sangyo Kaisha, Ltd. It is also allowed to use SNS10M, SAN-100P, SN-100D, and FSS10M.

The photothermographic material of the present invention incorporates a support having thereon at least one image forming layer, which is a light-sensitive layer. Only an image forming layer may be formed on a support, but it is preferable that at least one light-insensitive layer is formed on the image forming layer. For example, it is preferable that a protective layer is provided on the image forming layer for the purpose of protecting the image forming layer. Further, a back coat layer is provided on the opposite surface of the support in order to minimize “sticking” between light-sensitive materials or in wound rolls of light-sensitive materials.

Selected as binders employed in such a protective layer and a back coat layer from the aforesaid binders are, for example, polymers such as cellulose acetate, cellulose acetate butyrate, or cellulose acetate propionate, which exhibit a higher glass transition point (Tg) than the image forming layer, and barely suffer from abrasion as well as deformation.

Incidentally, in order to control gradation, at least two image forming layers may be formed on one side of the support or at least one layer may be formed on both sides of the same.

<Layer Structures and Coating Conditions>

It is preferable to prepare the silver salt photothermographic dry imaging material of the present invention as follows. Materials of each constitution layer as above are dissolved or dispersed in solvents to prepare coating compositions. Resultant coating compositions are subjected to simultaneous multilayer coating and subsequently, the resultant coating is subjected to a thermal treatment. “Simultaneous multilayer coating”, as described herein, refers to the following. The coating composition of each constitution layer (for example, a photosensitive layer and a protective layer) is prepared. When the resultant coating compositions are applied onto a support, the coating compositions are not applied onto a support in such a manner that they are individually applied and subsequently dried, and the operation is repeated, but are simultaneously applied onto a support and subsequently dried. Namely, before the residual amount of the total solvents of the lower layer reaches 70 percent by weight (more preferably less than 90 percent by weight), the upper layer is applied.

Simultaneous multilayer coating methods, which are applied to each constitution layer, are not particularly limited. For example, are employed methods, known in the art, such as a bar coater method, a curtain coating method, a dipping method, an air knife method, a hopper coating method, and an extrusion method.

Of these, more preferred is the pre-weighing type coating system called an extrusion coating method. The aforesaid extrusion coating method is suitable for accurate coating as well as organic solvent coating because volatilization on a slide surface, which occurs in a slide coating system, does not occur. Coating methods have been described for coating layers on the photosensitive layer side. However, the backing layer and the subbing layer are applied onto a support in the same manner as above. The detailed description of simultaneous multilayer coating methods for a photothermographic material is found in JP-A No. 2000-15173.

An adequate amount of silver coverage is selected in accordance with the purpose of the photothermographic material. For medical use, the silver coverage is preferably from 0.3 to 1.5 g/m², and is more preferably from 0.5 to 1.5 g/m². The ratio of the silver coverage which is resulted from silver halide is preferably from 2 to 18 percent with respect to the total silver, and is more preferably from 5 to 15 percent.

Further, in the present invention, the number of coated silver halide grains, having a grain diameter (being a sphere equivalent grain diameter) of at least 0.01 μm, is preferably from 1×10¹⁴ to 1×10¹⁸ grains/m², and is more preferably from 1×10¹⁵ to 1×10¹⁷.

Further, the coated weight of aliphatic carboxylic acid silver salts of the present invention is from 10⁻¹⁷ to 10⁻¹⁴ g per silver halide grain having a diameter (being a sphere equivalent grain diameter) of at least 0.01 μm, and is more preferably from 10⁻¹⁶ to 10⁻¹⁵ g.

When coating is carried out under conditions within the aforesaid range, from the viewpoint of maximum optical silver image density per definite silver coverage, namely covering power as well as silver image tone, desired results are obtained.

In the present invention, it is preferable that during development, photothermographic materials incorporate solvents in an amount of 5-1,000 mg/m². However, it is more preferable that the above amount is controlled to be 100-500 mg/m². By so doing, photothermographic materials are allowed to exhibit high photographic speed, lowered fogging, and higher maximum density. Listed as such solvents are those described in paragraph ^{┌}0030_{┘} of JP-A No. 2001-264930, however, they are not limited thereto. Further, these solvents may be employed individually or in combinations of several types.

Incidentally, it is possible to control the amount of the above solvents in the photothermographic materials by changing conditions such as temperature during the drying process, following the coating process. Further, it is possible to determine the amount of the above solvents by employing gas chromatography under conditions suitable for detecting incorporated solvents.

<Packages>

In cases in which the photothermographic materials of the present invention are stored, in order to minimize density variation and fogging over an elapse of time, or to minimize curl and core-set curl, it is preferable that packaging is performed employing packaging materials of low oxygen permeability and/or low moisture permeability. The oxygen permeability is preferably at most 50 ml/atm·m²·day at 25° C., is more preferably 10 ml/atm·m²·day, but is still more preferably 1.0 ml/atm·m²·day.

The moisture permeability is preferably 0.01 g/m²·40° C.·90% RH·day (based on JIS Z 0208 Dish Method), is more preferably 0.05 g/m²·40° C.·90% RH·day, and still more preferably 0.001 g/m²·40° C.·90% RH·day.

Specific examples of packaging materials for photothermographic materials include those described, for example, in JP-A Nos. 8-254793, 2000-206653, 2000-235242, 2002-0626225, 2003-0152261, 2003-057790, 2003-084397, 2003-098648, 2003-098635, 2003-107635, 2003-131337, 2003-146330, 2003-226439, and 2003-228152. The void ratio in packages is commonly controlled to be 0.01-10 percent, but is preferably 0.02-5 percent. Further, by enclosing nitrogen, it is preferable to control the partial pressure of nitrogen in the package to be at least 80 percent, but preferably at least 90 percent. Further, it is preferable to control the relative humidity in the package to be 10-60 percent, but is more preferably 40-55 percent.

Further, in order to minimize image defects such as abrasion or white spots, it is preferable to perform a slitting process and a packaging process under a circumstance at a degree of cleanness of U.S. Federal Standard 209d Class 10,000 or better.

### EXAMPLES

The present invention will now be detailed with reference to examples, however the present invention is not limited thereto. “%” in the examples represents “% by weight” unless otherwise specified.

### Example 1

<<Preparation of Subbed Photographic Support>>

A photographic support, which was prepared in such a manner that both sides of a biaxially oriented and thermally fixed 175 μm thick polyethylene terephthalate film dyed with the following blue dye at an optical density of 0.150 (determined by DENSITOMETER PDA-65, produced by Konica Corp.) was subjected to corona discharge treatment of 8 W·minute/m², was subjected to a subbing treatment. Namely, Subbing Liquid Coating Composition a-1 was applied onto one side of the above photographic support at 22° C. and 100 m/minute to reach a dried layer thickness of 0.2 μm, and dried at 140° C., whereby a subbing layer (hereinafter referred to as Subbing Layer A-1) on the photosensitive layer (being the image forming layer) side was prepared. Further, following Subbing Liquid Coating Composition b-1, as a backing layer subbing layer, was applied onto the surface on the opposite side at 22° C. and 100 m/minute to reach a dried layer thickness of 0.12 μm and dried at 240° C., whereby a subbing conductive layer (referred to as Subbing Layer b-1) exhibiting an antistatic function was formed on the backing layer side. Each of the upper surfaces of Subbing Layers A-1 and B-1 was subjected to corona discharge treatment of 8 W·minute/m², and following Subbing Liquid Coating Composition a-2 was applied onto Subbing Lower Layer A-1 at 33° C. and 100 m/minute to reach a dried layer thickness of 0.03 μm and dried at 140° C., whereby Subbing Upper Layer A was prepared. Following Subbing Liquid Coating Composition b-2 was applied onto Subbing Lower Layer B-1 at 33° C. and 100 m/minute to reach a dried layer thickness of 0.2 pm and dried at 140° C., whereby Subbing Upper Layer B-2 was prepared. Further, the resultant coating was subjected to heat treatment at 23° C. for two minutes and then wound up at 25° C. and 50% relative humidity, whereby a subbed sample was prepared. 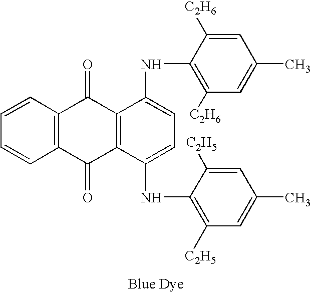
(Preparation of Water Based Polyester A-1 Solution)

A mixture of 35.4 parts by weight of dimethyl phthalate, 33.63 parts by weight of dimethyl isophthalate, 17.92 parts by weight of sodium dimethyl 5-sulfoisophthalate, 62 parts by weight of ethylene glycol, 0.065 part by weight of calcium acetate monohydrate, and 0.022 part by weight of manganese acetate tetrahydrate underwent transesterification reaction under a nitrogen flow at 170-220° C. while distilling off methanol. Thereafter, 0.04 part by weight of trimethyl phosphate, 0.04 part by weight of antimony trioxide as a polycondensation catalyst, and 6.8 parts by weight of 4-cyclohexanedicarboxylic acid were added and esterification was performed at 220-230° C. while distilling off water of a nearly theoretical amount.

Thereafter, pressure in the reaction system was reduced over one hour and then the temperature was raised. Subsequently, polycondensation was performed at 280° C. and at most 133 Pa, whereby Water Based Polyester A-1 was synthesized. The intrinsic viscosity, the average particle diameter, and Mw of the resultant Water Based Polyester A-1 were 0.33, 40 nm and 80,000-100.000, respectively.

Subsequently, charged into a 2 L three-necked flask, fitted with stirring blades, a reflux cooling pipe, and a thermometer, was 850 ml of pure water, and while turning the stirring blades, 150 g of Water Base Polyester A-1 was gradually added. After stirring for 30 minutes at room temperature without any modification, the interior temperature was raised to 98° C. over 1.5 hours, and dissolution was performed at the above temperature. After completion of the heating, the temperature was lowered to room temperature over one hour, and the solution was allowed to stand overnight, whereby a 1.5% by weight Water Based Polyester A-1 Solution was prepared.

(Preparation of Modified Water Based Polyester B-1-2 Solutions)

Charged into a 3 L four-necked flask, fitted with stirring blades, a reflux cooling pipe, a thermometer, and a dripping funnel, was 1,900 ml of above 15% by weight Water Based Polyester A-1 Solution. While turning the stirring blades, the interior temperature was raised to 80° C. Subsequently, 6.52 ml of a 24% by weight aqueous ammonium peroxide solution was added, and a monomer mixed liquid (28.5 g of glycidyl methacrylate, 21.4 g of ethyl acrylate, and 21.4 g of methyl methacrylate) was dripped over 30 minutes and the reaction was continued for an additional three hours. Thereafter, the temperature was lowered to 30° C. and filtration was conducted, whereby Modified Water Based Polyester B-1 Solution (vinyl based component modification ratio of 20% by weight) of a solid concentration of 18% by weight was prepared.

Modified Water Based Polyester B-2 Solution (vinyl based component modification ratio of 20% by weight) of a solid concentration of 18% by weight) was prepared in the same manner as above, except that the vinyl modification ratio was varied to 36% by weight, and the modification components were changed to styrene:glycidyl methacrylate acetacetoxyethyl methacrylate:n-butyl acrylate=39.5:40:20:0.5.

(Preparation of Acryl Based Polymer Lattices C-1-C-3)

Acryl Based Polymer Lattices C-1-C-3 incorporating monomer compositions, shown in Table 1, were synthesized via emulsion polymerization. All solid concentrations were regulated to 30% by weight.

TABLE 1

| Latex | | Tg |
|---|---|---|
| No. | Monomer Composition (weight ratio) | (° C.) |
| C-1 | styrene:glycidyl methacrylate:n-butyl acrylate = 20:40:40 | 20 |
| C-2 | styrene:n-butyl acrylate:t-butyl acrylate:hydroxyethyl | 55 |
| | methacrylate = 27:10:35:28 | |
| C-3 | styrene:glycidyl methacrylate:acetacetoxyethyl | 50 |
| | methacrylate = 40:40:20 | |

(Photosensitive Layer Side Lower Subbing Layer Liquid Coating Composition a-1)

| | |
|---|---|
| Acryl based Polymer Latex C-3 (30% solids) | 70.0 g |
| Aqueous dispersion of ethoxylated alcohol and | 5.0 g |
| ethylene homopolymer (10% solids) | |
| Surface Active Agent (A) | 0.1 g |

Distilled water was added to the above to make 1,000 ml, whereby a liquid coating composition was prepared.

<<Photosensitive Layer Side Upper Subbing Layer Liquid Coating Composition a-2>>

| | |
|---|---|
| Modified Water Based Polyester B-2 (18% by | 30.0 g |
| weight) | |
| Surface Active Agent (A) | 0.1 g |
| Spherical Silica Matting Agent (SEAHOSTER | 0.04 g |
| KE-P50, produced by Nippon Shokubai | |
| Co., Ltd.) | |

Distilled water was added to the above to make 1,000 ml, whereby a liquid coating composition was prepared.

(Backing Layer Side Lower Subbing Layer Liquid Coating Composition b-1)

| | |
|---|---|
| Acryl Based Polymer Latex C-1 (30% solids) | 30.0 g |
| Acryl Based Polymer Latex C-2 (30% solids) | 7.6 g |
| SnO₂ sol | 180 g |

(prepared in such a manner that after heat-concentrating SnO₂ sol synthesized via the method described in Example 1 of Japanese Patent Publication No. 25-6616 to reach a solid concentration of 10% by weight, the pH was adjusted to 10 by the addition of ammonia water)

| | |
|---|---|
| Surface Active Agent (A) | 0.5 g |
| 5% by weight aqueous PVA-613 (PVA produced | 0.4 g |
| by Kuraray Co., Ltd.) solution | |

Distilled water was added to the above to make 1,000 ml, whereby a liquid coating composition was prepared.

(Backing Layer Side Upper Subbing Layer Liquid Coating Composition b-2)

| | |
|---|---|
| Modified Water Based Polyester B-1 (18% by | 145.0 g |
| weight) | |
| Spherical silica matting agent (SEAHOSTER | 0.2 g |
| KE-P50, produced by Nippon Shokubai | |
| Co., Ltd.) | |
| Surface Active Agent (A) | 0.1 g |

Distilled water was added to the above to make 1,000 ml, whereby a liquid coating composition was prepared.

Incidentally, the back coat layer and the back coat layer protective layer, having the following compositions, were applied onto Subbing Layer B-2 of the support onto which the above subbing layer had been applied. 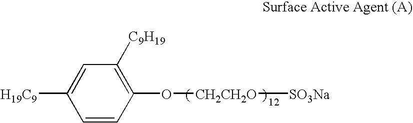
<Preparation of Back Coat Layer Liquid Coating Composition>

While stirring 830 g of methyl ethyl ketone (MEK), 84.2 g of cellulose acetate propionate (CAP482-20, produced by Eastman Chemical Co.) and 4.5 g of a polyester resin (VITTEL PE2200B, produced by Bostic Co.) were added and dissolved. Subsequently, following Infrared Dye 1 was added to the resulting solution to reach the absorbance described in Table 2, and further, 4.5 g of a fluorine based surface active agent (SURFRON KH40, produced by Asahi Glass Co., Ltd.) and 2.3 g of a fluorine based surface active agent (MEGAFAG F120K, produced by Dainippon Ink and Chemicals Inc.), which were dissolved in 43.2 g of methanol, were added and the resulting mixture was vigorously stirred to result in complete dissolution. Subsequently, 2.5 g of oleyl oleate was added, whereby a back coat layer liquid coating composition was prepared. 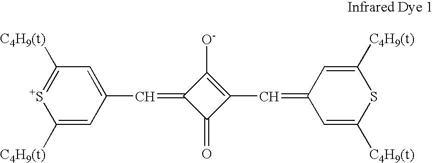
<Preparation of Back Coat Layer Protective Layer (Surface Protective Layer) Liquid Coating Composition>

A back coat layer protective layer liquid coating composition was prepared, in the same manner as the back coat layer liquid coating composition, under the following composition ratio. Silica in MEK at a concentration of 1% was dispersed employing a dissolver type homogenizer, and the resulting dispersion was the last addition.

Infrared Dye 1 (the added amount was regulated to result in the absorbance described in Table 2)

| | | |
|---|---|---|
| Cellulose acetate propionate | 15 | g |
| (10 % MEK solution) | | |
| (CAP482-20, produced by Eastman | | |
| Chemical Co.) | | |
| Infrared Dye 1 (the added amount | | |
| was regulated to result in the | | |
| absorbance described in Table 2 | | |
| Monodispersed silica (average | 0.03 | g |
| particle diameter of 10 pin) | | |
| of a mono-dispersibility of 15% | | |
| (the surface was treated with | | |
| aluminum in an amount of 1% | | |
| with respect to the total silica | | |
| weight) | | |
| C₈F₁₇(CH₂CH₂O)₁₂C₈F₁₇ | 0.075 | g |
| Fluorine Based Surface Active Agent | 0.01 | g |
| (SF-17) | | |
| Fluorine Based Polymer (FM-1) | 0.05 | g |
| Stearic acid | 0.1 | g |
| Butyl stearate | 0.1 | g |
| α-Alumina (at a Mohs hardness of 9) | 0.1 | g |

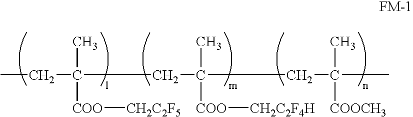

l:m:n=48:17:35 (being a mol ratio),

Tg of 87-97° C.

<Preparation of Photosensitive Silver Halide Grain Emulsion

<Preparation of Photosensitive Silver Halide Grain Emulsion A1>

| | | |
|---|---|---|
| Phenylcarbamoylated gelatin | 88.3 | g |
| 10% Compound (AO-1) aqueous methanol | 10 | ml |
| solution | | |
| Potassium bromide | 0.32 | g |
| Water to make | 5429 | ml |

(B1)

| | | |
|---|---|---|
| 0.67 mol/L aqueous silver nitrate | 2635 | ml |
| solution | | |

(C1)

| | | |
|---|---|---|
| Potassium bromide | 50.69 | g |
| Potassium iodide | 2.66 | g |
| Water to make | 660 | ml |

(D1)

| | | |
|---|---|---|
| Potassium bromide | 151.6 | g |
| Potassium iodide | 7.67 | g |
| Potassium hexachloroiridate(IV): | 0.93 | ml |
| K₂(IrCl₆) (1% aqueous solution) | | |
| Potassium hexacyanoferrate(II) | 0.004 | g |
| Potassium hexachloroosminate(IV) | 0.004 | g |
| Water to make | 1982 | ml |

(E1)

0.4 mo/L aqueous potassium bromide solution
in an amount to achieve the silver potential
described below

(F1)

| | | |
|---|---|---|
| Potassium hydroxide | 0.71 | g |
| Water to make | 20 | ml |

(G1)

| | | |
|---|---|---|
| 56% aqueous acetic acid solution | 18.0 | ml |

(H1)

| | | |
|---|---|---|
| Sodium carbonate anhydride | 1.72 | g |
| Water to make | 151 | ml |

AO-1: HO(CH₂CH₂O)ₙ[CH(CH₃)CH₂O]₁₇(CH₂CH₂O)ₘH (m + n = 5, 6 or 7

While employing the mixing stirrer shown in Japanese Patent Publication No. 58-58288, added to Solution (A1) were a quarter of Solution (B1) and all of Solution (C1) over 4 minutes and 45 seconds, employing a double-jet method, while controlling the temperature to 20° C. and the pAg to 8.09, whereby nuclei were formed. After one minute, all of Solution (F1) was added. During this period, the pAg was appropriately controlled employing (E1). After an elapse of 6 minutes, ¾ of Solution (D1) and all of Solution (D1) were added over 14 minutes and 15 seconds, employing a double-jet method while adjusting the temperature to 20° C. and the pAg to 8.09. After stirring for 5 minutes, the temperature was lowered to 40° C., and all of Solution (G1) was added to form precipitates of the silver halide emulsion. The precipitated portion of a volume of 2,000 ml was allowed to remain and the supernatant was removed. Subsequently, 10 L of water was added. After stirring, the silver halide emulsion was re-precipitated. The precipitated portion of a volume of 1,500 ml was allowed to remain and the supernatant was removed. Subsequently, 10 L of water was added, and after stirring, the silver halide grain emulsion was precipitated. The precipitated portion of a volume of 1,500 was allowed to remain. After removing the supernatant, the precipitates were added to solution (H1) and the resulting mixture was heated to 60° C. and stirred for 120 minutes. Lastly, the pH was adjusted to 5.8, and water was added to result in a volume of 1,161 g per mol of silver, whereby Photosensitive Silver Halide Grain Emulsion A1 was prepared.

The resulting emulsion was composed of monodispersed cubic silver iodobromide grains (at an AgI content ratio of 3.5 mol %) of an average grain diameter of 25 nm, a grain diameter variation coefficient of 12%, and a [100] plane ratio of 92%.

(Preparation of Photosensitive Silver Halide Grain Emulsion A2)

Photosensitive Silver Halide Emulsion A2 was prepared in the same manner as above Photosensitive Silver Halide Emulsion A1, except that after formation of nuclei, all of Solution F1 was added, and thereafter, 40 ml of a 5% aqueous 4-hydroxy-6-methyl-1,3,3a,7-tetraazaindene solution was added.

The grains of the above emulsion were monodispersed cubic silver iodobromide grains (at an AgI content ratio of 3.5 mol %) of an average grain diameter of 25 nm, a grain diameter variation coefficient of 12%, and a [100] plane ratio of 92%.

(Preparation of Photosensitive Silver Halide Grain Emulsion A3)

Photosensitive Silver Halide Grain Emulsion A3 was prepared in the same manner as above Photosensitive Silver Halide Emulsion A1, except that after formation of nuclei, all of Solution F1 was added, and thereafter, 4 ml of a 0.1% following Compound (TPPS) ethanol solution was added.

The grains of the above emulsion were monodispersed cubic silver iodobromide grains (at an AgI content ratio of 3.5 mol %) of an average grain diameter of 25 nm, a grain diameter variation coefficient of 12%, and a [100] plane ratio of 92%. 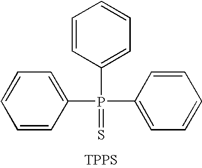
(Preparation of Photosensitive Silver Halide Grain Emulsion B1)

Photosensitive Silver Halide Grain Emulsion B1 was prepared in the same manner as above Photosensitive Silver Halide Grain Emulsion A1, except that the temperature during addition via a double jet method was changed to 45° C. The grains of the above emulsion were monodispersed cubic silver iodobromide grains (at an AgI content ratio of 3.5 mol %) of an average grain diameter of 55 nm, a grain diameter variation coefficient of 12%, and a [100] plane ratio of 92%.

(Preparation of Photosensitive Silver Halide Grain Emulsion B2)

Photosensitive Silver Halide Grain Emulsion B2 was prepared in the same manner as above Photosensitive Silver Halide Grain Emulsion B1, except that after formation of nuclei, all of Solution F1 was added, and thereafter, 4 ml of a 0.1% following Compound (TPPS) ethanol solution was added. The grains of the above emulsion were monodispersed cubic silver iodobromide grains (at an AgI content ratio of 3.5 mol %) of an average grain diameter of 55 nm, a grain diameter variation coefficient of 12%, and a [100] plane ratio of 92%.

<Preparation of Powdered Organic Silver Salts>

At 80° C., 130.8 g of behenic acid, 67.7 g of arachidic acid, 43.6 g of stearic acid, and 2.3 g of palmitic acid were dissolved in 4,720 ml of pure water. Subsequently, after adding 540.2 ml of a 1.5 mol/L potassium hydroxide solution and then 6.9 ml of concentrated nitric acid, the resulting mixture was cooled to 55° C., whereby a fatty acid sodium salt solution was prepared. While maintaining the above fatty acid potassium salt solution at 55° C., Photosensitive Silver Halide Grain Emulsions A1, A2, A3, B1, and B2 (the types and added amounts are listed in Table 2) as well as 450 ml of pure water were added and the resulting mixture was stirred for 5 minutes. Subsequently, 468.4 ml of a 1 mol/L silver nitrate solution was added over 2 minutes, and the resulting mixture was stirred for 10 minutes, whereby an organic silver salt dispersion was prepared. Thereafter, the resulting organic silver salt dispersion was transferred to a water washing vessel. After adding deionized water and stirring, the resulting mixture was set aside to allow the organic silver salt dispersion to float to the top followed by separation, and water-soluble salts at the bottom were removed. Thereafter, washing was repeated employing deionized water until the conductivity of the effluent reached 2 μS/cm. After centrifugal dehydration, the resulting cake-shaped organic silver salts were dried employing an air flow type drier, specifically FLASH JET DRIER (produced by Seishin Enterprise Co., Ltd.) under a nitrogen ambience and operation conditions of a drier heated air flow temperature (65° C. at the inlet and 40° C. at the outlet) until the moisture content reached 0.1%, whereby dried powdered organic silver slats were prepared. The moisture content of the organic silver salt compositions was determined employing an infrared moisture meter.

<Preparation of Preliminary Dispersion>

Dissolved in 1,457 g of MEK was 14.57 g of SO₃K group incorporating polyvinyl butyral (at a Tg of 75° C. incorporating a —SO₃K group of 0.2 millimol/g) as a binder of the photosensitive layer (functioning as the image forming layer). While stirring employing a dissolver DISPERMAT TYPE CA-40M, produced by VMA-GETZMANN Co., 500 g of the above powdered organic silver salts was gradually added and sufficiently mixed, whereby a preliminary dispersion was prepared.

<Preparation of Photosensitive Emulsion Dispersion>

By employing a pump, the preliminary dispersion was fed to a media type homogenizer, DISPERMAT TYPE SL-C12EX (produced by VMA-GETZMANN Co) loaded with 0.5 mm diameter zirconia beads (TORECERUM, produced by Toray Industries, Inc.) by 80% of the inner capacity to result in a retention in the mill for 1.5 minutes and dispersed at a peripheral mill rate of 8 m/second, whereby a photosensitive emulsion dispersion was prepared.

<Preparation of Stabilizer Solution>

A stabilizer solution was prepared by dissolving 1.0 g of Stabilizer 1 and 0.31 g of potassium acetate in 4.97 g of methanol.

<Preparation of Infrared Sensitizing Dye Solution A>

Infrared Sensitizing Dye Solution A was prepared by dissolving 9.6 mg of Infrared Sensitizing Dye 1, 9.6 mg of Infrared Sensitizing Dye 2, 1.488 g of 2-chlorobenzoic acid, 2.779 g of Stabilizer 2, 365 mg of 5-methyl-2-mercaptobenzimidazole in 31.3 ml of MEK in a darkened ambience.

<Preparation of Addition Solution a>

Addition Solution a was prepared by dissolving a reducing agent (the compound and amount described in Table 2), 0.159 g of Yellow Forming Leuco Dye (YA-1) represented by Formula (YB), 0.159 g of Cyan Forming Leuco Dye (CLA-4), 1.54 g of 4-methylphthalic acid, above Infrared Dye 1 (the compound and amount described in Table 2) in 110.0 g of MEK.

<Preparation of Addition Solution b>

Addition Solution b was prepared by dissolving 1.56 g of Antifogging Agent 2, 0.5 g of Antifogging Agent 3, 0.5 g of Antifogging Agent 4, and 0.5 g of Antifogging Agent 5 in 40.9 g of MEK.

<Preparation of Addition Solution c>

Addition Solution c was prepared by dissolving 0.05 g of Silver conservation agent (SE 1-1) in 39.95 g of MEK.

<Preparation of Addition Solution d>

Addition Solution d was prepared by dissolving 0.1 g of Supersensitizer 1 in 9.9 g of MEK.

<Preparation of Addition Solution e>

Addition Solution e was prepared by dissolving 0.5 g of potassium toluenesulfonate and 0.5 g of Antifogging Agent 6, in 9.0 g of MEK.

<Preparation of Addition Solution f>

Addition Solution f was prepared by dissolving 1.0 g of an antifogging agent incorporating vinylsulfone ((CH₂═CH—SO₂CH₂)SO₂CH₂)CHOH) in 9.0 of MEK.

(Preparation of Photosensitive Layer Liquid Coating Composition>

Under an inert gas atmosphere (97% nitrogen), while stirring, 1,000 μl of Chemical Sensitizer S-5 (being a 0.5% methanol solution) was added to 50 g of the above photosensitive emulsion dispersion (described in Table 2) and 15.11 g of MEK, which were maintained at 21° C., After 2 minutes, 390 μl of Antifogging Agent 1 (being a 10% methanol solution) was added and the resulting mixture was stirred for one hour. Further, 494 μl of calcium bromide (being a 10% methanol solution) was added and the resulting mixture was stirred for 10 minutes. Thereafter, added was Gold Sensitizer Au-5 in an amount equivalent to 1/20 mol of the above organic chemical sensitizer, and the resulting mixture was stirred for 20 minutes. Subsequently added was 67 μl of Stabilizer Solution 1 and the resulting mixture was stirred for 10 minutes. Thereafter, 1.32 g of above Infrared Sensitizing Dye A was added and the resulting mixture was stirred for one hour. Subsequently, the temperature was lowered to 13° C. and stirring was carried out for an additional 30 minutes. While maintaining the temperature at 13° C., added were 0.5 g of Addition Solution d, 0.5 g of Addition Solution e, 0.5 g of Addition Solution f, and 13.31 g of Binder 13 employed in Preliminary Dispersion A, and the resulting mixture was stirred for 30 minutes. Thereafter, 1.084 g of tetrachlorophthalic acid (being a 9.4% methanol solution) was added and the resulting mixture was stirred for 15 minutes. While continuing stirring, 12.43 g of Addition Solution a, 1.6 ml of DESMODUR N3300 (aliphatic isocyanate, produced by Mobay Co., being a 10% MEK solution), 4.27 g of Addition Solution b, and 4.0 g of Addition Solution c were successively added while stirring, whereby a photosensitive layer liquid coating composition was prepared.

Chemical structures of the additives employed to prepare each of the liquid coating composition such as a stabilizer solution and photosensitive layer liquid coating compositions are described below.

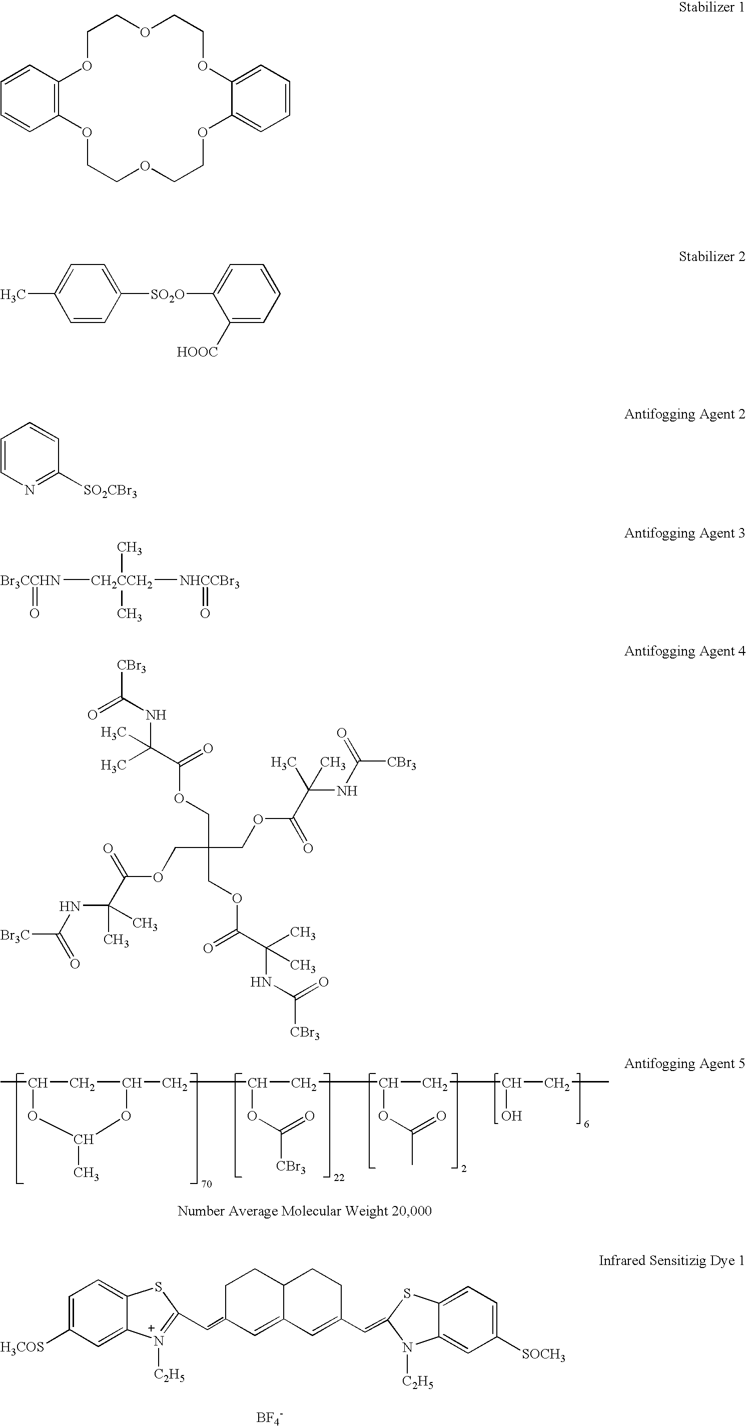

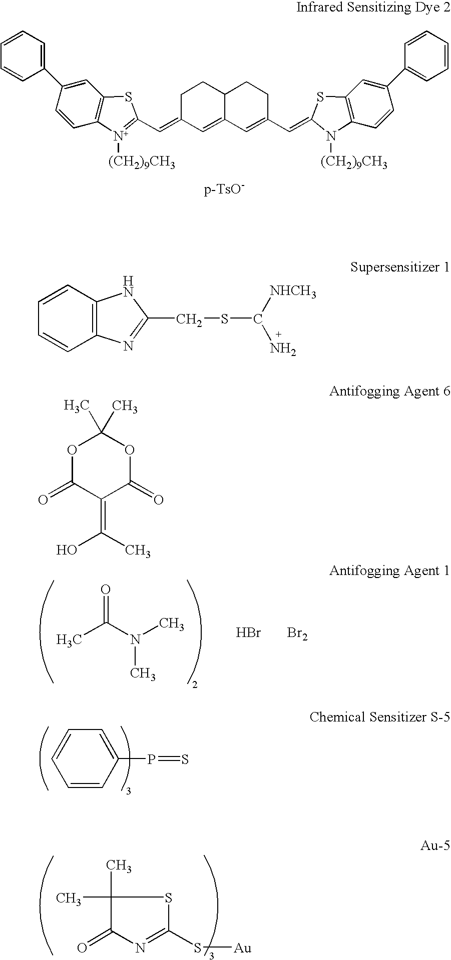

<Preparation of Photosensitive Layer Lower Protective Layer (Surface Protective Layer Lower Layer)

| | |
|---|---|
| Acetone | 5 g |
| MEK | 21 g |
| Cellulose acetate propionate (CAP-141-20 at | 2.3 g |
| a glass transition point Tg of 190° C., | |
| produced by Eastman Chemical Co.) | |
| Methanol | 7 g |
| Infrared Dye 1 | (the added amount was |
| | controlled to result |
| | in the absorbance |
| | listed in Table 1) |
| Phthalazine | 0.25 g |
| CH₂═CHSO₂CH₂CH₂OCH₂CH₂SO₂CH═CH₂ | 0.035 g |
| C₁₂F₂₅(CH₂CH₂O)₁₀C₁₂F₂₅ | 0.01 g |
| Fluorine Based Surface Active Agent (SF-13, | 0.01 g |
| described above) | |
| Stearic acid | 0.1 g |
| Butyl stearate | 0.1 g |
| α-Alumina (at a Mohs hardness of 9) | 0.1 g |

<Preparation of Photosensitive Layer Protective Layer Upper Layer (Surface Protective Layer Upper Layer)>

| | | |
|---|---|---|
| Acetone | 5 | g |
| Methyl ethyl ketone | 21 | g |
| Cellulose acetate propionate (CAP-141-30 at a | 2.3 | g |
| glass transition point Tg of 190° C., | | |
| produced by Eastman Chemical Co.) | | |
| Paraloid A-21 (produced by Rohm and Haas Co.) | 0.08 | g |
| Infrared Dye 1 (the addition amount was controlled | | |
| to result in absorbance described in Table 1) | | |
| Benzotriazole | 0.03 | g |
| Methanol | 7 | g |
| Phthalazine | 0.25 | g |
| Monodispersed silica of a monodispersibility | 0.140 | g |
| of 15% (at an average particle diameter | | |
| of 3 μm) (the surface treatment was | | |
| carried out employing 1% by weight | | |
| aluminum with respect to the total | | |
| silica weight) | | |
| CH₂═CHSO₂CH₂CH₂CH₂OCH₂CH₂SO₂CH═CH₂ | 0.035 | g |
| C₁₄F₂₅(CH₂CH₂O)₁₀C₁₂F₂₅ | 0.01 | g |
| Fluorine Based surface Active Agent (SF-17, | 0.0005 | g |
| described above) | | |
| Fluorine Based Polymer (FM-1, described | 0.01 | g |
| above) | | |
| Stearic acid | 0.1 | g |
| Butyl stearate | 0.1 | g |
| α-Alumina (at a Mohs hardness of 9) | 0.1 | g |

Further, the photosensitive layer protective layer upper layer and lower layer were prepared under the above composition ratio in the same manner as the back coat layer liquid coating composition. Silica was dispersed in the same manner as in the back coat layer protective layer at a concentration of 1% in MEK, added lastly and stirred, whereby a photosensitive layer protective layer upper layer and lower layer liquid coating compositions were prepared.

<Preparation of Silver Salt Photothermographic Dry Imaging Materials>

The back coat layer liquid coating composition and the back coat layer protective layer liquid coating composition, prepared as above, were applied onto Subbing Layer Upper Layer B-2 at a coating rate of 50 m/minute to result in a dried layer thickness of each of 1.5 μm, employing an extrusion coater. Drying was carried out over 5 minutes, employing a drying air flow of a drying temperature of 100° C. and a dew point of 10° C.

The above photosensitive layer liquid coating composition and photosensitive layer protective layer (being the surface protective layer) liquid coating composition were simultaneously applied onto Upper Subbing Layer A-2 at a coating rate of 50 m/minute, employing an extrusion coater, whereby Photosensitive Material Samples 101-128 were prepared. Coating was carried out to result in a dried photosensitive layer thickness of 10.5 μm, and a dried photosensitive layer protective layer (being the surface protective layer) thickness of 3.0 μm (the surface protective layer upper layer thickness of 1.5 μm and the surface protective layer lower layer thickness of 1.5 μm). Thereafter, drying was carried out for 10 minutes employing a drying air flow at a drying temperature of 75° C. and a dew point of 10° C.

The pH and Bekk smoothness of the layer surface on the photosensitive layer side of the resulting photothermographic materials (Sample 123) were 5.3 and 6,000 seconds, respectively while the pH and Bekk smoothness on the surface of the back coat layer were 5.5 and 9,000 seconds, respectively. Further, determination of the surface roughness of each of Samples 101-128 resulted in Rz(E)/Rz(B)=0.40 and Rz(E)=1.4 μm. Further, Rz(B), Ra(E), and Ra(B) were 3.5 μm, 0.09 μm, and 0.12 μm, respectively. With regard to Samples 101-127, a wavelength 420 nm absorption peak was noticed due to yellow forming leuco dyes. Further, with regard to Samples 101-127, a wavelength 420 nm absorption peak was noticed due to cyan forming leuco dyes.

Sample 118 was prepared in the same manner as Sample 102, except that during preparation of Powdered Organic Silver Salt A, 130.8 g of behenic acid, 67.7 g of arachidic acid, 43.6 g of stearic acid, and 2.3 g of palmitic acid were replaced with 259.4 g of behenic acid and 0.5 g of arachidic acid.

Sample 119 was prepared in the same manner as Sample 102, except that Fluorine Based Surface Active Agent SE-17 in the back coat layer protective layer and the photosensitive layer protective layer of Sample 102 were replaced with C₈F₁₇SO₃Li.

Sample 120 was prepared in the same manner as Sample 102, except that dried layer thickness 10.5 μm of the photosensitive layer of Sample 102 was varied to 14.0 μm.

Sample 121 was prepared in the same manner as Sample 102, except that the 10.5 μm dried layer thickness of the photosensitive layer of Sample 102 was changed to 17.0 μm.

<Exposure and Photographic Processing>

Each of Photothermographic Material Samples 101-128, prepared as above, was cut to 34.5 cm×43.0 cm sheets and subsequently was packaged employing packaging materials under an ambience of 25° C. and 50% relative humidity, followed by storage at normal temperature for two weeks. The following evaluation was then carried out.

(Wrapping Materials)

Employed were a barrier bag of PET 10 μm/PET 12 μm/aluminum foil 9 μm/Ny 15 μm/polyethylene 50 μm incorporating 3% carbon, exhibiting an oxygen permeability of 0.02 ml/m² per day at 25° C. and 1.013×155 Pa, and a moisture permeability of 0.001 g/m² per day at 40° C. and 90% relative humidity (based on the Cup Method of JIS Z 0208) and a paper tray.

(Evaluation of Samples)

<Exposure and Photographic Processing>

Each of Photothermographic Dry Imaging Material Samples 101-127, prepared as above, was cut to 34.5 cm×43.0 cm sheets. Subsequently, each sample sheet was subjected to heat development at the same time of exposure (51, 52, and 53 in FIG. 1 was set at 100° C., 123° C., and 123° C., respectively, and the sheet was conveyed to come into contact with 51, 52, and 53 for 2 seconds, 2 seconds, and 6 seconds for a total of 10 seconds, respectively) employing a thermal processor (loaded with a 810 nm semiconductor laser of a maximum output of 50 mW, and of a footprint of 0.35 m²). As used herein, “was subjected to heat development at the same time of exposure” means that a photosensitive sheet composed of silver salt photothermographic dry imaging materials was partially exposed and the partially exposed portion was immediately developed. The distance between the exposure section and the development section was 12 cm and the linear conveyance ate during the above development was 30 mm/second. During the above processing, the conveyance rate from the photosensitive material feeding unit to the image exposure unit, the conveyance rate to the image exposure section, and the conveyance rate to the image development section were each controlled to 30 mm/second. The position of the bottom plane of the photosensitive material stock tray position at the lowest level was 45 cm from the floor surface. Time required for heat development (the time from the pick-up of a photosensitive material to its discharge) was 45 seconds (during continuous processing, the interval of heat development was 4 seconds). Exposure was carried out stepwise in such a manner that the exposure energy amount was reduced by 0.05 in terms of logE. Sample 128 was exposed and thermally developed in the same manner as Sample 102, except that the conveying rate from the photosensitive material feeding unit to the image exposure unit, the conveyance rate to the image exposure section, and the conveyance rate to the image development section were each controlled to be 60 mm/second instead of 30 mm/second.

<<Evaluation of Image Quality>>

Under each of 23° C., 30% relative humidity, 23° C., 70% relative humidity, 30° C., 30% relative humidity, and 30° C., 70% relative humidity, a photosensitive material was placed in a thermal processor in which a cycloolefin resin lens was employed as a resin lens, the degree of sealing of scanning exposure section 55 was 70%, moisture controlling agent 559 was not used, and the surface of film F to be heated was a non-photosensitive surface. After three hours, a chest diagnostic image (being an image sample prepared employing a chest phantom) was outputted. The resulting image was visually observed and the general evaluation of sharpness, graininess, and density stability was made based on the following criteria in a 0.5 grade difference. Table 2 shows the results.

The degree of sealing was defined as (1−area of aperture/surface area of case 550 when assuming that an aperture is absent)×100 (%).

<Criteria of General Evaluation of Image Quality (Sharpness, Graininess, and Density Stability)>

5: sharpness and graininess are excellent, and image quality is optimal for a medical diagnostic image
4: sharpness and graininess meet the targeted quality, and image quality is acceptable for a medical diagnostic image
3: sharpness and graininess are slightly degraded, but density is stable, resulting in no problems for medical diagnosis
2: unsharpness is noted, and granular appearance of the image is also noted, resulting in some problem for diagnosis
1: unsharpness and granular appearance are marked and the image quality results in difficulty for diagnosis

Needless to say, it is preferable that the image quality performance receives high evaluation. It is also preferable that under any outputting ambience, high evaluation is constantly obtained.

<<Average Gradient Ga Values>>

The density of each of the resulting sensitometry samples was determined employing PDM65 TRANSMISSION DENSITOMETER (produced by Konica Corp.), and density measurement results were processed employing a computer, whereby a characteristic curve was made. Based on the resulting characteristic curve, the average gradient Ga value between an optical density of 0.25-2.5 was obtained. Table 2 shows the results.

<<Density Variation Due to Humidity Variation>>

After rehumidifying a sample at 25° C. and 40% relative humidity over 24 hours, the resulting sample was subjected heat development at 25° C. and 40% relative humidity which were the same conditions employed for the image quality evaluation, and the maximum density was determined. On the other hand, after rehumidifying a sample at 40° C. and 90% relative humidity for 24 hours, the resulting sample was subjected to heat development at 40° C. and 90% relative humidity which were the same conditions employed for the image quality evaluation, and the maximum density was also determined. Subsequently, the difference (ΔDmax) between the former maximum density and the latter maximum density was calculated. Table 2 shows the results.

<<Absorbance>>

(Total Absorbance of All Layers on Photosensitive Layer Side)

A photosensitive material, in which the layers on the reverse surface side had been removed, was placed in a cell loading position of a spectrophotometer (U-3410, produced by Hitachi Ltd.) so that the photosensitive emulsion surface faced the light source (perpendicular to the incident light), and the absorption value at wavelength 810 nm, which had been subjected to reduction of the absorption value due to the support, namely absorbance, was determined. Light which was transmitted through the photosensitive material was captured by an integrating sphere (of an aperture area of 20 mm×15 mm) which was arranged approximately 12 cm from the photosensitive material and focused onto the photomultiplier tube.

(Total Absorbance of All Layers on the Back Coat Layer Side)

A photosensitive material, in which the layers on the reverse surface side had been removed, was placed in a cell loading position of a spectrophotometer (U-3410, produced by Hitachi Ltd.) so that the back coat surface faced the light source (perpendicular to the incident light), and the absorption value at wavelength 810 nm, which had been subjected to reduction of the absorption value due to the support, namely absorbance, was determined. Light which was transmitted through the back coat layer was captured by an integrating sphere (of an aperture area of 20 mm×15 mm) which was arranged approximately 12 cm from the back coat layer and focused onto the photomultiplier tube. Table 2 shows the results.

Table 2 shows the results.

TABLE 2

| | | | | | | Dye in | | Absorbance | Type and |
|---|---|---|---|---|---|---|---|---|---|
| | Powdered | | | | Dye in | Back Coat | | of All | Amount (g) of |
| | Organic Silver | Dye in | | | Back | Layer | | Layers on | Reducing Agent |
| Sample | Salt* | Photosensitive | | | Coat | protective | | Back Coat | Represented by |
| No. | *1 | Layer | *2 | *3 | Layer | Layer | *4 | Layer Side | Formula (RD1) |
| 101 | A2/B2 = 36.2/9.1 | Yes | No | No | Yes | No | 0.50 | 0.70 | (1-1) = 27.98 |
| 102 | A3/B2 = 36.2/9.1 | Yes | No | No | Yes | No | 0.50 | 0.70 | (1-1) = 27.98 |
| 103 | A3/B2 = 36.2/9.1 | Yes | No | No | Yes | No | 0.50 | 0.70 | (1-3) = 27.98 |
| 104 | A3/B2 = 36.2/9.1 | Yes | No | No | Yes | No | 0.50 | 0.70 | (1-10) = 27.98 |
| 105 | A3/B2 = 36.2/9.1 | Yes | No | No | Yes | No | 0.50 | 0.70 | (1-13) = 27.98 |
| 106 | A3/B2 = 36.2/9.1 | Yes | No | No | Yes | No | 0.50 | 0.70 | (1-20) = 27.98 |
| 107 | A3/B2 = 36.2/9.1 | Yes | No | No | Yes | No | 0.50 | 0.70 | (1-21) = 27.98 |
| 108 | A3/B2 = 36.2/9.1 | Yes | No | No | Yes | No | 0.50 | 0.70 | (1-40) = 27.98 |
| 109 | A3/B2 = 36.2/9.1 | Yes | No | No | Yes | No | 0.50 | 0.70 | (1-46) = 27.98 |
| 110 | A3/B2 = 36.2/9.1 | Yes | No | No | Yes | No | 0.40 | 1.00 | (1-1) = 27.98 |
| 111 | A3/B2 = 36.2/9.1 | Yes | No | No | Yes | No | 0.40 | 1.20 | (1-1) = 27.98 |
| 112 | A3/B2 = 36.2/9.1 | Yes | No | No | Yes | No | 0.30 | 1.50 | (1-1) = 27.98 |
| 113 | A3/B2 = 36.2/9.1 | Yes | No | No | Yes | No | 0.80 | 0.40 | (1-1) = 27.98 |

| | | | | | | Density | |
|---|---|---|---|---|---|---|---|
| | Image Quality (General Evaluation of Sharpness, | | | | | Variation due | |
| Sample | Graininess, and Density Stability) | | | | Average | to Temperature | |
| No. | 25° C. 70% RH | 25° C. 30% RH | 30° C. 70% RH | 30° C. 30% RH | Gradient Ga | Variation | Remarks |
| 101 | 5.0 | 5.0 | 5.0 | 5.0 | 4.0 | 0.1 | Inv. |
| 102 | 5.0 | 5.0 | 5.0 | 5.0 | 4.0 | 0.1 | Inv. |
| 103 | 5.0 | 5.0 | 5.0 | 5.0 | 4.1 | 0.1 | Inv. |
| 104 | 5.0 | 5.0 | 5.0 | 5.0 | 4.1 | 0.1 | Inv. |
| 105 | 5.0 | 5.0 | 5.0 | 5.0 | 4.0 | 0.1 | Inv. |
| 106 | 5.0 | 5.0 | 5.0 | 5.0 | 4.1 | 0.1 | Inv. |
| 107 | 5.0 | 5.0 | 5.0 | 5.0 | 4.1 | 0.1 | Inv. |
| 108 | 5.0 | 5.0 | 5.0 | 5.0 | 6.5 | 0.1 | Inv. |
| 109 | 4.5 | 4.5 | 4.5 | 4.5 | 4.0 | 0.3 | Inv. |
| 110 | 5.0 | 5.0 | 5.0 | 5.0 | 4.0 | 0.1 | Inv. |
| 111 | 5.0 | 5.0 | 4.5 | 4.5 | 4.0 | 0.1 | Inv. |
| 112 | 4.5 | 5.0 | 4.5 | 5.0 | 4.0 | 0.1 | Inv. |
| 113 | 5.0 | 5.0 | 5.0 | 5.0 | 4.0 | 0.1 | Inv. |

| | | | | | | Dye in | | Absorbance | Type and |
|---|---|---|---|---|---|---|---|---|---|
| | Powdered | | | | Dye in | Back Coat | | of All | Amount (g) of |
| | Organic Silver | Dye in | | | Back | Layer | | Layers on | Reducing Agent |
| Sample | Salt* | Photosensitive | | | Coat | protective | | Back Coat | Represented by |
| No. | *1 | Layer | *2 | *3 | Layer | Layer | *4 | Layer Side | Formula (RD1) |
| 114 | A3/B2 = 36.2/9.1 | Yes | No | No | Yes | No | 1.00 | 0.20 | (1-1) = 27.98 |
| 115 | A3/B2 = 36.2/9.1 | No | Yes | No | Yes | No | 0.50 | 0.70 | (1-1) = 27.98 |
| 116 | A3/B2 = 36.2/9.1 | No | No | Yes | Yes | No | 0.50 | 0.70 | (1-1) = 27.98 |
| 117 | A3/B2 = 36.2/9.1 | Yes | No | No | No | Yes | 0.50 | 0.70 | (1-1) = 27.98 |
| 118 | A3/B2 = 36.2/9.1 | Yes | No | No | Yes | No | 0.50 | 0.70 | (1-1) = 27.98 |
| 119 | A3/B2 = 36.2/9.1 | Yes | No | No | Yes | No | 0.50 | 0.70 | (1-1) = 27.98 |
| 120 | A3/B2 = 36.2/9.1 | Yes | No | No | Yes | No | 0.50 | 0.70 | (1-1) = 27.98 |
| 121 | A3/B2 = 36.2/9.1 | Yes | No | No | Yes | No | 0.50 | 0.70 | (1-1) = 27.98 |
| 122 | A1/B1 = 36.2/9.1 | Yes | No | No | Yes | No | 0.50 | 0.70 | (1-1) = 27.98 |
| 123 | A1/B1 = 36.2/9.1 | Yes | No | No | Yes | No | 0.50 | 0.70 | (2-1) = 27.98 |
| 124 | A1/B1 = 36.2/9.1 | Yes | No | No | Yes | No | 0.20 | 0.70 | (2-1) = 27.98 |
| 125 | A1/B1 = 36.2/9.1 | Yes | No | No | Yes | No | 1.10 | 0.70 | (2-1) = 27.98 |
| 126 | A1/B1 = 36.2/9.1 | Yes | No | No | Yes | No | 0.50 | 0.10 | (2-1) = 27.98 |
| 127 | A1/B1 = 36.2/9.1 | Yes | No | No | Yes | No | 0.50 | 1.60 | (2-1) = 27.98 |
| 128 | A3/B2 = 36.2/9.1 | Yes | No | No | Yes | No | 0.50 | 0.70 | (1-1) = 27.98 |

| | | | | | | Density | |
|---|---|---|---|---|---|---|---|
| | Image Quality (General Evaluation of Sharpness, | | | | | Variation due | |
| Sample | Graininess, and Density Stability) | | | | Average | to Temperature | |
| No. | 25° C. 70% RH | 25° C. 30% RH | 30° C. 70% RH | 30° C. 30% RH | Gradient Ga | Variation | Remarks |
| 114 | 4.5 | 5.0 | 4.5 | 4.5 | 4.0 | 0.1 | Inv. |
| 115 | 4.0 | 4.0 | 4.0 | 4.0 | 4.0 | 0.1 | Inv. |
| 116 | 4.0 | 4.0 | 4.0 | 4.0 | 4.0 | 0.1 | Inv. |
| 117 | 4.0 | 4.0 | 4.0 | 4.0 | 4.0 | 0.1 | Inv. |
| 118 | 5.0 | 5.0 | 5.0 | 5.0 | 3.9 | 0.0 | Inv. |
| 119 | 5.0 | 5.0 | 4.5 | 4.5 | 4.0 | 0.2 | Inv. |
| 120 | 5.0 | 5.0 | 5.0 | 5.0 | 4.0 | 0.1 | Inv. |
| 121 | 4.5 | 4.5 | 4.5 | 4.5 | 4.1 | 0.3 | Inv. |
| 122 | 4.5 | 4.5 | 4.5 | 4.5 | 3.9 | 0.1 | Inv. |
| 123 | 3.5 | 3.5 | 3.5 | 3.5 | 3.6 | 0.6 | Inv. |
| 124 | 2.0 | 2.5 | 1.5 | 2.0 | 3.6 | 1.1 | Comp. |
| 125 | 2.5 | 2.5 | 2.0 | 2.0 | 3.6 | 1.2 | Comp. |
| 126 | 1.5 | 1.5 | 2.0 | 2.0 | 3.6 | 1.2 | Comp. |
| 127 | 2.5 | 2.5 | 2.0 | 2.5 | 3.6 | 1.1 | Comp. |
| 128 | 5.0 | 5.0 | 5.0 | 5.0 | 4.0 | 0.1 | Inv. |

*Powdered Organic Silver Salt (the powdered organic silver salt was dispersed into a mixture of MEK and a binder (SO₃K group incorporating polyvinyl butyral) to prepare a preliminary dispersion, which was further dispersed to prepare a photosensitive emulsion dispersion)
*1: Type and Amount (g) of Photosensitive Silver Halide Emulsion
*2: Dye in Photosensitive Layer Lower Protective Layer
*3: Dye in Photosensitive Layer Upper Protective Layer
*4: Absorbance of All Layers on Photosensitive Layer Side
Inv.: Present Invention,
Comp.: Comparative Example

As Table 2 shows, by controlling, within the range of the present invention, the absorbance of the photosensitive layer side and the back coat layer side via incorporation of radiation absorbing compounds, high quality images were obtained which resulted in minimal density variation even when ambient humidity varied, even in the cases in which resin lenses were employed in the exposure system.

Further, improved effects were pronounced by employing, as a reducing agent, the highly active reducing agents represented by Formula (RD1).

Further, in the case of Sample 102, the paper tray was modified to a raised bottom structure and silica gel was sealed in the vacant space formed in the bottom of the tray. When the above silica gel incorporating paper tray was employed, density variation due to moisture variation became 0.0, whereby improved effects were realized.

### Example 2

<<Preparation of Subbed Photographic Supports>>

Supports were prepared in the same manner as Example 1.

<Preparation of Back Coat Layer Liquid Coating Composition>

While stirring 830 g of methyl ethyl ketone (MEK), 84.2 g of cellulose acetate propionate (CAP482-20, produced by Eastman Chemical Co.) and 4.5 g of a polyester resin (VITTEL PE2200B, produced by Bostic Co.) were added and dissolved. Subsequently, following Yellow Dye 1 was added to the resulting solution (the added amount was controlled to realize the absorbance listed in Table 3) and further, 4.5 g of a fluorine based surface active agent (SURFRON KH40, produced by Asahi Glass Co., Ltd.) and 2.3 g of a fluorine based surface active agent (MEGAFAG F120K, produced by Dainippon Ink and Chemicals, Inc.), which were dissolved in 43.2 g of methanol, were added and the resulting mixture was vigorously stirred to result in complete dissolution. Subsequently, 2.5 g of oleyl oleate was added. Lastly, 75 g of silica (at an average particle diameter pf 10 μm) which was dispersed into MEK at a concentration of 1%, employing a dissolver type homogenizer, was added while stirring, whereby a back coat layer liquid coating composition was prepared. 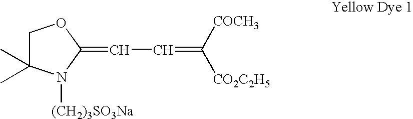
<Preparation of Back Coat Layer Protective Layer (Surface Protective Layer) Liquid Coating Composition>

A back coat layer protective layer liquid coating composition was prepared in the same manner as the back coat layer liquid coating composition under the following composition ratio. Silica was dispersed employing a dissolver type homogenizer.

| | | |
|---|---|---|
| Cellulose acetate propionate (10% MEK solu- | 15 | g |
| tion ) (CAP482-20, produced by Eastman | | |
| Chemical Co.) | | |
| Yellow Dye 1 | | |
| (the added amount was regulated to | | |
| result in the absorbance listed in | | |
| Table 3) | | |
| Monodispersed silica (average particle | 0.03 | g |
| diameter of 10 μm) of a monodispersibility | | |
| of 15% (the surface was | | |
| treated with aluminum in an amount of | | |
| 1% with respect to the total silica | | |
| weight) | | |
| C₈F₁₇(CH₂CH₂O)₁₂C₈F₁₇ | 0.05 | g |
| Fluorine Based Surface Active Agent (SF-17) | 0.01 | g |
| Fluorine Based Polymer (FM-1) | 0.05 | g |
| Stearic acid | 0.1 | g |
| Butyl stearate | 0.1 | g |
| α-Alumina (at a Mohs hardness of 9) | 0.1 | g |

<Preparation of Photosensitive Silver Halide Grain Emulsion A1>

Preparation was the same as Photosensitive Silver Halide Grain Emulsion A1 in Example 1.

<Preparation of Photosensitive Silver Halide Grain Emulsion B1>

Preparation was the same as Photosensitive Silver Halide Grain Emulsion B1 in Example 1.

<Preparation of Photosensitive Silver Halide Emulsion C>

Photosensitive Silver Halide Emulsion C was prepared in the same manner as Photosensitive Silver Halide Grain Emulsion A1, except that potassium bromide employed during preparation of Photosensitive Silver Halide Grain Emulsion A1 was replaced with potassium iodide. Grains in the above emulsion were monodispersed pure silver iodide grains of an average grain diameter of 25 nm, a grain diameter variation coefficient of 12%, and a [100] plane ratio of 92%.

<Preparation of Photosensitive Silver Halide Grain Emulsion D>

Photosensitive Silver Halide Grain Emulsion D was prepared in the same manner as Photosensitive Silver Halide Grain Emulsion A1, except that some of potassium bromide employed during preparation of Photosensitive Silver Halide Grain Emulsion A1 was replaced with potassium iodide to result in a silver iodide incorporating ratio of 90 mol %. Grains in the above emulsion were monodispersed silver iodobromide grains of an average grain diameter of 25 nm, a grain diameter variation coefficient of 12%, and a [100] plane ratio of 92% (the silver iodide incorporating ratio was 90 mol %).

<Preparation of Photosensitive Silver Halide Grain Emulsion E>

Photosensitive Silver Halide Grain Emulsion E was prepared in the same manner as Photosensitive Silver Halide Emulsion C, except that the temperature during addition employing the double-jet method was changed to 45° C. Grains in the above emulsion were monodispersed pure silver iodide grains of an average grain diameter of 55 nm, a grain diameter variation coefficient of 12%, and a [100] plane ratio of 92%.

<Preparation of Photosensitive Silver Halide Grain Emulsion F>

Photosensitive Silver Halide Grain Emulsion F was prepared in the same manner as Photosensitive Silver Halide Emulsion D, except that the temperature during addition, employing the double-jet method, was changed to 45° C. Grains in the above emulsion were monodispersed silver iodobromide grains of an average grain diameter of 55 nm, a grain diameter variation coefficient of 12%, and a [100] plane ratio of 92% (the silver iodide incorporating ratio was 90 mol %).

<Preparation of Photosensitive Silver Halide Grain Emulsion G>

Photosensitive Silver Halide Grain Emulsion G was prepared in the same manner as Photosensitive Silver Halide Emulsion C, except that after formation of nuclei, all of Solution F1 was added, and subsequently 4 ml of 0.1% above compound (TPPS) ethanol solution was added.

Further, grains in the above emulsion were monodispersed pure silver iodide grains of an average grain diameter of 25 nm, a grain diameter variation coefficient of 12%, and a [100] plane ratio of 92%.

<Preparation of Photosensitive Silver Halide Grain Emulsion H>

Photosensitive Silver Halide Grain Emulsion H was prepared in the same manner as above Photosensitive Silver Halide Grain Emulsion E, except that after formation of nuclei, all of Solution F1 was added, and subsequently 4 ml of 0.1% above compound (TPPS) ethanol solution was added.

Grains in the above emulsion were monodispersed pure silver iodide grains of an average grain diameter of 55 nm, a grain diameter variation coefficient of 12%, and a [100] plane ratio of 92%.

<Preparation of Powdered Organic Silver Salts>

At 80° C., 130.8 g of behenic acid, 67.7 g of arachidic acid, 43.6 g of stearic acid, and 2.3 g of palmitic acid were dissolved in 4,720 ml of pure water. Subsequently, after adding 540.2 ml of a 1.5 mo/L potassium hydroxide solution and then 6.9 ml of concentrated nitric acid, the resulting mixture was cooled to 55° C., whereby a fatty acid sodium salt solution was prepared. While maintaining the above fatty acid sodium salt solution at 55° C., Photosensitive Silver Halide Grain Emulsions A1, B1, C, D, E, F, G, and H (types and added amounts are listed in Table 2), as well as 450 ml of pure water were added and the resulting mixture was stirred for 5 minutes. Subsequently, 468.4 ml of a 1 mol/L silver nitrate solution was added over 2 minutes, and the resulting mixture was stirred for 10 minutes, whereby an organic silver salt dispersion was prepared. Thereafter, the resulting organic silver salt dispersion was transferred to a water washing vessel. After adding deionized water and stirring, the resulting mixture was set aside to allow to float the organic silver salt dispersion followed by separation, and water-soluble salts in the bottom were removed. Thereafter, washing was repeated employing deionized water until the conductivity of the effluent reached 2 μS/cm. After centrifugal dehydration, the resulting cake-shaped organic silver salts were dried employing an air flow type drier, FLASH JET DRIER (produced by Seishin Enterprise Co., Ltd.) under a nitrogen ambience and operation conditions of a drier heated air flow (65° C. at the inlet and 40° C. at the outlet) until the moisture content reached 0.1%, whereby dried powdered organic silver salts were prepared. The moisture content of organic silver salt compositions was determined employing an infrared moisture meter.

<Preparation of Preliminary Dispersion>

Each of the preliminary dispersions was prepared in the same manner as in Example 1, except that the powdered organic silver salt was replaced with the powdered silver salt as prepared as above.

<Preparation of Photosensitive Emulsion Dispersion>

By employing a pump, the preliminary dispersion was fed to a media type homogenizer, DISPERMAT TYPE SL-C12EX (produced by VMA-GETZMANN Co.) loaded with 0.5 mm diameter zirconia beads (TORECERUM, produced by Toray Co.) to 80% of the inner capacity to result in a retention in the mill of 1.5 minutes and dispersed at a peripheral rate of 8 m/second, whereby a photosensitive emulsion dispersion was prepared.

<Preparation of Stabilizer Solution>

A stabilizer solution was prepared by dissolving 1.0 g of Stabilizer 1 and 0.31 g of potassium acetate in 4.97 g of methanol.

<Preparation of 2-Chlorobenzoic Acid Solution>

A 2-chlorobenzoic acid solution was prepared by dissolving 1.488 g of 2-chlorobenzoic acid, 2.779 g of Stabilizer 2, and 365 mg of 5-methyl-2-mercaptobenzimidazole in 31.3 ml of MEK in a darkened place.

<Preparation of Addition Solution a>

Addition Solution a was prepared by dissolving a reducing agent (the compound and amount listed in Table 3), 0.159 g of Yellow Forming Leuco Dye (YA-1), 0.159 g of Cyan Forming Leuco Dye (CLA-4), above Yellow Dye 1 (the added amount was controlled to realize the absorbance listed in Table 3), and 1.54 g of 4-methylphthalic acid, in 110.0 g of MEK.

<Preparation of Addition Solution b>

Addition Solution b was prepared by dissolving 1.56 g of Antifogging Agent 2, 0.5 g of Antifogging Agent 3, 0.5 g of Antifogging Agent 4, 0.5 g of Antifogging Agent 5, and 3.43 g of phthalazine, in 40.9 g of MEK.

<Preparation of Addition Solution c>

Addition Solution c was prepared by dissolving 0.05 g of Silver Conservation Agent (SE 2-2) in 39.95 g of MEK.

<Preparation of Addition Solution d>

Addition Solution d was prepared by dissolving 0.5 g of potassium p-toluenethiosulfonate and 0.5 g of Antifogging Agent 6 in 9.0 g of MEK.

<Preparation of Addition Solution e>

Addition Solution e was prepared by dissolving 1.0 g of vinylsulfone ((CH₂═CH—SO₂CH₂)₂CHOH) in 9.0 g of MEK.

Under an inert gas atmosphere (97% nitrogen), while stirring, 50 g of the above photosensitive emulsion dispersion (listed in Table 3) and 15.11 g of MEK were maintained at 21° C., and 1,000 μl of Chemical Sensitizer S-5 (being a 0.5% menthol solution) was added. After two minutes, Antifogging Agent 1 (being a 10% methanol solution) was added and stirring was carried out for one hour. Further, 494 μl of calcium bromide (being a 10% methanol solution) was added and stirring was carried out for 10 minutes. Thereafter, Gold Sensitizer Au-5 in an amount equivalent to 1/20 mol of the above organic chemical sensitizer was added and stirring was carried out for 20 minutes. Subsequently, 67 μl of Stabilizer Solution 1 was added and stirring was carried out for 10 minutes. Thereafter, 1.32 g of the above 2-chlorobenzoic acid solution was added and stirring was carried out for one hour. Thereafter, the temperature was lowered to 13° C., and stirring was further carried out for 30 minutes. While maintaining at 13° C., 0.5 g of Addition Solution d, 0.5 g of Addition Solution e, and 13.31 g of the binder employed in the preliminary dispersion were added and stirring was carried out for 30 minutes. Thereafter, 1.084 g of tetrachlorophthalic acid (being a 9.4% MEK solution) was added and stirring was carried out for 15 minutes. Further, while stirring, 12.43 g of Addition Solution a, 1.6 ml of a 10% DESMODUR N3300 (aliphatic isocyanate, produced by Mobay Co.) MEK solution, and 1.0 g of Addition Solution c were successively added, whereby a photosensitive layer liquid coating composition was prepared.

<Preparation of Photosensitive Layer Lower Protective Layer (Lower Surface Protective Layer)>

Added to a mixture of 500 g of acetone, 2,100 g of MEK, and 700 g of methanol was 230 g of cellulose acetate butyrate (CAB-171-15S, produced by Eastman Chemical Co.), and dissolved while stirred via a dissolver. Subsequently, while stirring, 25 g of phthalazine, above Yellow Dye 1 (the addition amount was controlled to realize the absorbance listed in Table 3), 3.5 g of CH₂═CHSO₂CHCH₂OCH₂CH₂SO₂CH═CH₂, 1 g of C₁₂F₂₅(CH₂CH₂O)₁₀C₁₂F₂₅, 1 g of Compound SF-17, represented by Formula (SF), and 10 g of butyl stearate were added and dissolved, whereby a photosensitive layer Lower Protective Layer Liquid Coating Composition was prepared.

<Preparation of Photosensitive Layer Upper Protective-Layer (Upper Surface Protective Layer)>

Added to a mixture of 500 g of acetone, 2,100 g of MEK, and 700 g of methanol was 230 g of cellulose acetate butyrate (CAB-171-15S, produced by Eastman Chemical Co.), and dissolved while stirred via a dissolver. Subsequently, while stirring, 25 g of phthalazine, above Yellow Dye 1 (the addition amount was controlled to realize the absorbance listed in Table 3), 3.5 g of CH₂═CHSO₂CHCH₂OCH₂CH₂SO₂CH═CH₂, 1 g of C₁₂F₂₅(CH₂CH₂O)₁₀C₁₂F₂₅, 0.5 g of Compound SF-17, represented by Formula (SF), 1.0 g of above Fluorine Based Polymer (FM-1), 110 g of stearic acid, and 10 g of butyl stearate were added and dissolved.

Lastly, 280 g of monodispersed silica of a mono-dispersibility of 15% which had been dispersed into MEK at a concentration of 5%, employing a dissolver type homogenizer (of an average particle size of 10.0 μm, in which the surface was treated via 1% aluminum with respect to the total silica weight) was added while stirring, whereby a photosensitive layer upper protective layer liquid coating composition was prepared.

<Preparation of Silver Salt Photothermographic Dry Imaging Materials>

The back coat layer liquid coating composition and the back coat layer protective layer liquid coating composition, prepared as above, were applied onto Subbing Layer Upper Layer B-2 at a coating rate of 50 m/minute to result in each of the dried layer thickness of 3.5 μm, employing an extrusion coater. Drying was carried out over 5 minutes, employing a drying air flow of a drying temperature of 100° C. and a dew point of 10° C.

The above photosensitive layer liquid coating composition and photosensitive layer protective layer (being the surface protective layer) liquid coating composition were simultaneously applied onto Upper Subbing Layer A-2 at a coating rate of 50 m/minute, employing an extrusion coater, whereby Photothermographic Photosensitive Material Samples 201-229 were prepared. Coating was carried out to result in a dried photosensitive layer thickness of 10.5 μm, and a dried photosensitive layer protective layer (being the surface protective layer) thickness of 3.0 μm (the surface protective layer upper layer thickness of 1.5 μm and the surface protective layer lower layer thickness of 1.5 μm). Thereafter, drying was carried out for 10 minutes employing a drying air flow at a drying temperature of 75° C. and a dew point of 10° C. Further, determination of the surface roughness of each of Samples 201-229 resulted in Rz(E)/Rz(B)=0.40 and Rz(E)=1.4 μm. Further, Rz(B), Ra(E), and Ra(B) were 3.5 pm, 0.09 μm, and 0.12 μm, respectively.

With regard to Samples 201-229, the absorption peak of maximum absorption wavelength 420 nm due to the yellow forming leuco dye was noted, and further, with regard to Samples 201-229, the absorption peak of maximum absorption wavelength 620 nm due to cyan forming leuco dye was also noted.

Sample 219 was prepared in the same manner as Sample 203, except that during preparation of Powdered Organic Silver Salt A, 130.8 g of behenic acid, 67.7 g of arachidic acid, 43.6 g of stearic acid, and 2.3 g of palmitic acid were replaced with 259.4 g of behenic acid and 0.5 g of arachidic acid.

Sample 220 was prepared in the same manner as Sample 203 except that Fluorine Based Surface Active Agent SE-17 in the back coat layer protective layer and the photosensitive layer protective layer of Sample 203 were replaced with C₈F₁₇SO₃Li.

Sample 221 was prepared in the same manner as Sample 203, except that the dried layer thickness 10.5 μm of the photosensitive layer of Sample 203 was changed to 14.0 μm.

Sample 222 was prepared in the same manner as Sample 203, except that the dried layer thickness 10.5 μm of the photosensitive layer of Sample 203 was changed to 17.0 μm.

(Evaluation of Samples)

<Exposure and Photographic Processing>

Each of Photothermographic Dry Imaging Material Samples 201-228, prepared as above, was cut to 34.5 cm×43.0 cm sheets. Subsequently, each sample sheet was subjected to simultaneous heat development as exposure (51, 52, and 53 in FIG. 1 was set at 100° C., 123° C., and 123° C., respectively, and the sheet was conveyed to come into contact with 51, 52, and 53 for 2 seconds, 2 seconds, and 6 seconds for a total of 10 seconds, respectively) employing the thermal processor shown in FIG. 1 in which a semiconductor laser (being NLHV 3000E, produced by Nichia Corporation) of emitting wavelength 405 nm, which was subjected to a longitudinal multi-mode, was employed as an exposure light source. As used herein, “was subjected to simultaneous heat development as exposure” means that a photosensitive sheet composed of silver salt photothermographic dry imaging materials was partially exposed and the partially exposed portion was immediately developed. The distance between the exposure section and the development section was 12 cm and the linear rate during the above development was 30 mm/second. During the above processing, the conveyance rate from the photosensitive material feeding unit to the image exposure unit, the conveyance rate to the image exposure section, and the conveyance rate to the image development section was each controlled to 30 mm/second. The position of the bottom plane of the photosensitive material stock tray position at the lowest level was 45 cm from the floor surface. Time required for heat development (the time from the pick-up of a sheet of photosensitive material to its discharge) was 45 seconds (during continuous processing, the interval time of heat development was 4 seconds). Exposure was carried out stepwise in such a manner that the exposure energy amount was reduced by 0.05 in terms of logE. Sample 229 was exposed and thermally developed in the same manner as Sample 203, except that the conveying rate from the photosensitive material feeding unit to the image exposure unit, the conveyance rate to the image exposure section, and the conveyance rate to the image development section were each controlled to be 60 mm/second instead of 30 mm/second.

(Wrapping Materials)

Employed were a barrier bag of PET 10 μm/PET 12 μm/aluminum foil 9 μm/Ny 15 μm/polyethylene 50 μm incorporating 3% carbon, exhibiting an oxygen permeability of 0.02 ml/m² per day at 25° C. and 1.013×155 Pa and a moisture permeability of 0.001 g/m² per day at 40° C. and 90% relative humidity (based on the Cup Method of JIS Z 0208) and a paper tray.

<<Evaluation of Image Quality>>

Evaluation was carried out in the same manner as Example 1. Table 3 shows the results.

<<Average Gradient Ga Values>>]

Evaluation was carried out in the same manner as Example 1. Table 3 shows the results.

<<Density Variation Due to Humidity Variation>>

Evaluation was carried out in the same manner as Example 1. Table 3 shows the results.

<<Absorbance>>

(Total Absorbance of All Layers on Photosensitive Layer Side)

A photosensitive material, in which the layers on the reverse surface side had been removed, was placed in the cell loading position of a spectrophotometer (U-3410, produced by Hitachi, Ltd.) so that the photosensitive emulsion surface faced the light source (perpendicular to the incident light), and the absorption value at wavelength 405 nm which had been subjected to reduction of the absorption value due to the support, namely absorbance, was determined. Light, which was transmitted through the photosensitive material, was captured by an integrating sphere (of an aperture area of 20 mm×15 mm) which was arranged approximately 12 cm from the photosensitive material and focused onto the photomultiplier tube. Table 3 shows the results.

(Total Absorbance of All Layers on Back Coat Layer Side)

A photosensitive material, in which the layers on the photosensitive layer side had been removed, was placed in a cell loading position of a spectrophotometer (U-3410, produced by Hitachi Ltd.) so that the back coat surface faced the light source (perpendicular to the incident light), and the absorption value at wavelength 405 nm which had been subjected to reduction of the absorption value due to the support, namely absorbance, was determined. Light, which was transmitted through the back coat layer, was captured by an integrating sphere (of an aperture area of 20 mm×15 mm) which was arranged approximately 12 cm from the back coat layer and focused onto the photomultiplier tube. Table 3 shows the results.

TABLE 3

| | | | | | | Dye in | | Absorbance | Type and |
|---|---|---|---|---|---|---|---|---|---|
| | Powdered | | | | Dye in | Back Coat | | of All | Amount (g) of |
| | Organic Silver | Dye in | | | Back | Layer | | Layers on | Reducing Agent |
| Sample | Salt* | Photosensitive | | | Coat | protective | | Back Coat | Represented by |
| No. | *1 | Layer | *2 | *3 | Layer | Layer | *4 | Layer Side | Formula (RD1) |
| 201 | C/E = 36.2/9.1 | Yes | No | No | Yes | No | 0.50 | 0.70 | (1-1) = 27.98 |
| 202 | D/F = 36.2/9.1 | Yes | No | No | Yes | No | 0.50 | 0.70 | (1-1) = 27.98 |
| 203 | G/H = 36.2/9.1 | Yes | No | No | Yes | No | 0.50 | 0.70 | (1-1) = 27.98 |
| 204 | G/H = 36.2/9.1 | Yes | No | No | Yes | No | 0.50 | 0.70 | (1-3) = 27.98 |
| 205 | G/H = 36.2/9.1 | Yes | No | No | Yes | No | 0.50 | 0.70 | (1-10) = 27.98 |
| 206 | G/H = 36.2/9.1 | Yes | No | No | Yes | No | 0.50 | 0.70 | (1-13) = 27.98 |
| 207 | G/H = 36.2/9.1 | Yes | No | No | Yes | No | 0.50 | 0.70 | (1-20) = 27.98 |
| 208 | G/H = 36.2/9.1 | Yes | No | No | Yes | No | 0.50 | 0.70 | (1-21) = 27.98 |
| 209 | G/H = 36.2/9.1 | Yes | No | No | Yes | No | 0.50 | 0.70 | (1-40) = 27.98 |
| 210 | G/H = 36.2/9.1 | Yes | No | No | Yes | No | 0.50 | 0.70 | (1-46) = 27.98 |
| 211 | G/H = 36.2/9.1 | Yes | No | No | Yes | No | 0.40 | 1.00 | (1-1) = 27.98 |
| 212 | G/H = 36.2/9.1 | Yes | No | No | Yes | No | 0.40 | 1.20 | (1-1) = 27.98 |
| 213 | G/H = 36.2/9.1 | Yes | No | No | Yes | No | 0.30 | 1.50 | (1-1) = 27.98 |

| | | | | | | Density | |
|---|---|---|---|---|---|---|---|
| | Image Quality (General Evaluation of Sharpness, | | | | | Variation due | |
| Sample | Graininess, and Density Stability) | | | | Average | to Temperature | |
| No. | 25° C. 70% RH | 25° C. 30% RH | 30° C. 70% RH | 30° C. 30% RH | Gradient Ga | Variation | Remarks |
| 201 | 5.0 | 5.0 | 5.0 | 5.0 | 3.8 | 0.1 | Inv. |
| 202 | 5.0 | 5.0 | 5.0 | 5.0 | 3.8 | 0.1 | Inv. |
| 203 | 5.0 | 5.0 | 5.0 | 5.0 | 3.9 | 0.1 | Inv. |
| 204 | 5.0 | 5.0 | 5.0 | 5.0 | 3.8 | 0.1 | Inv. |
| 205 | 5.0 | 5.0 | 5.0 | 5.0 | 3.8 | 0.1 | Inv. |
| 206 | 5.0 | 5.0 | 5.0 | 5.0 | 3.9 | 0.1 | Inv. |
| 207 | 5.0 | 5.0 | 5.0 | 5.0 | 3.9 | 0.1 | Inv. |
| 208 | 5.0 | 5.0 | 5.0 | 5.0 | 3.8 | 0.1 | Inv. |
| 209 | 5.0 | 5.0 | 5.0 | 5.0 | 6.4 | 0.1 | Inv. |
| 210 | 4.5 | 4.5 | 4.0 | 4.5 | 3.6 | 0.4 | Inv. |
| 211 | 5.0 | 5.0 | 5.0 | 5.0 | 3.8 | 0.1 | Inv. |
| 212 | 4.5 | 5.0 | 4.5 | 5.0 | 3.8 | 0.1 | Inv. |
| 213 | 4.5 | 4.5 | 4.5 | 4.5 | 3.8 | 0.1 | Inv. |

| | | | | | | Dye in | | Absorbance | Type and |
|---|---|---|---|---|---|---|---|---|---|
| | Powdered | | | | Dye in | Back Coat | | of All | Amount (g) of |
| | Organic Silver | Dye in | | | Back | Layer | | Layers on | Reducing Agent |
| Sample | Salt* | Photosensitive | | | Coat | protective | | Back Coat | Represented by |
| No. | *1 | Layer | *2 | *3 | Layer | Layer | *4 | Layer Side | Formula (RD1) |
| 214 | G/H = 36.2/9.1 | Yes | No | No | Yes | No | 0.80 | 0.40 | (1-1) = 27.98 |
| 215 | G/H = 36.2/9.1 | Yes | No | No | Yes | No | 1.00 | 0.20 | (1-1) = 27.98 |
| 216 | G/H = 36.2/9.1 | No | Yes | No | Yes | No | 0.50 | 0.70 | (1-1) = 27.98 |
| 217 | G/H = 36.2/9.1 | No | No | Yes | Yes | No | 0.50 | 0.70 | (1-1) = 27.98 |
| 218 | G/H = 36.2/9.1 | Yes | No | No | No | Yes | 0.50 | 0.70 | (1-1) = 27.98 |
| 219 | G/H = 36.2/9.1 | Yes | No | No | Yes | No | 0.50 | 0.70 | (1-1) = 27.98 |
| 220 | G/H = 36.2/9.1 | Yes | No | No | Yes | No | 0.50 | 0.70 | (1-1) = 27.98 |
| 221 | G/H = 36.2/9.1 | Yes | No | No | Yes | No | 0.50 | 0.70 | (1-1) = 27.98 |
| 222 | G/H = 36.2/9.1 | Yes | No | No | Yes | No | 0.50 | 0.70 | (1-1) = 27.98 |
| 223 | A1/B1 = 36.2/9.1 | Yes | No | No | Yes | No | 0.50 | 0.70 | (1-1) = 27.98 |
| 224 | A1/B1 = 36.2/9.1 | Yes | No | No | Yes | No | 0.50 | 0.70 | (2-1) = 27.98 |
| 225 | A1/B1 = 36.2/9.1 | Yes | No | No | Yes | No | 0.20 | 0.70 | (2-1) = 27.98 |
| 226 | A1/B1 = 36.2/9.1 | Yes | No | No | Yes | No | 1.10 | 0.70 | (2-1) = 27.98 |
| 227 | A1/B1 = 36.2/9.1 | Yes | No | No | Yes | No | 0.50 | 0.10 | (2-1) = 27.98 |
| 228 | A1/B1 = 36.2/9.1 | Yes | No | No | Yes | No | 0.50 | 1.60 | (2-1) = 27.98 |
| 229 | G/H = 36.2/9.1 | Yes | No | No | Yes | No | 0.50 | 0.70 | (1-1) = 27.98 |

| | | | | | | Density | |
|---|---|---|---|---|---|---|---|
| | Image Quality (General Evaluation of Sharpness, | | | | | Variation due | |
| Sample | Graininess, and Density Stability) | | | | Average | to Temperature | |
| No. | 25° C. 70% RH | 25° C. 30% RH | 30° C. 70% RH | 30° C. 30% RH | Gradient Ga | Variation | Remarks |
| 214 | 5.0 | 5.0 | 5.0 | 5.0 | 3.8 | 0.1 | Inv. |
| 215 | 4.5 | 4.5 | 4.5 | 4.5 | 3.8 | 0.1 | Inv. |
| 216 | 4.0 | 4.0 | 4.0 | 4.0 | 3.8 | 0.1 | Inv. |
| 217 | 4.0 | 4.0 | 4.0 | 4.0 | 3.8 | 0.1 | Inv. |
| 218 | 4.0 | 4.0 | 4.0 | 4.0 | 3.8 | 0.1 | Inv. |
| 219 | 5.0 | 5.0 | 5.0 | 5.0 | 3.7 | 0.0 | Inv. |
| 220 | 5.0 | 5.0 | 4.5 | 4.5 | 3.8 | 0.2 | Inv. |
| 221 | 5.0 | 5.0 | 5.0 | 5.0 | 3.8 | 0.1 | Inv. |
| 222 | 4.5 | 4.5 | 4.0 | 4.0 | 3.8 | 0.3 | Inv. |
| 223 | 4.5 | 4.5 | 4.5 | 4.5 | 3.7 | 0.1 | Inv. |
| 224 | 3.5 | 3.5 | 3.5 | 3.5 | 3.3 | 0.8 | Inv. |
| 225 | 1.0 | 1.5 | 1.5 | 1.5 | 3.3 | 1.6 | Comp. |
| 226 | 1.5 | 1.5 | 1.0 | 1.5 | 3.3 | 1.7 | Comp. |
| 227 | 1.0 | 1.0 | 1.5 | 1.0 | 3.3 | 1.6 | Comp. |
| 228 | 1.5 | 1.5 | 1.5 | 1.0 | 3.3 | 1.7 | Comp. |
| 229 | 5.0 | 5.0 | 5.0 | 5.0 | 3.9 | 0.1 | Inv. |

※: Powdered Organic Silver Salt (the powdered organic silver salt was dispersed into a mixture of MEK and a binder (SO₃K group incorporating polyvinyl butyral) to prepare a preliminary dispersion, which was further dispersed to prepare a photosensitive emulsion dispersion)
*1: Type and Amount (g) of Photosensitive Silver Halide Emulsion
*2: Dye in Photosensitive Layer Lower Protective Layer
*3: Dye in Photosensitive Layer Upper Protective Layer
*4: Absorbance of All Layers on Photosensitive Layer Side
Inv.: Present Invention,
Comp.: Comparative Example

As Tables 2 and 3 show, by controlling, within the range of the present invention, the absorbance of the photosensitive layer side and the back coat layer side via incorporation of radiation absorbing compounds, high quality images were obtained which resulted in minimal density variation even when ambient humidity varied, even in the cases in which resin lenses were employed in the exposure system.

Further, improved effects were pronounced by employing, as a reducing agent, the highly active reducing agents represented by Formula (RD1).

As can clearly be seen from Tables 2 and 3, samples prepared by employing silver halides incorporating a high ratio of silver iodide resulted in effects of marked improvement.

Further, in the case of Sample 203, the paper tray was modified to have a raised bottom structure and silica gel was sealed in the vacant space formed in the bottom of the tray. When the above silica gel incorporating paper tray was employed, density variation due to moisture variation became 0.0, whereby improved effects were recognized.

What is claimed is:

1. A method of forming an image comprising the steps of:
(a) irradiating an silver salt photothermographic material with a laser beam emitted by a scanning exposing device in a laser imager, provided that the scanning exposing device comprises a laser diode, a polygon mirror, and an imaging lens made of a resin; and
(b) developing the irradiated silver salt photothermographic material to obtain an image by applying heat,
wherein the silver salt photothermographic material comprises:
(i) a support having thereon a photosensitive layer comprising organic silver salts, silver halide grains, a binder, a reducing agent;
(ii) a first radiation absorbing compound on a side of the support which is provided with the photosensitive layer, provided that a total absorbance of the first radiation absorbing compound is from 0.3 to 1.00 at an irradiation wavelength; and
(iii) a second radiation absorbing compound on a side of the support opposite the photosensitive layer, provided that a total absorbance of the second radiation absorbing compound is from 0.20 to 1.50 at an irradiation wavelength, and the first radiation absorbing compound and the second radiation absorbing compound may be the same or different from each other.

2. The method of forming an image of claim 1,
wherein the resin for making the imaging lens is a cycloolefin polymer.

3. The method of forming an image of claim 1,
wherein the reducing agent in the photosensitive layer is represented by Formula (RDI): 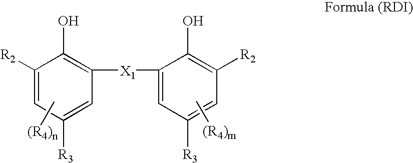
wherein X₁ is a chalcogen atom or CHR₁ in which R₁ is a hydrogen atom, a halogen atom, an alkyl group, an alkenyl group, an aryl group or a heterocyclic group; both R₂s are alkyl groups which may be the same or different, provided that at least one R₂ is a secondary or tertiary alkyl group; both R₃s are a hydrogen atom or a group capable of being substituted on a benzene ring, provided that plural R₃s may be the same or different; R₄ is a group capable of being substituted on a benzene ring; and m and n are an integer of 0 to 2.

4. The method of forming an image of claim 1,
wherein in the reducing agent represented by Formula (RDI), at least one R₃ is an alkyl group having 1 to 20 carbon atoms, provided that the alkyl group has a hydroxyl group as a substituent, or the alkyl group has a protected hydroxy group capable of forming a hydroxyl group upon deprotection.

5. The method of forming an image of claim 1,
wherein a thickness of the photosensitive layer is from 4 to 16 μm.

6. The method of forming an image of claim 1,
wherein the developed image obtained by irradiation with a laser beam and then by heating at 123° C. for 10 seconds has an optical density of 0.25 to 2.5 measured with a diffused light and an average gradation of 1.8 to 6.0,
provided that the average gradation is measured from an characteristic curve having orthogonal coordinates X and Y axes, the Y axis being a diffusion density; and the X axis being an amount of irradiation light in a common logarithm unit, each unit of the X and Y axes being the same length.

7. The method of forming an image of claim 1,
wherein a content of silver iodide in the silver halide grains is 5 to 100 mol % based on a total mol of the silver halide grains.

8. The method of forming an image of claim 1,
wherein the silver salt photothermographic material is provided as a sheet, and the sheet is fed in the laser imager at a speed of 30 to 200 mm/second during heating.

9. The method of forming an image of claim 1,
wherein the silver salt photothermographic material is provided as a sheet, and development of an irradiated portion of the sheet is carried out while a portion of the sheet is irradiated.

10. The method of forming an image of claim 1,
wherein a distance between an irradiating device and a heating device of the laser imager is 0 to 50 cm.

11. The method of forming an image of claim 1,
wherein a time period for applying heat is not more than 10 seconds.
